(19) United States
(12) Patent Application Publication
(10) Pub. No.: US 2025/0274279 A1
(43) Pub. Date: Aug. 28, 2025

(54) ADAPTIVELY SECURE STREAMING FUNCTIONAL ENCRYPTION SYSTEM AND METHOD

(71) Applicant: NTT Research, Inc., Sunnyvale, CA (US)

(72) Inventors: Pratish Datta, Sunnyvale, CA (US); Jiaxin Guan, Hoboken, NJ (US); Alexis Korb, Los Angeles, CA (US); Amit Sahai, Los Angeles, CA (US)

(73) Assignee: NTT Research, Inc., Sunnyvale, CA (US)

(21) Appl. No.: 19/064,398

(22) Filed: Feb. 26, 2025

Related U.S. Application Data
(60) Provisional application No. 63/558,099, filed on Feb. 26, 2024.

(51) Int. Cl. H04L 9/08

(52) U.S. Cl. CPC H04L 9/088; H04L 9/0861

(57) ABSTRACT

The present disclosure provides a method and system for implementing a streaming functional encryption scheme with adaptive security. The method includes building a single-key, single-ciphertext, adaptively secure streaming functional encryption scheme and executing a bootstrap of this scheme into a full multi-key, multi-ciphertext, public-key adaptive streaming functional encryption scheme. The method further includes implementing setup, encryption, key generation, and decryption routines for both the single-key scheme and the bootstrapped scheme. The system comprises a processor and a memory storing instructions to execute these routines. The streaming functional encryption scheme enables secure processing of encrypted data streams, allowing for dynamic generation of functional keys and iterative application to ciphertext segments, including those generated prior to key generation.

### CROSS-REFERENCE TO RELATED APPLICATION

This application claims the benefit of U.S. Provisional Application Ser. No. 63/558,099 filed Feb. 26, 2024, the content of which is incorporated by reference herein in its entirety.

### STATEMENT OF GOVERNMENT SUPPORT

This invention was made with government support under Grant No. HR00112020024 awarded by the Defense Advanced Research Projects Agency. The government has certain rights in the invention.

### FIELD OF INVENTION

The present disclosure generally relates to the field of streaming functional encryption, and more specifically, to systems and methods for streaming functional encryption that support adaptive security.

### BACKGROUND

A motivating medical research scenario. Imagine that a medical research institute wants to determine the appropriate vaccine dosage for patients with compromised health. To do this, the institute needs access to the records of patients held by a major health organization. However, these records contain highly sensitive private information. Naturally, the health organization would prefer to share only the necessary details for the study, withholding additional sensitive information.

To meet this objective, the health organization might turn to functional encryption (FE). Functional encryption is an advanced form of encryption that departs from the traditional “all-or-nothing” encryption model. With FE, an authority can generate function-specific keys using a master secret key. Given a function key for ƒ and an encrypted piece of data x, decryption should yield only ƒ(x) and nothing more. Hence, to accomplish this goal, the health organization can encrypt its medical records with FE and grant the research institute a function key for some function that is appropriate to their research. This key might allow, for example, the institute to extract only the results of certain statistical analyses on private patient data.

While FE may already sound too good to be true, after a long series of works, the recent pivotal works successfully constructed FE schemes for general polynomial-sized circuits, using well-studied computational assumptions.

However, while FE offers a promising theoretical framework to enable the aforementioned medical study and other similar privacy-preserving computational challenges, it is not without its drawbacks. In terms of both functionality and privacy, FE presents certain limitations when applied to scenarios like the one described above. For example:
1. FE permits the medical research institute to access information only from the records available when the function key is initially provided. If new medical records emerge during the study, the institute would need the health organization to re-encrypt its entire database, inclusive of the new records. They would then apply the function key to this newly encrypted database. Thus, for assimilating newly obtained data, the study must essentially begin anew.
2. The institute cannot obtain interim results. They must await the function key's completion of the decryption process, a duration proportional to the database's size. If, due to power or connectivity issues, the server housing the encrypted records goes offline during decryption, the process has to start over from scratch.

From a privacy perspective, using FE in the aforementioned scenarios raises even more significant concerns. Given that the database of medical records is continuously evolving, if the health organization chooses to encrypt records in batches and then share those ciphertexts with the research institute, the institute could discern the output of the learning function for each batch individually. Consequently, the research institute might either gain excessive information, or insufficient insight if the health organization adds substantial noise to each output to preserve privacy. Therefore, the only viable strategy for the health organization involves periodically encrypting its ever-expanding database, which incurs asymptotically large computational overhead.

FE's primary challenges, especially in applications like medical studies which involve extensive and evolving data sets, stem from its inherent design. Specifically, FE requires the entire data set to be present at the time of encryption, and decryption can only be performed on the ciphertext encrypting the entire data set at once.

Streaming functional encryption. To address these issues, recently Guan, Korb, and Sahai introduced streaming FE (sFE). Essentially, sFE caters to situations where data is received in a streaming manner and is sequentially processed as it's received.

In simple terms, a streaming function is a stateful function that takes as input a state stᵢ and a value xᵢ and outputs the next state stᵢ₊₁ and a value yᵢ. In an sFE scheme, the input x=x₁ . . . xₙ is encrypted piece by piece as it arrives in a streaming fashion and the streaming function of the encrypted input is derived by decrypting the piece-wise ciphertext of the input stream as it arrives. More precisely, in an sFE scheme, encryption requires the ability to individually generate ciphertexts ctᵢ for the i^{th} input xᵢ given only the master public key, xᵢ, the index i, and an encryption state (which is generated once for x using only the master public key). The decryption algorithm will itself be a streaming function that takes as input the [symbol] ciphertext ctᵢ, the index i, the function key sk_{ƒ}, and the current decryption state Dec.stᵢ (which roughly speaking encrypts stᵢ), and outputs the next output value yᵢ where (yᵢ,stᵢ₊₁)=ƒ(xᵢ,stᵢ) and the next decryption state Dec.stᵢ₊₁. For non-triviality, it is required that an sFE scheme be streaming efficient, meaning that the runtime of the algorithms should not depend on the total length n of the data stream x=x₁ . . . xₙ that is encrypted. More formally, we require that the size and runtime of all algorithms of sFE with security parameter λ, function size [symbol] , state size [symbol] , input size [symbol] , and output size [symbol] are poly(λ, [symbol] , [symbol] , [symbol] , [symbol] ).

Given its design, sFE naturally addresses the issues raised in our medical research example, avoiding the associated operational/security constraints sketched above. sFE also has potential uses in other privacy-focused computation scenarios. Applications include executing privacy-preserving machine learning algorithms on voluminous, evolving private data, analyzing sensitive live-streamed video content, and outsourcing the assessment of confidential user data as it becomes available.

In their work, Guan, Korb, and Sahai constructed the first sFE system using standard FE. They demonstrated that assuming (1) a selectively secure, public-key FE scheme for P/Poly, and (2) a strongly-compact selectively secure, secret-key FE scheme for P/Poly, then a semi-adaptive function-selective secure, public-key sFE scheme for P/Poly exists. Here, semi-adaptive function-selective security for sFE requires that in the security game, adversaries must present all function key queries immediately after obtaining the master public key. Only after this step can they request ciphertexts for the challenge stream. Unfortunately, as we now argue, this model of security leaves a lot to be desired, and achieving full (adaptive) security for sFE is a major open problem.

The insufficiency of function-selective security. The function-selective security guarantee achieved by prior work not only dampens the sFE's privacy robustness, rather it is so restrictive that it does not suffice for various natural applications of sFE. Take, for instance, the medical research scenario introduced earlier. Here, encrypted medical records of ill patients might have been accumulated long before the research institute decided to initiate the study. Using a semi-adaptive-function-selective sFE scheme would necessitate the health organization to re-encrypt the entire database after the function key is given to the research institute. Furthermore, if two distinct research institutes request computations on the same database at different times, the health organization must ensure that the institute receiving a function key later cannot access the encrypted database created for the previous institute.

These limitations are so onerous as to render function-selective sFE unsatisfactory as a theoretical foundation for the security scenarios that we aim to address.

What we want: adaptive security. The security guarantee which addresses these issues in sFE applications is adaptive security. Specifically, adaptive security guarantees security against adversaries that demand ciphertexts for the challenge stream and function keys for multiple streaming functions in an arbitrarily intertwined manner. As we just pointed out, such intertwining of function key requests and the encryption of different parts of the data stream would naturally arise in almost any scenario where streaming functional encryption would be used.

Traditionally, it has been possible to upgrade from selective to adaptive security for standard FE via “complexity leveraging” and its more advanced variant, namely “the piecewise guessing framework”. These approaches involve predicting the challenge ciphertext in the adaptive security game and halting if the prediction is wrong. As such, these approaches incur a security loss “super” polynomial in the length of the challenge ciphertext. However, in streaming FE, the challenge stream's length is theoretically limitless, preventing the use of complexity leveraging or the piecewise guessing framework for attaining adaptive security for sFE. Indeed, this is why Guan, Korb, and Sahai identified achieving adaptive security for sFE as a particularly intriguing open problem.

Thus, there is an unmet need for the first adaptively secure sFE scheme for P/Poly.

### SUMMARY OF INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In this work, we resolve the main open question posed by the work of Guan, Korb, and Sahai, and show how to construct adaptively secure streaming functional encryption (sFE). As we argue below, adaptive security is crucial to providing a meaningful theoretical foundation for almost all applications of sFE. We now elaborate.

Our main result is summarized below.
Theorem 0.1 (Main Result, Informal). Assuming a secure indistinguishability obfuscator (i [symbol] ) for P/Poly and injective pseudorandom generators (PRGs), there exists an adaptively secure sFE scheme for P/Poly.

An obfuscator, as defined in prior work, is a tool that converts a circuit into an equivalent one, i.e. preserving its input-output behavior, while concealing the original circuit's confidential data. An indistinguishability obfuscator iO is a specific type of obfuscator which ensures that any two equivalent circuits' obfuscations are indistinguishable. The utility of iO is extensive, enabling a broad range of applications in both cryptography and complexity theory.

Given the extensive applications of iO in cryptography, it has been extensively researched, culminating in recent advancements constructing iO from the following well-established computational assumptions.
Theorem 0.2 (Informal). Assume sub-exponential security of the following assumptions:
   the Learning Parity with Noise (LPN) assumption over general prime fields [symbol] ₚ with polynomially many LPN samples and error rate 1/k^{δ}, where k is the dimension of the LPN secret, and δ>0 is any constant (Definition 2.2);
   the existence of a Boolean Pseudo-Random Generator (PRG) in NC⁰ with stretch n^{1+τ}, where n is the length of the PRG seed, and τ>0 is any constant (Definition 3.1);
   the Decision Linear (DLIN) assumption on symmetric bilinear groups of prime order (Definition 2.4).

Then, there exists (subexponentially secure) i [symbol] for P/Poly.

Theorems 0.1 and 0.2 together imply the following result.
Corollary 0.3 (Informal). Assume injective PRGs and the sub-exponential security of the following assumptions:
   the Learning Parity with Noise (LPN) assumption over general prime fields [symbol] ₚ with polynomially many LPN samples and error rate 1/k^{δ}, where k is the dimension of the LPN secret, and δ>0 is any constant (Definition 2.2);
   the existence of a Boolean Pseudo-Random Generator (PRG) in NC⁰ with stretch n^{1+τ}, where n is the length of the PRG seed, and τ>0 is any constant (Definition 3.1);
   the Decision Linear (DLIN) assumption on symmetric bilinear groups of prime order (Definition 2.4).

Then, there exists an adaptively secure sFE scheme for P/Poly.

In the next section, we elaborate extensively on our technical approach. Briefly, our adaptive sFE scheme is developed in two steps.
Step 1: Build Message-Selective sFE. We start by constructing a semi-adaptive message-selective sFE scheme essentially for P/Poly. More precisely, we prove the following theorem. The message-selective sFE scheme we directly build in this paper has a weaker security guarantee than the scheme promised by Theorem 0.4 in that it is a secret-key scheme which is only secure against adversaries who are given just one function key and one encrypted challenge stream. As this weaker scheme is sufficient for building our final adaptive scheme, we do not need to enhance its security. Nevertheless, we can build the standalone message-selective scheme promised in Theorem 0.4 (which is a semi-adaptive, message-selective, public key sFE scheme) either (1) directly by bootstrapping our weaker message-selective scheme using the same bootstrapping technique we use for our adaptive scheme (see Section 7), or (2) as a byproduct of our final adaptive scheme which by definition, is also semi-adaptive, message-selective secure.
Theorem 0.4. (Message-Selective sFE) Assuming a secure i [symbol] for P/Poly and injective PRGs, there exists a semi-adaptive message-selective sFE scheme for the function class [symbol] ={two-input ƒ∈P/Poly: ∀s, ƒ(⊥, [symbol] )=⊥} where ⊥ is a special symbol.

Message-selective security is the dual notion to function-selective security. More precisely, in the message-selective security model, the adversary must output the entire challenge stream before querying any function key. Constructing a message-selective sFE scheme is highly non-trivial and we develop innovative technical ideas to tackle it.

Our approach modifies and adapts i [symbol] -friendly “authentication” techniques pioneered by Koppula et al. in the context of developing i [symbol] for Turing Machines. Very roughly speaking, what we mean by an i [symbol] -friendly authentication mechanism is one that only allows a special circuit to be evaluated on one particular input, and not on any others. We refer the reader to the technical overview for a much more accurate description. These techniques were originally devised for managing computations which take the entire input at once, and produce output only after the entire iterative computation concludes. In contrast, in the context of sFE, we encounter new inputs at each iterative step of our computation, and we must produce outputs visible to the adversary after each step of computation. At a high level, instead of authenticating a single iterative computation path for a single fixed input, as was the case in prior work, we develop a more flexible authentication system that is able to authenticate a “sliding window” consisting of the inputs and intermediate states of the computation in two adjacent steps.
Step 2: Combine Message-Selective and Function-Selective Schemes to Achieve Full Adaptive Security. Having crafted schemes with adaptive security's two facets (the message-selective one above, and the function-selective one), we develop a novel “gluing” technique to combine the two, resulting in full-fledged adaptive security. Our gluing mechanism is highly non-black-box and relies on specific properties of the two underlying schemes to merge the two “halves” of adaptive security.

We also remark that our technique for achieving adaptive security departs from the “dual system encryption” paradigm invented by Waters and could potentially pave a new pathway towards adaptive security for FE in scenarios similar to ours.

Related Work. Perhaps the two variants of FE that are closest to sFE are: FE for Turing machines and multi-input FE. However, crucial distinctions exist between sFE and these FE variants. While Turing machines inherently use iterative operations reminiscent of a streaming function, FE for Turing machines necessitates knowing the entire input at the time of (the first and only) encryption and doesn't yield any output until the Turing machine's computation concludes. On the other hand, though multi-input FE envisions segmenting a message into multiple parts and encrypting these segments incrementally, in order to successfully decrypt, the function key needs to be applied collectively to all these ciphertexts. Consequently, it lacks the capability to support incremental outputs like sFE.

According to an aspect of the present disclosure, a method for a streaming functional encryption scheme with adaptive security is provided. The method includes using a computerized processor to build a single-key, single-ciphertext, adaptively secure streaming functional encryption scheme One-sFE. The method also includes executing with the processor a bootstrap of this scheme into a full multi-key, multi-ciphertext, public-key adaptive streaming functional encryption scheme.

According to other aspects of the present disclosure, the method may include one or more of the following features. Building the single-key single-ciphertext scheme may further comprise configuring the processor to implement a setup routine, an encryption routine, a key generation routine, and a decryption routine. The setup routine may receive as input a security parameter and parameters about the functions, including a function size, a state size, an input size, and an output size. It may run the setup algorithm of a base streaming functional encryption scheme Post-One-sFE, generate cryptographic keys for additional encryption and authentication schemes, output a master secret key MSK comprising the Post-One-sFE master secret key and the additional cryptographic keys, and store the master secret key MSK in a memory of the processor.

The encryption routine may take as input the master secret key MSK, an index i, and a message xᵢ, encrypt xᵢ using the Post-One-sFE scheme, perform a nested encryption of the Post-One-sFE ciphertext using a symmetric key encryption scheme SKE, authenticate the nested encryption using a signature scheme Sig, output the ciphertext as the authenticated nested encryption, and store the ciphertext in the memory of the processor.

The key generation routine may take as input the master secret key MSK and a function ƒ, create a function key for ƒ under the Post-One-sFE scheme, treated as state st₁, encrypt the Post-One-sFE function key using the SKE scheme and authenticate it with the Sig scheme, generate auxiliary cryptographic data, including an iterator itr, create a secure transformation T that processes encrypted inputs and states, performs decryption and verification, executes the Post-One-sFE decryption algorithm, and produces authenticated encrypted outputs, output the function key comprising the secure transformation T, the encrypted and authenticated initial state, and the auxiliary cryptographic data, and store the function key in the memory of the processor.

The decryption routine may apply the secure transformation T to the encrypted and authenticated input and state data to obtain an output yᵢ, an encrypted and authenticated state for the next step, and updated auxiliary data, and store the output yᵢ, the encrypted and authenticated state, and the updated auxiliary data in the memory of the processor.

The bootstrap step may further comprise configuring the processor to implement a setup routine, an encryption setup routine, an encryption routine, a key generation routine, and a decryption routine. The setup routine may take as input a security parameter and function parameters, run the setup algorithm of a public key functional encryption scheme FE, output a master public key MPK and a master secret key MSK, and store the master public key MPK and master secret key MSK in the memory of the processor.

The encryption setup routine may take as input the master secret key MSK, generate a master secret key for a function-private functional encryption scheme FPFE, encrypt the FPFE master secret key under the public key functional encryption scheme FE, output an encryption state comprising the FPFE master secret key and its encryption, and store the encryption state in the memory of the processor.

The encryption routine may take as input the master public key MPK, the encryption state, an index i, and a value xᵢ, generate an FPFE function key for a function that encrypts xᵢ under the One-sFE scheme, output this FPFE function key as the ciphertext for xᵢ, and store the ciphertext in the memory of the processor.

The key generation routine may take as input the master secret key MSK and a function ƒ, generate an FE function key for a function that incorporates ƒ into a composite encryption process using the One-sFE and FPFE schemes, output this FE function key, and store the FE function key in the memory of the processor.

The decryption routine may take as input a function key for ƒ, a decryption state, an index i, and a ciphertext of xᵢ, perform a series of nested decryptions and function evaluations using the FE, FPFE, and One-sFE scheme decryption algorithms, output yᵢ and an updated decryption state comprising intermediate decryption results, and store yᵢ and the updated decryption state in the memory of the processor.

The secure transformation T may be created using indistinguishability obfuscation, comprising generating a circuit that processes encrypted inputs and states, performs decryption and verification, executes the Post-One-sFE decryption algorithm, and produces authenticated encrypted outputs, applying an indistinguishability obfuscation algorithm to the generated circuit to produce an obfuscated version of the circuit, and using the obfuscated circuit as the secure transformation T.

The key generation routine for the single key scheme may further comprise taking as input the master secret key MSK and a function ƒ, generating a function key Post.sk_{ƒ} for the function ƒ under the Post-One-sFE scheme, encrypting Post.sk_{ƒ} using the symmetric key encryption scheme SKE derived from a key K_{E} to obtain a state ciphertext ct_{st,1}, where ct_{st,1}∈{0,1}ⁿ for some positive integer n, generating an iterator with public parameters pp and a starting iterator state itr, where itr∈{0,1}^{m} for some positive integer m, signing a message m₁=(1,ct_{st,1},itr) using a signature scheme Sig derived from a key K_{A} to obtain a signature σ₁, producing an obfuscation of a program Prog using an indistinguishability obfuscation algorithm, and outputting the composite function key comprising the obfuscation of Prog, the state ciphertext ct_{st,1}, the signature σ₁ on m₁, and the iterator state itr.

The program Prog may have hardwired into it keys Kᵢₙₚ, K_{A}, K_{E}, and the public parameters pp, and take as input an index i∈ [symbol] , an input ciphertext ct_{inp,i}, a state ciphertext ct_{st,i}, signatures σ_{inp,i} and σ_{st,i} for the input and state ciphertexts respectively, and an iterator state itrᵢ. The program Prog may perform operations comprising checking that the index i is positive and verifying the signatures σ_{inp,i} and σ_{st,i} on the input ciphertext ct_{inp,i} and the state ciphertext ct_{st,i} respectively, using a verification key derived from K_{A}, decrypting the input ciphertext ct_{inp,i} and the state ciphertext ct_{st,i} using a secret key derived from K_{E} to obtain xᵢ and stᵢ respectively, and evaluating the Post-One-sFE decryption algorithm on these decrypted values, resulting in an updated Post-One-sFE decryption state stᵢ₊₁ and an output value yᵢ, encrypting the updated Post-One-sFE decryption state stᵢ₊₁ using randomness derived from K_{E} to obtain a new state ciphertext ct_{st,i+1}, updating the iterator state itrᵢ with some of the new values computed to obtain itrᵢ₊₁, signing the new values using the signature scheme Sig derived from K_{A} to obtain a new signature σ_{st,i+1}, and outputting the value yᵢ, the new state ciphertext ct_{st,i+1}, the new signature σ_{st,i+1}, and the updated iterator state itrᵢ₊₁.

The method may further comprise receiving encrypted training data as a stream of ciphertexts {ct₁, ct₂, . . . , ctₙ}, where each ctᵢ is an encryption of a training sample xᵢ, generating function keys {sk_{ƒ}_{₁}, sk_{ƒ}_{₂}, . . . , sk_{ƒ}_{ₘ}} for a set of machine learning update functions {ƒ₁,ƒ₂, . . . , ƒₘ}, where each ƒⱼ corresponds to the training of a specific machine learning model, iteratively applying the decryption routine to the stream of ciphertexts using the generated function keys to obtain model updates {yⱼ_{₁}, yⱼ_{₂}, . . . yⱼ_{ₙ}} along with encrypted intermediate model parameters {θⱼ_{₁}, θⱼ_{₂}, . . . , θⱼ_{ₙ}} where (y_{j,i},θ_{j,i})=(ƒⱼ(xᵢ,θⱼ_{_{i−1}}), and θⱼ_{₀} the initial model parameter for all j∈{1, . . . , m}, aggregating the model updates to progressively refine the machine learning model parameters, and outputting the final trained model parameters {θ_{1,n+1}, . . . , θ_{m,n+1}} for all the m models in encrypted form.

The method may further comprise dynamically generating, at any point during stream generation, an additional functional key corresponding to a new function, wherein the additional functional key is operable to be applied iteratively to all ciphertext segments of the stream, including those segments generated prior to the generation of the additional functional key.

According to another aspect of the present disclosure, a system for implementing a streaming functional encryption scheme with adaptive security is provided. The system includes a processor and a memory storing instructions that, when executed by the processor, cause the processor to build a single-key, single-ciphertext, adaptively secure streaming functional encryption scheme One-sFE, and execute a bootstrap of the One-sFE scheme into a full multi-key, multi-ciphertext, public-key adaptive streaming functional encryption scheme.

According to other aspects of the present disclosure, the system may include one or more of the following features. Building the single-key single-ciphertext scheme may comprise implementing a setup routine, an encryption routine, a key generation routine, and a decryption routine. The setup routine may be configured to receive as input a security parameter and parameters about the functions, including a function size, a state size, an input size, and an output size, run a setup algorithm of a base streaming functional encryption scheme Post-One-sFE, generate cryptographic keys for additional encryption and authentication schemes, output a master secret key MSK comprising the Post-One-sFE master secret key and the additional cryptographic keys, and store the master secret key MSK in the memory.

The encryption routine may be configured to take as input the master secret key MSK, an index i, and a message xᵢ, encrypt xᵢ using the Post-One-sFE scheme, perform a nested encryption of the Post-One-sFE ciphertext using a symmetric key encryption scheme SKE, authenticate the nested encryption using a signature scheme Sig, output the ciphertext as the authenticated nested encryption, and store the ciphertext in the memory.

The key generation routine may be configured to take as input the master secret key MSK and a function ƒ, create a function key for ƒ under the Post-One-sFE scheme, treated as state st₁, encrypt the Post-One-sFE function key using the SKE scheme and authenticate it with the Sig scheme, generate auxiliary cryptographic data, including an iterator itr, create a secure transformation T that processes encrypted inputs and states, performs decryption and verification, executes the Post-One-sFE decryption algorithm, and produces authenticated encrypted outputs, output the function key comprising the secure transformation T, the encrypted and authenticated initial state, and the auxiliary cryptographic data, and store the function key in the memory.

The decryption routine may be configured to apply the secure transformation T to the encrypted and authenticated input and state data to obtain an output yᵢ, an encrypted and authenticated state for the next step, and updated auxiliary data, and store the output yᵢ, the encrypted and authenticated state, and the updated auxiliary data in the memory.

The bootstrap step may comprise implementing a setup routine, an encryption setup routine, an encryption routine, a key generation routine, and a decryption routine. The setup routine may be configured to take as input a security parameter and function parameters, run a setup algorithm of a public key functional encryption scheme FE, output a master public key MPK and a master secret key MSK, and store the master public key MPK and master secret key MSK in the memory.

The encryption setup routine may be configured to take as input the master secret key MSK, generate a master secret key for a function-private functional encryption scheme FPFE, encrypt the FPFE master secret key under the public key functional encryption scheme FE, output an encryption state comprising the FPFE master secret key and its encryption, and store the encryption state in the memory.

The encryption routine may be configured to take as input the master public key MPK, the encryption state, an index i, and a value xᵢ, generate an FPFE function key for a function that encrypts xᵢ under the One-sFE scheme, output this FPFE function key as the ciphertext for xᵢ, and store the ciphertext in the memory.

The key generation routine may be configured to take as input the master secret key MSK and a function ƒ, generate an FE function key for a function that incorporates ƒ into a composite encryption process using the One-sFE and FPFE schemes, output this FE function key, and store the FE function key in the memory.

The decryption routine may be configured to take as input a function key for ƒ, a decryption state, an index i, and a ciphertext of xᵢ, perform a series of nested decryptions and function evaluations using the FE, FPFE, and One-sFE scheme decryption algorithms, output yᵢ and an updated decryption state comprising intermediate decryption results, and store yᵢ and the updated decryption state in the memory.

The secure transformation T may be created using indistinguishability obfuscation, and the processor may be further configured to generate a circuit that processes encrypted inputs and states, performs decryption and verification, executes the Post-One-sFE decryption algorithm, and produces authenticated encrypted outputs, apply an indistinguishability obfuscation algorithm to the generated circuit to produce an obfuscated version of the circuit, and use the obfuscated circuit as the secure transformation T.

The key generation routine for the single key scheme may be further configured to take as input the master secret key MSK and a function ƒ, generate a function key Post.sk_{ƒ} for the function ƒ under the Post-One-sFE scheme, encrypt Post.sk_{ƒ} using the symmetric key encryption scheme SKE derived from a key K_{E} to obtain a state ciphertext ct_{st,1}, where ct_{st,1}∈{0,1}ⁿ for some positive integer n, generate an iterator with public parameters pp and a starting iterator state itr, where itr∈{0,1}^{m} for some positive integer m, sign a message m₁=(1,ct_{st,1},itr) using a signature scheme Sig derived from a key K_{A} to obtain a signature σ₁, produce an obfuscation of a program Prog using an indistinguishability obfuscation algorithm, and output the composite function key comprising the obfuscation of Prog, the state ciphertext ct_{st,1}, the signature σ₁ on m₁, and the iterator state itr.

The program Prog may have hardwired into it keys Kᵢₙₚ, K_{A}, K_{E}, and the public parameters pp, and take as input an index i∈ [symbol] , an input ciphertext ct_{inp,i}, a state ciphertext ct_{st,i}, signatures σ_{inp,i} and σ_{st,i} for the input and state ciphertexts respectively, and an iterator state itrᵢ. The program Prog may be configured to check that the index i is positive and verify the signatures σ_{inp,i} and σ_{st,i} on the input ciphertext ct_{inp,i} and the state ciphertext ct_{st,i} respectively, using a verification key derived from K_{A}, decrypt the input ciphertext ct_{inp,i} and the state ciphertext ct_{st,i} using a secret key derived from K_{E} to obtain xᵢ and stᵢ respectively, and evaluate the Post-One-sFE decryption algorithm on these decrypted values, resulting in an updated Post-One-sFE decryption state stᵢ₊₁ and an output value yᵢ, encrypt the updated Post-One-sFE decryption state stᵢ₊₁ using randomness derived from K_{E} to obtain a new state ciphertext ct_{st,i+1}, update the iterator state itrᵢ with some of the new values computed to obtain itrᵢ₊₁, sign the new values using the signature scheme Sig derived from K_{A} to obtain a new signature σ_{st,i+1}, and output the value yᵢ, the new state ciphertext ct_{st,i+1}, the new signature σ_{st,i+1}, and the updated iterator state itrᵢ₊₁.

The processor may be further configured to receive encrypted training data as a stream of ciphertexts {ct₁, ct₂, . . . , ctₙ}, where each ctᵢ is an encryption of a training sample xᵢ, generate function keys {sk_{ƒ}_{₁}, sk_{ƒ}_{₂}, . . . , sk_{ƒ}_{ₘ}} for a set of machine learning update functions {ƒ₁, ƒ₂, . . . , ƒₘ}, where each ƒⱼ corresponds to the training of a specific machine learning model, iteratively apply the decryption routine to the stream of ciphertexts using the generated function keys to obtain model updates {yⱼ_{₁}, yⱼ_{₂}, . . . , yⱼ_{ₙ}} along with encrypted intermediate model parameters {θⱼ_{₁}, θⱼ_{₂}, . . . , θⱼ_{ₙ}} where (y_{j,i},θ_{j,i})=(ƒⱼ) (xᵢ,θⱼ_{_{i−1}}), and θⱼ_{₀} the initial model parameter for all j∈{1, . . . , m}, aggregate the model updates to progressively refine the machine learning model parameters, and output the final trained model parameters {θ_{1,n+1}, . . . , θ_{m,n+1}} for all the m models in encrypted form.

The processor may be further configured to dynamically generate, at any point during stream generation, an additional functional key corresponding to a new function, wherein the additional functional key is operable to be applied iteratively to all ciphertext segments of the stream, including those segments generated prior to the generation of the additional functional key.

According to another aspect of the present disclosure, a non-transitory computer-readable storage medium storing instructions that, when executed by a processor, cause the processor to perform a method for a streaming functional encryption scheme with adaptive security is provided. The method includes building a single-key, single-ciphertext, adaptively secure streaming functional encryption scheme One-sFE, and executing a bootstrap of the One-sFE scheme into a full multi-key, multi-ciphertext, public-key adaptive streaming functional encryption scheme.

According to other aspects of the present disclosure, the method performed by the processor may include one or more of the following features. Building the single-key single-ciphertext scheme may comprise implementing a setup routine, an encryption routine, a key generation routine, and a decryption routine. The setup routine may be configured to receive as input a security parameter and parameters about the functions, including a function size, a state size, an input size, and an output size, run a setup algorithm of a base streaming functional encryption scheme Post-One-sFE, generate cryptographic keys for additional encryption and authentication schemes, output a master secret key MSK comprising the Post-One-sFE master secret key and the additional cryptographic keys, and store the master secret key MSK in a memory.

The encryption routine may be configured to take as input the master secret key MSK, an index i, and a message xᵢ, encrypt x; using the Post-One-sFE scheme, perform a nested encryption of the Post-One-sFE ciphertext using a symmetric key encryption scheme SKE, authenticate the nested encryption using a signature scheme Sig, output the ciphertext as the authenticated nested encryption, and store the ciphertext in the memory.

The key generation routine may be configured to take as input the master secret key MSK and a function ƒ, create a function key for ƒ under the Post-One-sFE scheme, treated as state st₁, encrypt the Post-One-sFE function key using the SKE scheme and authenticate it with the Sig scheme, generate auxiliary cryptographic data, including an iterator itr, create a secure transformation T that processes encrypted inputs and states, performs decryption and verification, executes the Post-One-sFE decryption algorithm, and produces authenticated encrypted outputs, output the function key comprising the secure transformation T, the encrypted and authenticated initial state, and the auxiliary cryptographic data, and store the function key in the memory.

The decryption routine may be configured to apply the secure transformation T to the encrypted and authenticated input and state data to obtain an output yᵢ, an encrypted and authenticated state for the next step, and updated auxiliary data, and store the output yᵢ, the encrypted and authenticated state, and the updated auxiliary data in the memory.

The bootstrap step may comprise implementing a setup routine, an encryption setup routine, an encryption routine, a key generation routine, and a decryption routine. The setup routine may be configured to take as input a security parameter and function parameters, run a setup algorithm of a public key functional encryption scheme FE, output a master public key MPK and a master secret key MSK, and store the master public key MPK and master secret key MSK in the memory.

The encryption setup routine may be configured to take as input the master secret key MSK, generate a master secret key for a function-private functional encryption scheme FPFE, encrypt the FPFE master secret key under the public key functional encryption scheme FE, output an encryption state comprising the FPFE master secret key and its encryption, and store the encryption state in the memory.

The encryption routine may be configured to take as input the master public key MPK, the encryption state, an index i, and a value xᵢ, generate an FPFE function key for a function that encrypts xᵢ under the One-sFE scheme, output this FPFE function key as the ciphertext for xᵢ, and store the ciphertext in the memory.

The key generation routine may be configured to take as input the master secret key MSK and a function ƒ, generate an FE function key for a function that incorporates ƒ into a composite encryption process using the One-sFE and FPFE schemes, output this FE function key, and store the FE function key in the memory.

The decryption routine may be configured to take as input a function key for ƒ, a decryption state, an index i, and a ciphertext of xᵢ, perform a series of nested decryptions and function evaluations using the FE, FPFE, and One-sFE scheme decryption algorithms, output yᵢ and an updated decryption state comprising intermediate decryption results, and store yᵢ and the updated decryption state in the memory.

The secure transformation T may be created using indistinguishability obfuscation, and the method may further comprise generating a circuit that processes encrypted inputs and states, performs decryption and verification, executes the Post-One-sFE decryption algorithm, and produces authenticated encrypted outputs, applying an indistinguishability obfuscation algorithm to the generated circuit to produce an obfuscated version of the circuit, and using the obfuscated circuit as the secure transformation T.

The key generation routine for the single key scheme may further comprise taking as input the master secret key MSK and a function ƒ, generating a function key Post.sk_{ƒ} for the function ƒ under the Post-One-sFE scheme, encrypting Post.sk_{ƒ} using the symmetric key encryption scheme SKE derived from a key K_{E} to obtain a state ciphertext ct_{st,1}, where ct_{st,1}∈{0,1}ⁿ for some positive integer n, generating an iterator with public parameters pp and a starting iterator state itr, where itr∈{0,1}^{m} for some positive integer m, signing a message m₁=(1,ct_{st,1},itr) using a signature scheme Sig derived from a key K_{A} to obtain a signature σ₁, producing an obfuscation of a program Prog using an indistinguishability obfuscation algorithm, and outputting the composite function key comprising the obfuscation of Prog, the state ciphertext ct_{st,1}, the signature σ₁ on m₁, and the iterator state itr.

The program Prog may have hardwired into it keys Kᵢₙₚ, K_{A}, K_{E}, and the public parameters pp, and take as input an index i∈ [symbol] , an input ciphertext ct_{inp,i}, a state ciphertext ct_{st,i}, signatures σ_{inp,i} and σ_{st,i} for the input and state ciphertexts respectively, and an iterator state itrᵢ. The program Prog may perform operations comprising checking that the index i is positive and verifying the signatures σ_{inp,i} and σ_{st,i} on the input ciphertext ct_{inp,i} and the state ciphertext ct_{st,i} respectively, using a verification key derived from K_{A}, decrypting the input ciphertext ct_{inp,i} and the state ciphertext ct_{st,i} using a secret key derived from K_{E} to obtain xᵢ and stᵢ respectively, and evaluating the Post-One-sFE decryption algorithm on these decrypted values, resulting in an updated Post-One-sFE decryption state stᵢ₊₁ and an output value yᵢ, encrypting the updated Post-One-sFE decryption state stᵢ₊₁ using randomness derived from K_{E} to obtain a new state ciphertext ct_{st,i+1}, updating the iterator state itrᵢ with some of the new values computed to obtain itrᵢ₊₁, signing the new values using the signature scheme Sig derived from K_{A} to obtain a new signature σ_{st,i+1}, and outputting the value yᵢ, the new state ciphertext ct_{st,i+1}, the new signature σ_{st,i+1}, and the updated iterator state itrᵢ₊₁.

The method may further comprise receiving encrypted training data as a stream of ciphertexts {ct₁, ct₂, . . . , ctₙ}, where each ctᵢ is an encryption of a training sample xᵢ, generating function keys {sk_{ƒ}_{₁}, sk_{ƒ}_{₂}, . . . , sk_{ƒ}_{ₘ}} for a set of machine learning update functions {ƒ₁,ƒ₂, . . . , ƒₘ}, where each ƒⱼ corresponds to the training of a specific machine learning model, iteratively applying the decryption routine to the stream of ciphertexts using the generated function keys to obtain model updates {yⱼ_{₁}, yⱼ_{₂}, . . . , yⱼ_{ₙ}} along with encrypted intermediate model parameters j∈{1, . . . , θjn} where (y_{j,i},θ_{j,i})=(ƒⱼ(xᵢ, θⱼ_{_{i−1}}), and θⱼ_{₀} the initial model parameter for all j∈{1, . . . , m}, aggregating the model updates to progressively refine the machine learning model parameters, and outputting the final trained model parameters {θ_{1,n+1}, . . . , θ_{m,n+1}} for all the m models in encrypted form.

The method may further comprise dynamically generating, at any point during stream generation, an additional functional key corresponding to a new function, wherein the additional functional key is operable to be applied iteratively to all ciphertext segments of the stream, including those segments generated prior to the generation of the additional functional key.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system diagram showing a database structure and a streaming functional encryption scheme, according to aspects of the present disclosure.

FIG. 2 illustrates a block diagram of a computer system, in accordance with example embodiments.

FIG. 3 illustrates a block diagram of another computer system, according to an embodiment.

FIG. 4 illustrates a block diagram of a Streaming Functional Encryption System, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

### 1 Preliminaries

Throughout, we will use λ to denote the security parameter.

### Notation.

We say that a function ƒ(λ) is negligible in λ if ƒ(λ)=λ^{-ω(1)}, and we denote it by ƒ(λ)=neg|(λ).
We say that a function g(λ) is polynomial in λ if g(λ)=p(λ) for some fixed polynomial p, and we denote it by g(λ)=poly(λ).
For n∈ [symbol] , we use [n] to denote {1, . . . , n}.
If R is a random variable, then r←R denotes sampling r from R. If T is a set, then i←T denotes sampling i uniformly at random from T.
Definition 1.1 (Statistical Distance). Let D₁ and D₂ be two distributions with support in X. The statistical distance between D₁ and D₂ is

$$Δ ( {D}_{1} , {D}_{2} ) = \frac{1}{2} {\sum }_{x ∈ X} \vert Pr [ {D}_{1} = x ] - Pr [ {D}_{2} = x ] \vert$$

Notation. Let A and B be two random variables with support in X. We use Δ(A,B) to denote the statistical distance Δ(P_{A},P_{B}) between the underlying distributions of the random variables.

We use the standard definitions of PRGs, PRFs, and symmetric key encryption (SKE) with pseudorandom ciphertexts. We formally define these notions in Appendix 3.1.

### 1.1 Indistinguishability Obfuscation

Recent work shows how to construct i [symbol] for P/Poly from well-established computational assumptions (see Theorem 0.2).
Definition 1.2 (Indistinguishability Obfuscation (i [symbol] ) for Circuits). A uniform PPT algorithm i [symbol] is an indistinguishability obfuscator for polynomial-sized circuits if the following holds:
   Completeness: For every λ∈ [symbol] , every circuit C with input length n, and every input x∈{0,1}ⁿ,

$$Pr [ {C}^{′} ( x ) = C ( x ) : {C}^{′} ← i ( {1}^{λ} , C ) ] = 1$$

Indistinguishability: For every two ensembles {C_{0,λ}}, {C_{1,λ}} of polynomial-sized circuits that have the same size, input length, and output length, and are functionally equivalent, that is, ∀λ∈ [symbol] , C_{0,λ}(x)=C_{1,λ}(x) for every input x, then for all polynomial-time, non-uniform adversaries [symbol] , there exists a negligible function μ, such that for all λ,

$$\vert Pr [ ( {1}^{λ} , i ( {1}^{λ} , {C}_{0 , λ} ) ) ] = 1 - Pr [ ( {1}^{λ} , i ( {1}^{λ} , {C}_{1 , λ} ) ) ] = 1 \vert \leq μ ( λ )$$

### 1.2 Puncturable Pseudorandom Function

A puncturable pseudorandom function (PPRF), first termed by Sahai and Waters, is a PRF augmented with additional algorithms that allow the user to puncture the key at a point of their choice. The punctured key can be used to correctly evaluate the PRF on all points not equal to the punctured point. Additionally, pseudorandomness holds at the punctured point even if the punctured key is given out.

As shown in prior work, the GGM tree-based construction of PRFs from OWFs can be readily modified to build a PPRF. Thus, we can build PPRFs from any OWF.
Definition 1.3 (Puncturable Pseudorandom Function (PPRF)). A puncturable pseudorandom function family with key space [symbol] ={ [symbol] _{λ,n,m} [symbol] is a tuple of PPT algorithms PPRF=(PPRF.Setup,PPRF.Eval,PPRF.Punc,PPRF.EvalPunc) where
PPRF.Setup(1^{λ},1ⁿ,1^{m}) is a randomized algorithm that takes as input the security parameter λ, an input length n, and an output length m, and outputs a key K∈ [symbol] _{λ,n,m}.
PPRF.Eval(K,x) is a deterministic algorithm that takes as input a key K∈ [symbol] _{λ,n,m} and an input x∈{0,1}ⁿ, and outputs a value y∈{0,1}^{m}.
PPRF.Punc(K,x*) is a randomized algorithm that takes as input a key K∈ [symbol] _{λ,n,m} and an input x*∈{0,1}ⁿ, and outputs a punctured key K[x*].
PPRF.EvalPunc(K[x*],x) is a deterministic algorithm that takes as input a punctured key K[x*] and an input x∈{0,1}ⁿ, and outputs either a value y∈{0,1}^{m} or 1.

We require the scheme to satisfy correctness under puncturing, and selective pseudorandomness at punctured points as defined below.
Remark 1.4. For convenience, we will sometimes combine PPRF.Eval and PPRF.EvalPunc into one algorithm. This can be done by having the combined algorithm run PPRF. Eval if it receives a regular key K and run PPRF.EvalPunc if it receives a punctured key K[x*] since the two types of keys are easily distinguishable in the prior construction. When using the combined algorithm, we will overload notation and refer to it simply by PPRF.Eval.
Definition 1.5 (Correctness under Puncturing). For all λ,n,m∈ [symbol] and all x*∈{0,1}ⁿ, if K←PPRF.Setup(1^{λ},1ⁿ,1^{m}) and K[*]<PPRF.Punc(K,x*), then

$$PPRF . EvalPunc ( K [ {x}^{*} ] , x ) = \{ \begin{matrix}PPRF . Eval ( K , x ) & if x \neq {x}^{*} \\ ⊥ & else\end{matrix}$$

Definition 1.6 (Selective Pseudorandomness at Punctured Points). There exists a negligible function μ such that for all λ∈ [symbol] and all PPT adversaries [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ}, and outputs an input size 1ⁿ, an output size 1^{m}, and a message x*∈{0,1}ⁿ.
   2. Compute Values:
      (a) K←PPRF.Setup(1^{λ},1ⁿ,1^{m}).
      (b) K[x*]←PPRF.Punc(K,x*).
      (c) If b=0, send (y,K[x*]) to [symbol] where y=PPRF.Eval(K,x*).
      (d) If b=1, send (r,K[x*]) to [symbol] where r˜{0,1}^{m}.
   3. Experiment Outcome: A outputs a bit b′ which is the output of the experiment.

### 1.3 Iterators

The following background is taken from Koppula et al. who construct iterators from i [symbol] for P/Poly and OWFs. A prior construction additionally uses puncturable PRFs and a CPA secure PKE, which can be constructed from i [symbol] for P/Poly and OWFs. Informally speaking, a cryptographic iterator consists of a small state that is updated in an iterative fashion as messages are received. An update to incorporate a new message given the current state is performed with the help of some public parameters. Since states will remain relatively small regardless of the number of messages that have been iteratively incorporated, there will in general be many sequences of messages that lead to the same state. However, its security properties require that the normal public parameters should be computationally indistinguishable from specially constructed “enforcing” parameters which ensure that a particular single state can only be obtained as the outcome of an update to precisely one other state-message pair. Note that this enforcement is a very localized property to a specific state, and hence can be achieved information-theoretically when we fix ahead of time where exactly this enforcement is desired.
Definition 1.7 (Iterator). A cryptographic iterator with state size s(·) is a tuple of PPT algorithms Itr=(Itr.Setup,Itr.SetupEnforce,Itr.Iterate) where.
   Itr.Setup(1^{λ},1ⁿ,B) is a randomized algorithm that takes as input the security parameter λ, a message size n, and a bound B (in binary) of the number of iterations, and outputs public parameters pp and an initial iterator state itr₀∈{0,1 [symbol] .
   Itr.SetupEnforce(1^{λ},1ⁿ,B,{mᵢ}_{i∈[k]}) is a randomized algorithm that takes as input the security parameter λ, a message size n, a bound B (in binary) of the number of iterations, and messages {mᵢ}_{i∈[k]} where k≤B and each mᵢ∈{0,1}ⁿ. It outputs public parameters pp and an initial iterator state itr₀∈{0,1 [symbol] .
Itr.Iterate(pp,itrᵢₙ,m) is a deterministic algorithm that takes as input public parameters pp, an iterator state itrᵢₙ∈{0,1 [symbol] , and a message m∈{0,1}ⁿ, and outputs an iterator state itrₒᵤₜ∈{0,1 [symbol] .

Security requires that the iterator satisfies indistinguishability of setup and the enforcing property defined below.
Definition 1.8 (Indistinguishability of Setup). There exists a negligible function μ such that for all λ∈ [symbol] and all PPT adversaries [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define [symbol] (1^{λ},b)
1. Parameters: [symbol] takes as input 1^{λ} and outputs a message size 1ⁿ, a bound B∈Θ(2^{λ}), and messages {mᵢ}_{i∈[k]} for some k≤B and where each mᵢ∈{0,1}ⁿ.
2. Compute Values:
   (a) (pp,itr₀)←Itr.Setup(1^{λ},1ⁿ,B).
   (b) (pp′,itr₀′)←Itr.SetupEnforce(1^{λ},1ⁿ,B,{mᵢ}_{i∈[k]}).
   (c) If b=0, send (pp,itr₀) to [symbol] .
   (d) If b=1, send (pp′,itr₀′) to [symbol] .
3. Experiment Outcome: [symbol] outputs a bit b′ which is the output of the experiment.
Definition 1.9 (Enforcing). Let λ, n∈ [symbol] , B∈Θ(2^{λ}), k≤B, and {mᵢ}_{i∈[k]} where each mᵢ∈{0,1}ⁿ. Define
   (pp,itr₀)←Itr.SetupEnforce(1^{λ},1ⁿ,B, {mᵢ}_{i∈[k]}).
For i∈[k],itrᵢ=Itr.Iterate(pp,itrᵢ₋₁,mᵢ).

Then, Itr is enforcing if for all (itr′,m′)∈{0,1 [symbol] ×{0,1}ⁿ,

$${itr}_{k} = Itr . Iterate ( pp , {itr}^{′} , {m}^{′} ) ⟹ ( {itr}^{′} , {m}^{′} ) = ( {itr}_{k - 1} , {m}_{k} )$$

Note that this is an information-theoretic property.

### 1.4 Splittable Signatures

The following background is taken from Koppula et al. who construct splittable signatures from i [symbol] for P/Poly and injective PRGs. The prior construction additionally uses a puncturable PRF which can be constructed from OWFs (which are implied by PRGs). A splittable signature scheme is essentially a normal signature scheme augmented by some additional algorithms that produce alternative signing and verification keys with differing capabilities. More precisely, there are “all-but-one” signing and verification keys which work correctly for all messages except for a specific one, as well as “one” signing and verification keys which work only for a particular message. Additionally, there are “reject” verification keys which always reject signatures.
Definition 1.10 (Splittable Signature (SSig)). A splittable signature scheme with signature size s(·) is a tuple of PPT algorithms SSig=(SSig.Setup,SSig.Sign,SSig.Verify,SSig.Split,SSig.SignAbo) where
   SSig.Setup(1^{λ},1ⁿ) is a randomized algorithm that takes as input the security parameter λ and a message size n, and outputs a signing key sgk, a verification key vk, and a rejecting verification key vkᵣₑⱼ.
   SSig.Sign(sgk,m) is a deterministic algorithm that takes as input a signing key sgk and a message m∈{0,1}ⁿ and outputs a signature σ∈{0,1 [symbol] .
   SSig.Verify(vk,m,σ) is a deterministic algorithm that takes as input a verification key vk, a message m∈{0,1}ⁿ, and a signature σ∈{0,1 [symbol] , and outputs a bit b∈{0,1}.
   SSig.Split(sgk,m*) is a randomized algorithm that takes as input a signing key sgk and a message m*∈{0,1}ⁿ, and outputs a signature σₒₙₑ=SSig.Sign(sgk,m*), a one-message verification key vkₒₙₑ, an all-but-one signing key sgk_{abo}, and an all-but-one verification key vk_{abo}.
   SSig.SignAbo(sgk_{abo},m) is a deterministic algorithm that takes as input an all-but-one signing key sgk_{abo} and a message m∈{0,1}ⁿ, and outputs a signature σ∈{0,1 [symbol] .

SSig must satisfy correctness and security as defined below.
Remark 1.11. For convenience, we will sometimes combine SSig.Sign and SSig.SignAbo into one algorithm. This can be done by having the combined algorithm run SSig. Sign if it receives a regular signing key sgk and run SSig.SignAbo if it receives an all-but-one signing key sgk_{abo} since the two types of signing keys are easily distinguishable in the prior construction. When using the combined algorithm, we will overload notation and refer to it simply by SSig. Sign.

Correctness. For any λ, n∈ [symbol] , let message m*∈{0,1}ⁿ, (sgk,vk,vkᵣₑⱼ)←SSig.Setup(1^{λ},1ⁿ), and (σₒₙₑ,vkₒₙₑ,sgk_{abo},vk_{abo})←SSig.Split(sgk,m*). Then, we require the following correctness properties:
1. Regular Correctness: ∀m∈{0,1}ⁿ, SSig.Verify(vk,m,SSig.Sign(sgk,m)=1.
2. Correctness of Split Keys on Appropriate Values:
   (a) σₒₙₑ=SSig.Sign(sgk,m*).
   (b) ∀m≠m*∈{0,1}ⁿ, SSig.SignAbo(sgk_{abo},m)=SSig.Sign(sgk,m).
   (c) ∀σ∈{0,1 [symbol] , SSig.Verify(vkₒₙₑ,m*,σ)=SSig.Verify(vk,m*,σ).
   (d) ∀m≠m*∈{0,1}ⁿ,σ∈{0,1 [symbol] , SSig.Verify(vk_{abo},m,σ)=SSig.Verify(vk,m,σ).
3. Restrictions on Split Keys:
   (a) ∀m+m*∈{0,1}ⁿ,σ∈{0,1 [symbol] , SSig.Verify(vkₒₙₑ,m,σ)=0.
   (b) ∀σ∈{0,1 [symbol] , SSig.Verify(vk_{abo},m*,σ)=0.
4. vkᵣₑⱼ Always Rejects: ∀m∈{0,1}ⁿ,σ∈{0,1 [symbol] , SSig.Verify(vkᵣₑⱼ,m,σ)=0.

Security. SSig must satisfy vkᵣₑⱼ indistinguishability, vkₒₙₑ indistintinguishability, vk_{abo} indistinguishability, and splitting indistinguishability as defined below:
Definition 1.12 (vkᵣₑⱼ Indistinguishability). There exists a negligible function μ such that for all λ∈ [symbol] and all PPT adversaries [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ} and outputs a message size 1ⁿ.
   2. Compute Values:
      (a) (sgk,vk,vkᵣₑⱼ)←SSig.Setup(1^{λ},1ⁿ).
      (b) If b=0, send vk to [symbol] .
      (c) If b=1, send vkᵣₑⱼ to [symbol] .
   3. Experiment Outcome: [symbol] outputs a bit b′ which is the output of the experiment.
Definition 1.13 (vkₒₙₑ Indistinguishability). There exists a negligible function μ such that for all λ∈ [symbol] and all PPT adversaries [symbol] ,

$$\vert Pr [ {Expt}_{𝒜}^{SSig - ONE} ( {1}^{λ} , 0 ) = 1 ] - Pr [ {Expt}_{𝒜}^{SSig - ONE} ( {1}^{λ} , 1 ) = 1 ] \vert \leq μ ( λ )$$

where for each b∈{0,1} and λ∈ [symbol] , we define [symbol] (1^{λ},b)
1. Parameters: [symbol] takes as input 1^{λ} and outputs a message size 1ⁿ and a message m*∈{0,1}ⁿ.
2. Compute Values:
   (a) (sgk,vk,vkᵣₑⱼ)←SSig.Setup(1^{λ},1ⁿ).
   (b) (σₒₙₑ,vkₒₙₑ,sgk_{abo},sgkₒₙₑ)←SSig.Split(sgk,m*)
   (c) If b=0, send (σₒₙₑ,vk) to [symbol] .
   (d) If b=1, send (σₒₙₑ,vkₒₙₑ) to [symbol] .
3. Experiment Outcome: [symbol] outputs a bit b′ which is the output of the experiment.
Definition 1.14 (vk_{abo} Indistinguishability). There exists a negligible function μ such that for all λ∈ [symbol] and all PPT adversaries [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ} and outputs a message size 1ⁿ and a message m*∈{0,1}ⁿ.
   2. Send Values:
      (a) (sgk,vk,vkᵣₑⱼ)←SSig.Setup(1^{λ},1ⁿ).
      (b) (σₒₙₑ,vkₒₙₑ,sgk_{abo},sgkₒₙₑ)←SSig.Split(sgk,m*).
      (c) If b=0, send (sgk_{abo},vk) to [symbol] .
      (d) If b=1, send (sgk_{abo},vk_{abo}) to [symbol] .
   3. Experiment Outcome: [symbol] outputs a bit b′ which is the output of the experiment.
Definition 1.15 (Splitting Indistinguishability). There exists a negligible function μ such that for all λ∈ [symbol] and all PPT adversaries [symbol] ,

$$\vert Pr [ {Expt}_{𝒜}^{SSig - Split} ( {1}^{λ} , 0 ) = 1 ] - Pr [ {Expt}_{𝒜}^{SSig - Split} ( {1}^{λ} , 1 ) = 1 ] \vert \leq μ ( λ )$$

where for each b∈{0,1} and λ∈ [symbol] , we define
[symbol] (1^{λ},b)
   1. Parameters: A takes as input 1^{λ} and outputs a message size 1ⁿ and a message m*∈{0,1}ⁿ.
   2. Compute Values:
      (a) (sgk,vk,vkᵣₑⱼ)←SSig.Setup(1^{λ},1ⁿ).
      (b) (σₒₙₑ,vkₒₙₑ,sgk_{abo},sgkₒₙₑ)←SSig.Split(sgk,m*).
      (c) (sgk′,vk′,vk′ᵣₑⱼ)←SSig.Setup(1^{λ},1ⁿ).
      (d) (σ′ₒₙₑ, vk′ₒₙₑ, sgk′_{abo}, sgk′ₒₙₑ)←SSig.Split(sgk′,m*).
      (e) If b=0, send (σₒₙₑ,vkₒₙₑ,sgk_{abo},vk_{abo}) to [symbol] .
      (f) If b=1, send (σ′ₒₙₑ,vk′ₒₙₑ,sgk_{abo},vk_{abo}) to [symbol] .
3. Experiment Outcome: [symbol] outputs a bit b′ which is the output of the experiment.

### 1.5 Functional Encryption

Here we give some fundamental definitions for functional encryption (FE) schemes. First, we define a class of functions parameterized by function size, input length, and output length.
Definition 1.16 (Function Class). The function class [symbol] [ [symbol] , [symbol] , [symbol] ] is the set of all functions ƒ that have a description \hat{ƒ}∈{0,1 [symbol] , take inputs in {0,1 [symbol] , and output values in {0,1 [symbol] .

### 1.5.1 Public-Key Functional Encryption

Definition 1.17 (Public-Key Functional Encryption). A public-key functional encryption scheme for P/Poly is a tuple of PPT algorithms FE=(Setup,Enc,KeyGen,Dec) defined as follows (We also allow Enc, KeyGen, and Dec to additionally receive parameters 1^{λ}, [symbol] , [symbol] , [symbol] as input, but omit them from our notation for convenience):
   Setup(1^{λ}, [symbol] , [symbol] , [symbol] ): takes as input the security parameter λ, a function size [symbol] , an input size [symbol] , and an output size [symbol] , and outputs the master public key mpk and the master secret key msk.
   Enc(mpk,x): takes as input the master public key mpk and a message x∈{0,1 [symbol] , and outputs an encryption ct of x.
   KeyGen(msk,ƒ): takes as input the master secret key msk and a function ƒ∈ [symbol] [ [symbol] , [symbol] , [symbol] ], and outputs a function key sk_{ƒ}.
   Dec(sk_{ƒ},ct): takes as input a function key sk_{ƒ} and a ciphertext ct, and outputs a value y∈{0,1 [symbol] .

FE satisfies correctness if for all polynomials p, there exists a negligible function μ such that for all λ∈ [symbol] , all [symbol] , [symbol] , [symbol] ≤p(λ), all x∈{0,1 [symbol] , and all ƒ∈ [symbol] [ [symbol] , [symbol] , [symbol] ],

$$Pr [ \begin{matrix} & ( mpk , msk ) ← Setup ( {1}^{λ} , , {1}^{{ℓ}_{𝓍}} , {1}^{{ℓ}_{𝓎}} ) \\ Dec ( {sk}_{f} , {ct}_{x} ) = f ( x ) : & {ct}_{x} ← Enc ( mpk , x ) \\ & {sk}_{f} ← KeyGen ( msk , f )\end{matrix} ] \geq 1 - μ ( λ ) .$$

We now define adaptive security.
Definition 1.18 (Adaptive Security for Public-Key FE). A public-key functional encryption scheme FE for P/Poly is adaptively secure if there exists a negligible function μ such that for all λ∈ [symbol] and every PPT adversary [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ}, and outputs a function size [symbol] , an input size [symbol] , and an output size [symbol] .
   2. Setup: Compute (mpk, msk)←FE.Setup(1), 1^{λ}, [symbol] , [symbol] , [symbol] ).
   3. Public Key: Send mpk to [symbol] .
   4. Function Queries Phase 1: The following can be repeated any polynomial number of times:
      (a) [symbol] outputs a function query ƒ∈ [symbol] [ [symbol] , [symbol] , [symbol] ]
      (b) sk_{ƒ}←FE.KeyGen(msk,ƒ)
      (c) Send sk_{ƒ} to [symbol]
   5. Challenge Message Query:
      (a) [symbol] outputs a challenge message pair (x₀,x₁) where x₀, x₁∈{0,1 [symbol] .
      (b) ct←FE.Enc(mpk,x_{b})
      (c) Send ct to [symbol] .
   6. Function Queries Phase 2: This is identical to Function Queries Phase 1.
   7. Experiment Outcome: [symbol] outputs a bit b′ which is the output of the experiment.
   Additionally, when running the experiment, we immediately halt and output 0 if the adversary ever aborts or if it at any point ƒ(x₀)≠ƒ(x₁) for some message query (x₀,x₁) and function query ƒ submitted by the adversary.
Definition 1.19 (Other Public-Key FE Security Definitions). There are many variations of the security definition. We list a few below:
   Semi-Adaptive Security: The adversary is required to make the message query before the function queries. This is identical to adaptive security, except that we remove Function Queries Phase 1 from the security game.
   Function-Selective Semi-Adaptive Security: The adversary is required to make all function queries before the message query. This is identical to adaptive security, except that we remove Function Queries Phase 2 from the security game.
   Selective Security: The adversary is required to make the message query at the beginning of the experiment before receiving the master public key. This is similar to adaptive security, except that in the security game, we move the Challenge Message Query step so that it now lies between the Setup step and the Public Key step. Note that the two function query phases are now adjacent and can thus be merged into one step.
   Function-Selective Security: The adversary is required to make the function queries at the beginning of the experiment before receiving the master public key. This is similar to adaptive security, except that in the security game, we move the two function query steps so that they now lie between the Setup step and the Public Key step. Note that the two function query phases are now adjacent and can thus be merged into one step.

### 1.5.2 Secret-Key Functional Encryption

We can also define FE in the secret-key setting.
Definition 1.20 (Secret-Key Functional Encryption). Secret-key FE is the same as public-key FE except that Setup only outputs a master secret key and Enc requires the master secret key instead of the (non-existent) master public key. We formally define this in Appendix 3.2.
Remark 1.21. We can analogously define our public-key definitions of security in the secret-key setting. The only difference is that we do not give the (non-existent) master public key to the adversary and will therefore allow the adversary to submit multiple challenge message pairs. Note that in the secret-key setting, semi-adaptive security is equivalent to selective security, and function-selective semi-adaptive security is equivalent to function-selective security. We formally define these security definitions in Appendix 3.2.

In the secret-key setting, we can also achieve function privacy. We define it now in the selective security setting.
Definition 1.22 (Function-Private-Selective-Security). A secret-key functional encryption scheme FE for P/Poly is function-private-selective-secure if there exists a negligible function μ such that for all λ∈ [symbol] and every PPT adversary [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ}, and outputs a function size [symbol] , an input size [symbol] , and an output size [symbol] .
   2. Setup: msk←FE.Setup( [symbol] , [symbol] , [symbol] , [symbol] ).
   3. Challenge Message Queries:
      (a) [symbol] outputs challenge message pairs {(x_{0,i},x_{1,i})}_{i∈[T]} for some T chosen by the adversary where x_{0,i},x_{1,i}∈{0,1 [symbol] for all i∈[T].
      (b) For i∈[T], compute ctᵢ←FE.Enc(msk,x_{b,i}) and send ctᵢ to [symbol] .
   4. Function Queries: The following can be repeated any polynomial number of times:
      (a) [symbol] outputs a function query pair (ƒ₀,ƒ₁) where ƒ₀, ƒ₁∈ [symbol] [ [symbol] , [symbol] , [symbol] ]
      (b) sk_{ƒ}←FE.KeyGen(msk,ƒ_{b})
      (c) Send sk_{ƒ} to [symbol]
   5. Experiment Outcome: [symbol] outputs a bit b′ which is the output of the experiment.
   Additionally, when running the experiment, we immediately halt and output 0 if the adversary ever aborts or if it at any point ƒ₀(x₀)≠ƒ₁(x₁) for some message query (x₀,x₁) and function query (ƒ₀,ƒ₁) submitted by the adversary.

### 1.5.3 Single-Key, Single-Ciphertext Security

Definition 1.23 (Single-Key, Single-Ciphertext Security). We can add the modifier “single-key. single-ciphertext” to any of our security definitions. This is a weakening of the security definition where we only require security against an adversary who is restricted to making only one function query and submitting only one challenge message pair in the relevant security game.

### 1.5.4 Strong-Compactness

Additionally, we might also want our FE scheme to be strongly-compact. (We call it strong-compactness since the usual notion of compactness found in the literature only requires the encryption algorithm to not grow with the function size.) Intuitively, this means that the sizes and running times of the setup and encryption algorithms are independent of the sizes of the circuits for which function keys are produced.
Definition 1.24 (Strong-Compactness). An FE scheme FE=(FE.Setup,FE.Enc,FE.KeyGen,FE.Dec) for P/Poly is said to be strongly-compact if there exist PPT algorithms FE.Setup*, FE.Enc* such that for all polynomials p, for all large enough λ, [symbol] , we have that for all [symbol] , [symbol] ≤p(λ+( [symbol] ), the following holds:
   FE.Setup(1^{λ}, [symbol] , [symbol] , [symbol] ) is identically distributed to FE.Setup*(1^{λ}, [symbol] )
   For all mpk←FE.Setup(1^{λ}, [symbol] , [symbol] , [symbol] ) and all x∈{0,1 [symbol] , FE.Enc(1^{λ}, [symbol] , [symbol] , [symbol] ,mpk,x) is identically distributed to FE.Enc*(1^{λ}, [symbol] ,mpk,x)

We will often abuse notation and write FE.Setup to mean FE.Setup and write FE.Enc to mean FE.Enc*.

### 1.6 Streaming Functional Encryption

Guan, Korb, and Sahai define streaming functional encryption (sFE) as functional encryption (FE) for a class of streaming functions.

### 1.6.1 Streaming Functions

Definition 1.25 (Streaming Function). A streaming function with state space [symbol] , input space x, output space y, and starting state (if not specified, we assume st₁ to be ⊥ (or the all-zero string) by default.) st₁∈ [symbol] is a function ƒ: x× [symbol] ←y× [symbol] .
   The output of ƒ on x=x₁ . . . xₙ∈xⁿ (denoted ƒ(x) is defined to be y=y₁ . . . yₙ∈yⁿ where

$$∀ i ∈ [ n ] , ( {y}_{i} , {st}_{i + 1} ) = f ( {x}_{i} , {st}_{i} )$$

Definition 1.26 (Streaming Function Class). The streaming function class [symbol] [ [symbol] , [symbol] , [symbol] , [symbol] ] is the set of all streaming functions ƒ that have a description \hat{ƒ}∈{0,1 [symbol] , state space [symbol] ={0,1 [symbol] , input space x={0,1 [symbol] , output space y={0,1 [symbol] , and starting state ( [symbol] [ [symbol] , [symbol] , [symbol] , [symbol] ] requires st₁=⊥. However, all of our results still hold even if we expand our function class to include functions with arbitrary starting states as we can simply include the starting state in the function description.) st₁=⊥.

When constructing Pre-One-sFE, we will work with a specific streaming function class [symbol] .
Definition 1.27 ( [symbol] ). [symbol] is the set of all two-input functions in P/Poly such that if the first input is ⊥, the function always outputs ⊥ regardless of the second input, i.e.

$$= \{ two - input f ∈ P / Poly : ∀ s , f ( ⊥ , s ) = ⊥ \} .$$

If ƒ is a streaming function, then ƒ∈ [symbol] means that ƒ(⊥,st)=(⊥,⊥) for any state st.
Remark 1.28. Note that constructing a sFE scheme for the restricted function class [symbol] does not hinder the usability of the scheme since every one-input function can be interpreted as a two-input function, and for every two-input function ƒ∈P/Poly, we can construct a function ƒ′∈P/Poly with essentially the same functionality by defining

$${f}^{′} ( z , s ) = \{ \begin{matrix}f ( x , s ) & if z = 1 ‖ x for some x \\ ⊥ & else\end{matrix} .$$

### 1.6.2 Public Key Streaming Function Encryption

Following the syntax of standard FE, we define public key sFE as follows.
Definition 1.29 (Public-Key Streaming FE). A public-key streaming functional encryption scheme for P/Poly is a tuple of PPT algorithms sFE=(Setup,EncSetup,Enc,KeyGen,Dec) defined as follows: (We also allow Enc,EncSetup,KeyGen, and Dec to additionally receive parameters 1^{λ}, [symbol] , [symbol] , [symbol] , [symbol] as input, but omit them from our notation for convenience.)
   Setup(1^{λ}, [symbol] , [symbol] , [symbol] , [symbol] ): takes as input the security parameter λ, a function size [symbol] , a state size [symbol] , an input size [symbol] , and an output size [symbol] , and outputs the master public key mpk and the master secret key msk.
   EncSetup(mpk): takes as input the master public key mpk and outputs an encryption state Enc.st.
   Enc(mpk,Enc.st,i,xᵢ): takes as input the master public key mpk, an encryption state Enc.st, an index i, and a message xᵢ∈{0,1 [symbol] and outputs an encryption ctᵢ of xᵢ.
   KeyGen(msk,ƒ): takes as input the master secret key msk, and a function ƒ∈ [symbol] [ [symbol] , [symbol] , [symbol] , [symbol] ] and outputs a function key sk_{ƒ}.
   Dec(sk_{ƒ},Dec.stᵢ,i,ctᵢ): where for each function key sk_{ƒ}, Dec(sk_{ƒ},·,·,·) is a streaming function that takes as input a state Dec.stᵢ, an index i, and an encryption ctᵢ and outputs a new state Dec.stᵢ₊₁ and an output [symbol] ∈{0,1 [symbol] .

sFE must be streaming efficient, meaning that the size and runtime of all algorithms of SFE on security parameter λ, function size [symbol] , state size [symbol] , input size [symbol] , and output size [symbol] are poly(λ, [symbol] , [symbol] , [symbol] , [symbol] ).

sFE satisfies correctness if for all polynomials p, there exists a negligible function μ such that for all λ∈ [symbol] , all [symbol] , [symbol] , [symbol] , [symbol] ≤p(λ), all n∈[2^{λ}], all x=x₁ . . . xₙ where each xᵢ∈{0,1 [symbol] , and all ƒ∈ [symbol] [ [symbol] , [symbol] , [symbol] , [symbol] ],

$$Pr [ \overline{Dec} ( {sk}_{f} , {ct}_{x} ) = f ( x ) : \begin{matrix}( mpk , msk ) ← Setup ( {1}^{λ} , , , {1}^{{ℓ}_{𝓍}} , {1}^{{ℓ}_{𝓎}} ) , \\ {ct}_{x} ← \overline{Enc} ( mpk , x ) \\ {sk}_{f} ← KeyGen ( msk , Dec . {st}_{1} , f )\end{matrix} ] \geq 1 - μ ( λ )$$

where we define (as with all streaming functions, we assume that Dec.st₁=⊥ if not otherwise specified.)
E̅n̅c̅(mpk,x) outputs ctₓ=(ctᵢ)_{i∈[n]} produced by sampling Enc.st←EncSetup(mpk) and then computing ctᵢ←Enc(mpk,Enc.st,i,xᵢ) for i∈[n].
D̅e̅c̅(sk_{ƒ},ctₓ) outputs y=(yᵢ)_{i∈[n]} where (yᵢ,Dec.stᵢ₊₁)=Dec(sk_{ƒ},Dec.stᵢ,i,ctᵢ) for i∈[n].

We now define adaptive security. Our definition of security is adaptive in a very strong sense, in that the adversary can not only adaptively pick each of the next values of its challenge streams based on the ciphertexts and function keys already received, but can also interweave function queries between the message queries.
Definition 1.30 (Adaptive Security for Public-Key sFE). A public-key streaming FE scheme sFE for P/Poly is adaptively secure if there exists a negligible function μ such that for all λ∈ [symbol] and all PPT adversaries [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ}, and outputs a function size [symbol] , a state size [symbol] , an input size [symbol] , and an output size [symbol] .
   2. Setup: Compute (mpk, msk)←sFE.Setup(1^{λ}, [symbol] , [symbol] , [symbol] , [symbol] ).
   3. Public Key: Send mpk to [symbol] .
   4. For a polynomial number of rounds, the adversary can do either one of the following in each round:
      (a) Function Query:
         i. [symbol] outputs a streaming function query ƒ∈ [symbol] [ [symbol] , [symbol] , [symbol] , [symbol] ].
         ii. sk_{ƒ} ←sFE.KeyGen(msk,ƒ).
         iii. Send sk_{ƒ} to [symbol] .
      (b) Challenge Message Query:
         i. If this is the first challenge message query, sample Enc.st←sFE. EncSetup(mpk) and initialize the index i=1. Else, increment the index i by 1.
         ii. [symbol] outputs a challenge message pair (xᵢ⁽⁰⁾,xᵢ⁽¹⁾) where xᵢ⁽⁰⁾,xᵢ⁽¹⁾∈{0,1 [symbol] .
         iii. ctᵢ←sFE.Enc(mpk,Enc.st,i,xᵢ^{(b)}).
         iv. Send ctᵢ to [symbol] .
   5. Experiment Outcome: [symbol] outputs a bit b′ which is the output of the experiment.

Additionally, when running the experiment, we immediately halt and output 0 if the adversary ever aborts or if it at any point some function query ƒ submitted by the adversary yields different outputs on the challenge message streams submitted so far (i.e. if ƒ(x⁽⁰⁾)≠ƒ(x⁽¹⁾) for some function query ƒ submitted by the adversary where {xᵢ⁽⁰⁾,xᵢ⁽¹⁾)}_{i∈[t]} are the message queries submitted so far, x⁽⁰⁾=x₁⁽⁰⁾ . . . xₜ⁽⁰⁾, and x⁽¹⁾=x₁⁽¹⁾ . . . xₜ⁽¹⁾).
Definition 1.31 (Other Public-Key sFE Security Definitions). There are many variations of the security definition. We list a few below:
   Semi-Adaptive Security: The adversary is required to make all message queries before any function queries. This is identical to adaptive security, except that we do not allow the adversary to make a Challenge Message Query after it has made a Function Query.
   Function-Selective Semi-Adaptive Security: The adversary is required to make all function queries before any message queries. This is identical to adaptive security, except that we do not allow the adversary to make a Function Query after it has made a Challenge Message Query.
   Selective Security: The adversary is required to make the message query at the beginning of the experiment before receiving the master public key. This is similar to adaptive security, except that we allow the adversary to take a polynomial number of Challenge Message Query steps in between the Setup step and the Public Key step, but do not allow the adversary to take any Challenge Message Query steps after the Public Key step.
   Function-Selective Security: The adversary is required to make the function queries at the beginning of the experiment before receiving the master public key. This is similar to adaptive security, except that we allow the adversary to take a polynomial number of Function Query steps in between the Setup step and the Public Key step, but do not allow the adversary to take any Function Query steps after the Public Key step.

### 1.6.3 Secret-Key Streaming Functional Encryption

We can also define sFE in the secret-key setting.
Definition 1.32 (Secret-Key Streaming Functional Encryption). Secret-key sFE is the same as public-key sFE except that Setup only outputs a master secret key and EncSetup and Enc require the master secret key instead of the (non-existent) master public key. We formally define this in Appendix 3.3.
Remark 1.33. We can analogously define our public-key definitions of security in the secret-key setting. The only difference is that we do not give the (non-existent) master public key to the adversary and will therefore allow the adversary to submit multiple pairs of challenge streams. Note that in the secret-key setting, semi-adaptive security is equivalent to selective security, and function-selective semi-adaptive security is equivalent to function-selective security. We formally define these security definitions in Appendix 3.3.

### 1.6.4 Single-Key, Single-Ciphertext Security

Definition 1.34 (Single-Key, Single-Ciphertext Security). We can add the modifier “single-key. single-ciphertext” to any of our security definitions. This is a weakening of the security definition where we only require security against an adversary who is restricted to making only one function query and submitting only one pair of challenge message streams (though each stream may still consist of many elements) in the relevant security game.

### 1.6.5 Notational Variations

Remark 1.35 (Providing the starting state stᵢ as input to KeyGen). When constructing our intermediate sFE schemes, we will sometimes define the KeyGen algorithm so that it additionally takes the starting state st₁ as input. This does not affect the scheme's ability to be a standalone sFE scheme since all functions ƒ∈ [symbol] [ [symbol] , [symbol] , [symbol] , [symbol] ] have starting state st₁=⊥, so we can simply define a new key generation algorithm with the proper amount of inputs by hardwiring st₁=⊥ into the old KeyGen algorithm.
Remark 1.36 (Modeling sFE decryption as a streaming function.). We can easily change any sFE scheme sFE′ into a new sFE scheme sFE* with the same security but whose decryption algorithm is a streaming function in the standard format (i.e. takes only two inputs: a state and a value). This is achieved by modifying the KeyGen and Dec algorithms as below so that the decryption state also includes the function key for ƒ and the index i.
   Let sFE′=(sFE′.Enc,sFE′.EncSetup,sFE′.KeyGen,sFE′.Dec) be a sFE scheme. We define sFE scheme sFE*=(sFE′.Enc,sFE′.EncSetup,sFE*.KeyGen,sFE*.Dec) where
      sFE*.KeyGen(msk,ƒ)
         1. sk_{ƒ}←sFE′.KeyGen(msk,ƒ).
         2. Output Dec.st₁*=(sk_{ƒ},Dec.st₁,1).
      sFE*.Dec(Dec.stᵢ*,ctᵢ)

$$1. Parse Dec . {st}_{i}^{*} = ( {sk}_{f} , Dec . {st}_{i} , i ) . \\ 2. ( {y}_{i} . Dec . {st}_{i + 1} ) = {sFE}^{′} . Dec ( {sk}_{f} , Dec . {st}_{i} , i , {ct}_{i} ) . \\ 3. Dec . {st}_{i + 1}^{*} = ( {sk}_{f} , Dec . {st}_{i + 1} , i + 1 ) . \\ 4. Output ( {y}_{i} , Dec . {st}_{i + 1}^{*} ) .$$

Note that in this case, KeyGen simply outputs the first decryption state Dec.st₁*. It is easy to see that sFE′ and sFE* have the same security.

### 2 Assumptions

In this section, we detail the assumptions used in prior work to build (subexponentially secure) i [symbol] for P/Poly.
Definition 2.1 (e-Indistinguishability). We say that two ensembles x={x_{λ} [symbol] and y={y_{λ} [symbol] are ∈-indistinguishable if for all PPT adversaries [symbol] and for all sufficiently large λ∈ [symbol] ,

$$\vert {Pr}_{x ← {𝒳}_{λ}} [ ( {1}^{λ} , x ) = 1 ] - {Pr}_{y ← {𝒴}_{λ}} [ ( {1}^{λ} , y ) = 1 ] \vert \leq ϵ ( λ )$$

We say that two ensembles are computationally indistinguishable if they are e-indistinguishable for ∈(λ)=neg|(λ) for some negligible neg|, and that two ensembles are subexponentially indistinguishable if they are ∈-indistinguishable for ∈(λ)=2−^{λ}^{^{c}} for some positive real number c.
Definition 2.2 (S-LPN Assumption). Let δ∈(0, 1). We say that the δ-LPN Assumption is true if the following holds: For any constant ηₚ>0, any function p: [symbol] → [symbol] such that for every [symbol] ∈ [symbol] , p( [symbol] ) is a prime of [symbol] bits, any constant ηₙ>0, we set p=p( [symbol] ), n=n( [symbol] )= [symbol] , and r=r( [symbol] )= [symbol] , and we require that the following two distributions are computationally indistinguishable:

$${\{ ( A , b = s \cdot A + e ) \vert A ← , s ← {ℤ}_{p}^{1 \times n} , e ← ( p ) \}}_{ℓ ∈ ℕ} \\ {\{ ( A , u ) \vert A ← , u ← {ℤ}_{p}^{1 \times n} \}}_{ℓ ∈ ℕ}$$

where e← [symbol] ᵣ(p) is a generalized Bernoulli distribution, i.e. e is sampled randomly from [symbol] ₚ with probability r= [symbol] and set to be 0 with probability 1−r. We say that subexponential δ-LPN holds if the two distributions above are subexponentially indistinguishable.
Remark 2.3. A PRG (see Definition 3.1) is said to be in NC⁰ if it is implementable by a uniformly efficiently generatable NC⁰ circuit. We say a PRG with stretch m(·) is subexponentially secure if there exists a real positive constant c such that for all non-uniform PPT adversaries [symbol] and all sufficiently large n∈ [symbol] ,

$$\vert {Pr}_{r ← {\{ 0 , 1 \}}^{n}} [ ( PRG ( r ) ) = 1 ] - {Pr}_{z ← {\{ 0 , 1 \}}^{m ( n )}} [ ( z ) = 1 ] \vert \leq {2}^{- {λ}^{c}}$$

Definition 2.4 (DLIN Assumption). The decision linear (DLIN) assumption over prime order symmetric bilinear groups is stated as follows: Given an appropriate prime p, two groups [symbol] , [symbol] _{T} are chosen of order p such that there exists an efficiently computable nontrivial bilinear map e: [symbol] × [symbol] → [symbol] _{T}. Canonical generators g for [symbol] and [symbol] _{T} for [symbol] _{T} are also computed. Then, the DLIN assumption requires that the following computational indistinguishability holds:

$$\{ ( {g}^{x} , {g}^{y} , {g}^{z} , {g}^{xa} , {g}^{yb} , {g}^{z ( a + b )} ) : x , y , z , a , b ← {p}_{} \} {\approx }_{c} \{ ( {g}^{x} , {g}^{y} , {g}^{z} , {g}^{xa} , {g}^{yb} , {g}^{zc} ) : x , y , z , a , b , c ← {ℤ}_{p} \}$$

We say that subexponential DLIN holds if the two distributions above are subexponentially indistinguishable.

### 3 Preliminaries Continued

### 3.1 Standard Notions

Definition 3.1 (Pseudorandom Generator (PRG)). A pseudorandom generator with stretch m(·) is a Boolean function PRG: {0,1}*→{0,1}* mapping n-bit inputs to m(n)-bit outputs that is computable by a uniform PPT machine. Security holds if there exists a negligible function μ such that for all n∈ [symbol] and all PPT adversaries [symbol] ,

$$\vert {Pr}_{r ← {\{ 0 , 1 \}}^{n}} [ ( PRG ( r ) ) = 1 ] - {Pr}_{z ← {\{ 0 , 1 \}}^{m ( n )}} [ ( z ) = 1 ] \vert \leq μ ( n )$$

Definition 3.2 (Pseudorandom Function (PRF)). A pseudorandom function family (PRF) with key space [symbol] ={ [symbol] _{λ,n,m}}_{λ,n,m∈N} is a tuple of PPT algorithms PRF=(PRF.Setup,PRF.Eval) where
   PRF.Setup(1^{λ},1ⁿ,1^{m}) is a randomized algorithm that takes as input the security parameter λ, an input length n, and an output length m, and outputs a key K∈ [symbol] _{λ,n,m}
   PRF.Eval(K,x) is a deterministic algorithm that takes as input a key K∈ [symbol] _{λ,n,m} and an input x∈{0,1}ⁿ, and outputs a value y∈{0,1}^{m}.

Security requires that there exists a negligible function μ such that for all λ∈ [symbol] and all PPT adversaries [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ} and outputs an input size 1ⁿ and an output size 1^{m}.
   2. Setup:
      (a) If b=0, sample K←PRF.Setup(1^{λ},1ⁿ,1^{m}).
      (b) If b=1, sample R← [symbol] _{n,m} where [symbol] _{n,m} is the set of all functions from {0,1}ⁿ to {0,1}^{m}.
   3. PRF Queries: The following can be repeated any polynomial number of times:
      (a) [symbol] outputs a value x∈{0,1}ⁿ.
      (b) If b=0, send y=PRF.Eval(K,x) to [symbol] .
      (c) If b=1, send y=R(x) to [symbol] .
   4. Experiment Outcome: [symbol] outputs a bit b′ which is the output of the experiment.
Definition 3.3 (Symmetric Key Encryption (SKE)). A symmetric key encryption scheme with key space K={K_{λ,n}}_{λ,n∈N} and ciphertext size m(·) is a tuple of PPT algorithms SKE=(SKE.Setup,SKE.Enc,SKE.Dec) where
   SKE.Setup(1^{λ},1ⁿ) is a randomized algorithm that takes as input the security parameter λ and an input length n and outputs a secret key k∈ [symbol] _{λ,n}
   SKE.Enc(k,x) is a randomized algorithm that takes as input a secret key k∈ [symbol] _{λ,n} and a message x∈{0,1}ⁿ and outputs an encryption ct∈{0,1}^{m(λ,n)} of x.
   SKE.Dec(k,ct) is a deterministic algorithm that takes as input a secret key k∈ [symbol] _{λ,n} and a ciphertext ct∈{0,1}^{m(λ,n)} and outputs a value y∈{0,1}ⁿ.

Correctness requires that for all λ, n∈ [symbol] and every x∈{0,1}ⁿ,

$$Pr [ SKE . Dec ( k , SKE . Enc ( k , x ) ) = x : k ← SKE . Setup ( {1}^{λ} , {1}^{n} ) ] = 1$$

Security requires that there exists a negligible function μ such that for all λ∈ [symbol] and all PPT adversaries [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ} and outputs an input size 1ⁿ.
   2. Setup: k←SKE.Setup(1^{λ},1ⁿ)
   3. Challenge Message Queries: The following can be repeated any polynomial number of times:
      (a) [symbol] outputs a challenge message pair (x₀,x₁) where x₀,x₁∈{0,1}ⁿ.
      (b) ct_{b}←SKE.Enc(k,x_{b})
      (c) Sent ct_{b} to [symbol] .
   4. Experiment Outcome: [symbol] outputs a bit b′ which is the output of the experiment.

We will sometimes require that our symmetric key encryption scheme has pseudorandom ciphertexts. Intuitively, this means that ciphertexts should be indistinguishable from random strings of the same size.
Definition 3.4 (Symmetric Key Encryption (SKE) with Pseudorandom Ciphertexts). A symmetric key encryption scheme SKE=(SKE.Setup,SKE.Enc,SKE.Dec) with key space [symbol] ={ [symbol] _{λ,n} [symbol] and ciphertext size m(·) has pseudorandom ciphertexts if there exists a negligible function μ such that for all λ∈ [symbol] and all PPT adversaries [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ} and outputs an input size 1ⁿ.
   2. Setup: k←SKE.Setup(1^{λ},1ⁿ)
   3. Challenge Message Queries: The following can be repeated any polynomial number of times:
      (a) [symbol] outputs a challenge message x where x∈{0,1}ⁿ.
      (b) If b=0, ct←SKE.Enc(k,x).
      (c) If b=1, ct←{0,1}^{m (λ,n)}.
      (d) Send ct to [symbol] .
   4. Experiment Outcome: [symbol] outputs a bit b′ which is the output of the experiment.

### 3.2 Secret-Key Functional Encryption

In this section, we formally define secret-key functional encryption.
Definition 3.5 (Secret-Key Functional Encryption). A secret-key functional encryption scheme for P/Poly is a tuple of PPT algorithms FE=(Setup,Enc,KeyGen,Dec) defined as follows: (We also allow Enc, KeyGen, and Dec to additionally receive parameters 1^{λ}, [symbol] , [symbol] , [symbol] as input, but omit them from our notation for convenience.)
   Setup(1^{λ}, [symbol] , [symbol] , [symbol] ): takes as input the security parameter λ, a function size [symbol] , an input size [symbol] , and an output size [symbol] , and outputs the master secret key msk.
   Enc(msk,x): takes as input the master secret key msk and a message x∈{0,1 [symbol] , and outputs an encryption ct of x.
   KeyGen(msk,ƒ): takes as input the master secret key msk and a function ƒ∈ [symbol] [ [symbol] , [symbol] , [symbol] ], and outputs a function key sk_{ƒ}.
   Dec(sk_{ƒ},ct): takes as input a function key sk_{ƒ} and a ciphertext ct, and outputs a value y∈{0,1 [symbol] .

FE satisfies correctness if for all polynomials p, there exists a negligible function μ such that for all λ∈ [symbol] , all [symbol] , [symbol] , [symbol] ≤p(λ), all x∈{0,1 [symbol] , and all ƒ∈ [symbol] [ [symbol] , [symbol] , [symbol] ],

$$Pr [ Dec ( {sk}_{f} , {ct}_{x} ) = f ( x ) : \begin{matrix}msk ← Setup ( {1}^{λ} , {1}^{{ℓ}_{ℱ}} , {1}^{{ℓ}_{𝒳}} , {1}^{{ℓ}_{𝒴}} ) \\ {ct}_{x} ← Enc ( msk , x ) \\ {sk}_{f} ← KeyGen ( msk , f )\end{matrix} ] \geq 1 - μ ( λ ) .$$

We now define adaptive security.
Definition 3.6 (Adaptive Security for Secret-Key FE). A secret-key functional encryption scheme FE for P/Poly is adaptively secure if there exists a negligible function μ such that for all λ∈ [symbol] and every PPT adversary [symbol] ,

$$\vert Pr [ ( {1}^{λ} , 0 ) = 1 ] - Pr [ ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ}, and outputs a function size [symbol] , an input size [symbol] , and an output size [symbol] .
   2. Setup: msk←FE.Setup(1^{λ}, [symbol] , [symbol] , [symbol] ).
   3. For a polynomial number of rounds, the adversary can do either one of the following in each round:
      (a) Function Query:
         i. [symbol] outputs a function query ƒ∈ [symbol] [ [symbol] , [symbol] , [symbol] ].
         ii. sk_{ƒ} ←FE.KeyGen(msk,ƒ).
         iii. Send sk_{ƒ} to [symbol] .
      (b) Challenge Message Query:
         i. [symbol] outputs a challenge message pair (x₀,x₁) where x₀,x₁∈{0,1 [symbol] .
         ii. ct←FE.Enc(msk,x_{b}).
         iii. Send ct to [symbol] .
   4. Experiment Outcome: [symbol] outputs a bit b′ which is the output of the experiment.

Additionally, when running the experiment, we immediately halt and output 0 if the adversary ever aborts or if it at any point ƒ(x₀)≠ƒ(x₁) for some message query (x₀,x₁) and function query ƒ submitted by the adversary.
Definition 3.7 (Other Secret-Key FE Security Definitions). There are many variations of the security definition. We list a few below:
   Selective Security: The adversary is required to make the message queries at the beginning of the experiment. This is similar to adaptive security, except that that we do not allow the adversary to make a Challenge Message Query after it has made a Function Query.
   Function-Selective Security: The adversary is required to make the function queries at the beginning of the experiment. This is similar to adaptive security, except that we do not allow the adversary to make a Function Query after it has made a Challenge Message Query.

### 3.3 Secret-Key Streaming Functional Encryption

In this section, we formally define secret-key streaming functional encryption.
Definition 3.8 (Secret-Key Streaming FE). A secret-key streaming functional encryption scheme for P/Poly is a tuple of PPT algorithms sFE=(Setup,EncSetup,Enc,KeyGen,Dec) defined as follows: (We also allow Enc,EncSetup,KeyGen, and Dec to additionally receive parameters 1^{λ}, [symbol] , [symbol] , [symbol] , [symbol] as input, but omit them from our notation for convenience.)
   1. Setup(1^{λ}, [symbol] , [symbol] , [symbol] , [symbol] ): takes as input the security parameter λ, a function size [symbol] , a state size [symbol] , an input size [symbol] , and an output size [symbol] , and outputs the master secret key msk.
   2. EncSetup(msk): takes as input the master secret key msk and outputs an encryption state Enc.st
   3. Enc(msk,Enc.st,i,xᵢ): takes as input the master secret key msk, an encryption state Enc.st, an index i, and a message xᵢ∈{0,1 [symbol] and outputs an encryption ctᵢ of xᵢ.
   4. KeyGen(msk,ƒ): takes as input the master secret key msk and a function ƒ∈ [symbol] [ [symbol] , [symbol] , [symbol] , [symbol] ] and outputs a function key sk_{ƒ}.
   5. Dec(sk_{ƒ},Dec.stᵢ,i,ctᵢ): where for each function key sk_{ƒ}, Dec(sk_{ƒ},·,·,·) is a streaming function that takes as input a state Dec.stᵢ, an index i, and an encryption ctᵢ and outputs a new state Dec.stᵢ₊₁ and an output yᵢ∈{0,1 [symbol] .

sFE must be streaming efficient, meaning that the size and runtime of all algorithms of sFE on security parameter λ, function size [symbol] , state size [symbol] , input size [symbol] , and output size [symbol] are poly(λ, [symbol] , [symbol] , [symbol] , [symbol] ).

sFE satisfies correctness if for all polynomials p, there exists a negligible function μ such that for all λ∈ [symbol] , all [symbol] , [symbol] , [symbol] , [symbol] ≤p(λ), all n∈[2^{λ}], all x=x₁ . . . xₙ where each xᵢ∈{0,1 [symbol] , and all ƒ∈ [symbol] [ [symbol] , [symbol] , [symbol] , [symbol] ],

$$Pr [ \overline{Dec} ( {sk}_{f} , {ct}_{x} ) = f ( x ) : \begin{matrix}msk ← Setup ( {1}^{λ} , , , {1}^{{ℓ}_{𝒳}} , {1}^{{ℓ}_{𝒴}} ) , \\ {ct}_{x} ← \overline{Enc} ( msk , x ) , \\ {sk}_{f} ← KeyGen ( msk , f )\end{matrix} ] \geq 1 - μ ( λ )$$

where we define (as with all streaming functions, we assume that Dec.st₁=⊥ if not otherwise specified.)
E̅n̅c̅(msk,x) outputs ctₓ=(ctᵢ)_{i∈[n]} produced by sampling Enc.st←EncSetup(msk) and then computing ctᵢ←Enc(msk,Enc.st,i,xᵢ) for i∈[n].
D̅e̅c̅(sk_{ƒ},ctₓ) outputs y=(yᵢ)_{i∈[n]} where (yᵢ,Dec.stᵢ₊₁)=Dec(skᵢ,Dec.stᵢ,i,ctᵢ) for i∈[n].

We now define adaptive security. Our definition of security is adaptive in a very strong sense, in that the adversary can not only adaptively pick each of the next values of each stream based on the ciphertexts and function keys already received, but can also interweave function queries with message queries of any stream. As each stream consists of multiple values, to avoid confusion, we require the adversary to specify which streams its challenge message queries are for by outputting a stream identity T with its message queries.
Definition 3.9 (Adaptive Security for Secret-Key sFE). A secret-key streaming FE scheme sFE for P/Poly is adaptively secure if there exists a negligible function μ such that for all λ∈ [symbol] and all PPT adversaries [symbol] ,

$$\vert ( {1}^{λ} , 0 ) = 1 ] - ( {1}^{λ} , 1 ) = 1 ] \vert \leq μ ( λ )$$

where for each b∈{0,1} and λ∈ [symbol] , we define
[symbol] (1^{λ},b)
   1. Parameters: [symbol] takes as input 1^{λ}, and outputs a function size [symbol] , a state size [symbol] , an input size [symbol] , and an output size [symbol] .
   2. Setup: Compute msk←sFE.Setup(1^{λ}, [symbol] , [symbol] , [symbol] , [symbol] ).
   3. For a polynomial number of rounds, the adversary can do either one of the following in each round:
      (a) Function Query:
         i. [symbol] outputs a streaming function query ƒ∈ [symbol] [ [symbol] , [symbol] , [symbol] , [symbol] ].
         ii. sk_{ƒ}←sFE.KeyGen(msk,ƒ).
         iii. Send sk_{ƒ} to [symbol] .
      (b) Challenge Message Query:
         i. [symbol] outputs a stream identity τ.
         ii. If this is the first challenge message query with stream identity τ, sample Enc.st_{τ}←sFE.EncSetup(msk) and initialize the index ind_{τ}=1. Else, increment the index ind_{τ} by 1.
         iii. [symbol] outputs a challenge message pair (x_{ind}_{_{τ}}⁽⁰⁾,x_{ind}_{_{τ}}⁽¹⁾) for stream τ where wind x_{ind}_{_{τ}}⁽⁰⁾,x_{ind}_{_{τ}}⁽¹⁾∈{0,1 [symbol] .
         iv. ct_{ind}_{_{τ}}←sFE.Enc(msk,Enc.st_{τ},ind_{τ},x_{ind}_{_{τ}}^{(b)}).
         v. Send ct_{ind}_{_{τ}}, to [symbol] .
   4. Experiment Outcome: [symbol] outputs a bit b′ which is the output of the experiment.

Additionally, when running the experiment, we immediately halt and output 0 if the adversary ever aborts or if it at any point some function query ƒ submitted by the adversary yields different outputs on any of the challenge message streams submitted so far (i.e. if ƒ(x_{τ}⁽⁰⁾)≠ƒ(x_{τ}⁽¹⁾) for some function query ƒ submitted by the adversary where {(x_{ind}_{_{τ}}⁽⁰⁾,x_{ind}_{_{τ}}⁽¹⁾)}_{ind}_{_{τ}}_{∈[t]} are the message queries submitted so far under some stream identity τ, x_{τ}⁽⁰⁾=x₁_{_{τ}}⁽⁰⁾ . . . xₜ_{_{τ}}⁽⁰⁾, and x_{τ}⁽¹⁾=x₁_{_{τ}}⁽¹⁾ . . . xₜ_{_{τ}}⁽¹⁾).
Definition 3.10 (Other Secret-Key sFE Security Definitions). There are many variations of the security definition. We list a few below:
   Selective Security: The adversary is required to make all message queries before any function queries. This is identical to adaptive security, except that we do not allow the adversary to make a Challenge Message Query after it has made a Function Query.
   Function-Selective Security: The adversary is required to make all function queries before any message queries. This is identical to adaptive security, except that we do not allow the adversary to make a Function Query after it has made a Challenge Message Query.

### 4 Pre-One-sFE

We first build a single-key, single-ciphertext, selectively secure sFE scheme which we call Pre-One-sFE.
Theorem 4.1. Assuming i [symbol] for P/Poly and injective PRGs, there exists a single-key, single-ciphertext, selectively secure, secret-key sFE scheme for the function class [symbol] ={two-input ƒ∈P/Poly: ∀s,ƒ(⊥,s)=⊥)}.

A technical overview of our construction is provided herein. To prove Theorem 4.1, we build an sFE scheme from the following tools, which as we show below, can each be instantiated using i [symbol] for P/Poly and OWFs.

### Tools.

SKE=(SKE.Setup,SKE.Enc,SKE.Dec): A secure symmetric key encryption scheme.
PPRF=(PPRF.Setup,PPRF.Eval,PPRF.Punc): A secure puncturable pseudorandom function family.¹.
Itr=(Itr.Setup,Itr.SetupEnforce,Itr.Iterate): A cryptographic iterator.
SSig=(SSig.Setup,SSig.Sign,SSig.Verify,SSig.Split): A secure splittable signature scheme.².
i [symbol] : An indistinguishability obfuscator for P/Poly. ¹ As per Remark 1.4, we have combined PPRF.Eval and PPRF.EvalPunc into one algorithm.² As per Remark 1.11, we have combined SSig.Sign and SSig.SignAbo into one algorithm.

Instantiation of the Tools. Let i [symbol] be an indistinguishability obfuscator for P/Poly, and let PRG be an injective pseudorandom generator.
We can build SKE and a one-way-function from PRGs using standard cryptographic techniques.
We can build PPRF from any one-way-function as shown in prior work.
We can build SSig and Itr from i [symbol] and injective PRGs as shown in prior work.

### 4.1 Parameters

On security parameter λ, function size [symbol] , state size [symbol] , input size Lₓ, and output size L_{y}, we will instantiate our primitives with the following parameters:
SKE: We instantiate SKE with message size L_{SKE.m}=max( [symbol] ,Lₓ). This means that we will use the following setup algorithm: SKE.Setup(1^{λ},1^{L}^{_{SKE.m}}). When encrypting or decrypting messages of size less than this, we assume that we pad the messages accordingly.
Observe that the algorithms and ciphertexts of SKE are of size poly(λ, [symbol] ,Lₓ).
PPRF: We overload notation and instantiate PPRF in two different ways:
   1. With input size λ and output size λ. This means that we will use the following setup algorithm: PPRF.Setup(1^{λ},1^{λ},1^{λ}).
   2. With input size λ and output size 2λ. This means that we will use the following setup algorithm: PPRF.Setup(1^{λ},1^{λ},1^{2λ}).
Which instantiation we are using can be determined by context as we will always use output length λ with keys Kᵢₙₚ, K_{A}, K_{B} and will always use output length 2λ with keys K_{E}.
Observe that the algorithms of both instantiations of PPRF are of size poly(λ).
Itr: We instantiate Itr with message size L_{ltr.m}=λ+L_{SKE.ct} and bound B=2^{λ} where L_{SKE.ct} is the size of ciphertexts of SKE. This means that we will use the following setup algorithm: Itr.Setup(1^{λ},1^{L}^{_{itr.m}},2^{λ}).
By properties of the iterator, the iterator state itr does not grow in size as we iterate more values into it. Thus, apart from Itr.SetupEnforce(which is used only in the security proof), the algorithms of Itr also remain the same size regardless of how many values we have iterated. Therefore, since L_{itr.m}=poly(λ,L_{SKE.ct})=poly(λ, [symbol] ,Lₓ), then every occurrence of an algorithm of Itr in our construction is of size poly(λ, [symbol] ,Lₓ).
SSig: We instantiate SSig with message size L_{SSig.m}=λ+L_{SKE.ct}+L_{Itr.itr} where L_{SKE.ct} is the size of ciphertexts of SKE and Itr.itr is the size of iterator states of Itr. This means that we will use the following setup algorithm: SSig.Setup(1^{λ},1^{L}^{_{SSig.m}}).
Therefore, since L_{SSig.m}=poly(λ,L_{SKE.ct}, L_{Itr.itr})=poly(λ, [symbol] ,Lₓ), then the algorithms and signatures of SSig are of size poly(λ, [symbol] ,Lₓ).
i [symbol] : We instantiate i [symbol] for the set of all circuits in P/Poly with
   circuit size L_{Prog} which is defined to be the maximum size of all programs which are obfuscated in the construction and security proof;
   input size Lᵢₙ=λ+2L_{SKE.ct}+2L_{SSig.σ}+L_{Itr.itr};
   output size Lₒᵤₜ=L_{y}+L_{SKE.ct}+L_{SSig.σ}+L_{Itr.itr};
where L_{SKE.ct} is the size of ciphertexts of SKE, L_{SSig.σ} is the size of signatures of SSig, and L_{Itr.itr} is the size of iterator states of Itr. When signing or verifying messages of size less than this, we assume that we pad the messages accordingly.
Observe that this means Lᵢₙ and Lₒᵤₜ are of size poly(λ, [symbol] ,Lₓ).
It is tedious, but straightforward to check that each of the programs that are obfuscated in our construction and security proof are of size poly(λ, [symbol] , [symbol] ,Lₓ,L_{y}) and do not have size dependent on the length of the stream. Therefore, the obfuscator i [symbol] and the obfuscated program [symbol] will be of size poly(L_{Prog})=poly(λ, [symbol] , [symbol] ,Lₓ,L_{y}).

Notation. For notational convenience, when the parameters are understood, we will often omit the security, input size, output size, message size, or state size parameters from each of the algorithms listed above.
Remark 4.2. We assume without loss of generality that for security parameter λ, all algorithms only require randomness of length λ. If the original algorithm requires additional randomness, we can replace it with a new algorithm that first expands the λ bits of randomness using a PRG of appropriate stretch and then runs the original algorithm. Note that this replacement does not affect the security of the above schemes (as long as [symbol] , [symbol] , Lₓ, L_{y} are polynomial in λ).

### 4.2 Construction

We now construct Pre-One-sFE. Recall that for notational convenience, we may omit the security, input size, output size, message size, function size, or state size parameters from our algorithms. For information on these parameters, please see the parameter section above.

For later use, we have defined our KeyGen algorithm so that it additionally takes the starting state st₁ as input. However, as per Remark 1.35, this does not affect the viability of Pre-One-sFE as a standalone scheme. We now describe our construction.

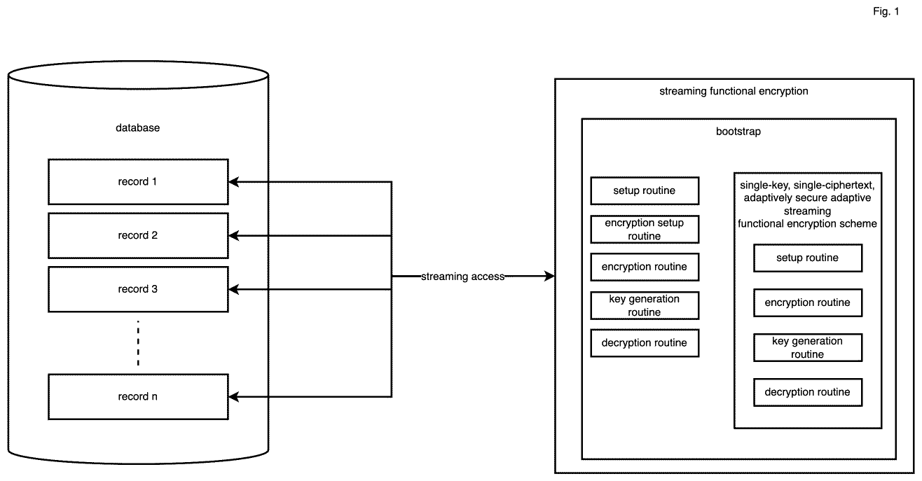

Figure 1: Def of Prog.

```
• Pre-One-sFE.Setup(1^{λ}, [symbol]   , [symbol]   , 1^{L}^{_{X}}, 1^{L}^{_{Y}}):
    1. Kᵢₙₚ, K_{A}, K_{E} ← PPRF.Setup(1^{λ}).
    * Throughout, for i ∈ [2^{λ}], we will define
                  r_{inp,i} = PPRF.Eval(Kᵢₙₚ, i)
            (sgk_{inp,i}, vk_{inp,i}, vk_{inp,i,rej}) = SSig.Setup(1^{λ}; r_{inp,i})
                  r_{A,i} = PPRF.Eval(K_{A}, i)
              (sgk_{A,i}, vk_{A,i}, vk_{A,i,rej}) = SSig.Setup(1^{λ}; r_{A,i})
                (r_{E,i}, r_{Enc,i}) = PPRF.Eval(K_{E}, i)
                  k_{E,i} = SKE.Setup(1^{λ}; r_{E,i})
    2. Output MSK = (Kᵢₙₚ, K_{A}, K_{E}).
• Pre-One-sFE.EncSetup(MSK): Output Enc.st = ⊥.
• Pre-One-sFE.Enc(MSK, Enc.st, i, xᵢ):
    1. Parse MSK = (Kᵢₙₚ, K_{A}, K_{E}).
    2. Compute ct_{inp,i}:
      (a) (r_{E,i}, r_{Enc,i}) = PPRF.Eval(K_{E}, i).
      (b) k_{E,i} = SKE.Setup(1^{λ}; r_{E,i}).
      (c) ct_{inp,i} ← SKE.Enc(k_{E,i}, xᵢ).
    3. Compute σ_{inp,i}:
      (a) (sgk_{inp,i}, vk_{inp,i}, vk_{inp,i,rej}) = SSig.Setup(1^{λ}; PPRF.Eval(Kᵢₙₚ, i)).
      (b) σ_{inp,i} ← SSig.Sign(sgk_{inp,i}, ct_{inp,i}).
    4. Output CTᵢ = (ct_{inp,i}, σ_{inp,i}).
• Pre-One-sFE.KeyGen(MSK, f, st₁):
    1. Parse MSK = (Kᵢₙₚ, K_{A}, K_{E}).
    2. Compute ct_{st,1}:
      (a) (r_{E,1}, r_{Enc,1}) = PPRF.Eval(K_{E}, 1).
      (b) k_{E,1} = SKE.Setup(1^{λ}; r_{E,1}).
      (c) ct_{st,1} = SKE.Enc(k_{E,1}, st₁; r_{Enc,1}).
    3. Setup iterator: (ppₛₜ, itr_{st,0}) ← Itr.Setup(1^{λ}).
    4. Compute σ_{st,1}:
      (a) m₁ = (1, ct_{st,1}, itr_{st,0}).
      (b) (sgk_{A,1}, vk_{A,1}, vk_{A,1,rej}) = SSig.Setup(1^{λ}; PPRF.Eval(K_{A}, 1)).
      (c) σ_{st,1} ← SSig.Sign(sgk_{A,1}, m₁).
    5. Compute program: [symbol]   ← i [symbol]   (Prog[f, Kᵢₙₚ, K_{A}, K_{E}, ppₛₜ]) where Prog is defined
      in Figure 1.
    6. Output SK_{f} = ( [symbol]   , ct_{st,1}, σ_{st,1}, itr_{st,0}).
• Pre-One-sFE.Dec(SK_{f}, Dec.stᵢ, i, CTᵢ)
    1. Parse SK_{f} = ( [symbol]   , ct_{st,1}, σ_{st,1}, itr_{st,0}) and CTᵢ = (ct_{inp,i}, σ_{inp,i}).
    2. If i > 1, parse Dec.stᵢ = (ct_{st,i}, σ_{st,i}, itr_{st,i-1}).
    3. Compute (yᵢ, ct_{st,i+1}, σ_{st,i+1}, itr_{st,i}) = [symbol]    (i, ct_{inp,i}, σ_{inp,i}, ct_{st,i}, σ_{st,i}, itr_{st,i-1}).
    4. Set Dec.stᵢ₊₁ = (ct_{st,i+1}, σ_{st,i+1}, itr_{st,i}).
    5. Output (yᵢ, Dec.stᵢ₊₁).
        Program Prog[f, Kᵢₙₚ, K_{A}, K_{E}, ppₛₜ](i, ct_{inp,i}, σ_{inp,i}, ct_{st,i}, σ_{st,i}, itr_{st,i-1})
  1. Verification Step:
      i. Verify i is positive: If i ≤ 0, output ⊥.
      ii. Verify input signature:
          i. (sgk_{inp,i}, vk_{inp,i}, vk_{inp,i,rej}) = SSig.Setup(1^{λ}; PPRF.Eval(Kᵢₙₚ, i)).
          ii. If SSig.Verify(vk_{inp,i}, ct_{inp,i}, σ_{inp,i}) = 0, output ⊥.
      iii. mᵢ = (i, ct_{st,i}, itr_{st,i-1}).
      iv. Verify state signature:
          i. (sgk_{A,i}, vk_{A,i}, vk_{A,i,rej}) = SSig.Setup(1^{λ}; PPRF.Eval(K_{A}, i)).
          ii. If SSig.Verify(vk_{A,i}, mᵢ, σ_{st,i}) = 0, output ⊥.
  2. Computation Step:
      i. Decrypt input and state:
          i. (r_{E,i}, r_{Enc,i}) = PPRF.Eval(K_{E}, i).
          ii. k_{E,i} = SKE.Setup(1^{λ}; r_{E,i}).
          iii. xᵢ = SKE.Dec(k_{E,i}, ct_{inp,i}).
          iv. stᵢ = SKE.Dec(k_{E,i}, ct_{st,i}).
      ii. Compute output value and next state:
          i. (yᵢ, stᵢ₊₁) = f(xᵢ, stᵢ).
      iii. Encrypt the new state:
          i. (r_{E,i+1}, r_{Enc,i+1}) = PPRF.Eval(K_{E}, i + 1).
          ii. k_{E,i+1} = SKE.Setup(1^{λ}; r_{E,i+1}).
          iii. ct_{st,i+1} = SKE.Enc(k_{E,i+1}, stᵢ₊₁; r_{Enc,i+1}).
  3. Authentication Step:
      i. itr_{st,i} = Itr.Iterate(ppₛₜ, itr_{st,i-1}, (i, ct_{st,i})).
      ii. mᵢ₊₁ = (i + 1, ct_{st,i+1}, itr_{st,i}).
      iii. Sign the new state:
          i. (sgk_{A,i+1}, vk_{A,i+1}, vk_{A,i+1,rej}) ← SSig.Setup(1^{λ}; PPRF.Eval(K_{A}, i + 1)).
          ii. σ_{st,i+1} = SSig.Sign(sgk_{A,i+1}, mᵢ₊₁).
  4. Output (yᵢ, ct_{st,i+1}, σ_{st,i+1}, itr_{st,i}).
```

### 4.3 Correctness and Efficiency

Efficiency. Using our discussion above on parameters, it is easy to see that the size and runtime of all algorithms of Pre-One-sFE on security parameter λ, function size [symbol] , state size [symbol] , input size Lₓ, and output size L_{y} are poly(λ, [symbol] , [symbol] ,Lₓ,L_{y}).

Correctness Intuition. Given an encryption of xᵢ, an encryption of stᵢ, and signatures for both ciphertexts, then the obfuscated program [symbol] outputs yᵢ along with a ciphertext and signature for stᵢ₊₁ where (yᵢ,stᵢ₊₁)=ƒ(xᵢ,stᵢ).

The decryptor obtains the obfuscated program [symbol] from SK_{ƒ}, and a ciphertext and signature for each xᵢ from CTᵢ. To get started, the decryptor also obtains a ciphertext and signature for the first state st₁ from SK_{ƒ}. Decryption works by iteratively running [symbol] on the ciphertexts and signatures for xᵢ and stᵢ to get the output value yᵢ along with the ciphertext and signature of the next state stᵢ₊₁, which is needed for the next decryption step.

Correctness. While we can only prove security for functions ƒ∈ [symbol] , we can prove correctness for all functions ƒ∈P/Poly. Furthermore, correctness holds even if we allow the function ƒ to have an arbitrary starting state st₁ (as long as this state is provided as additional input to KeyGen as described in the construction).

More formally, let p be any polynomial and consider any λ∈ [symbol] and any [symbol] , [symbol] ,Lₓ,L_{y}≤p(λ). Let SK_{ƒ} be a function key for some function ƒ∈ [symbol] [ [symbol] , [symbol] ,Lₓ,L_{y}] with starting state (by definition, all functions ƒ∈ [symbol] [ [symbol] , [symbol] ,Lₓ,L_{y}] have starting state st₁=⊥. Here, we are using an expanded definition of [symbol] [ [symbol] , [symbol] ,Lₓ,L_{y}] which allows ƒ to have an arbitrary starting state st₁∈{0,1 [symbol] .) st₁, and let {CTᵢ}_{i∈[n]} be a ciphertext for some x where x=x₁ . . . xₙ for some n∈[2^{λ}] and where each xᵢ∈{0,1}^{L}^{ₓ}.

By correctness of SKE, SSig, and i [symbol] , if
(r_{E,i},r_{Enc,i})=PPRF.Eval(K_{E},i) and k_{E,i}=SKE.Setup(1^{λ};r_{E,i}), (sgk_{inp,i},vk_{inp,i},vk_{inp,i,rej})=SSig.Setup(1^{λ};PPRF.Eval(K_{E},i)), (sgk_{A,i},vk_{A,i},vk_{A,rej})=SSig.Setup(1^{λ};PPRF.Eval(K_{A},i);
[symbol] =i [symbol] (Prog[ƒ,Kᵢₙₚ,K_{A},K_{E},ppₛₜ]);
ct_{inp,i} is an SKE encryption of xᵢ under key k_{E,i};
σ_{inp,i} is a signature of ct_{inp,i} signed using sgk_{inp,i};
ct_{st,i} is an SKE encryption of stᵢ under key k_{E,i};
σ_{st,i} is a signature of ct_{st,i} signed using sgk_{A,i};
itr_{st,i-1} is an iterator state associated with ppₛₜ;
   then

$$\begin{matrix}𝒫 ( i , {ct}_{inp , i} , {σ}_{inp , i} , {ct}_{st , i} , {σ}_{{st}_{i}} ) = Prog [ f , {K}_{inp} , {K}_{A} , {K}_{E} , {pp}_{st} ] ( i , {ct}_{inp , i} , {σ}_{inp , i} , {ct}_{st , i} , {σ}_{{st}_{i}} ) \\ = ( {y}_{i} , {ct}_{st , i + 1} , {σ}_{st , i + 1} , {itr}_{st , i} )\end{matrix}$$

where
(yᵢ,stᵢ₊₁)=ƒ(xᵢ,stᵢ);
ct_{st,i+1} is an SKE encryption of stᵢ₊₁ under key k_{E,i+1};
σ_{st,i+1} is a signature of ct_{st,i+1} signed using sgk_{A,i+1};
itr_{st,i} is an iterator state associated with ppₛₜ.

Observe that for i∈[n],

CTᵢ=(ct_{inp,i},σ_{inp,i})

where ct_{inp,i} is an SKE encryption of xᵢ under key k_{E,i} and σ_{inp,i} is a signature of ct_{inp,i} signed using sgk_{inp,i}. Additionally,

SK_{ƒ}=( [symbol] ,ct_{st,1},σ_{st,1},itr_{st,0})

where [symbol] =i [symbol] (Prog[ƒ,Kᵢₙₚ,K_{A},K_{E},ppₛₜ]), ct_{st,1} is an SKE encryption of st₁ under key k_{E,1}, σ_{st,1} is a signature of ct_{st,1} signed using sgk_{A,1}, and itr_{st,0} is an iterator state associated with ppₛₜ.

Therefore, for i=1,

$$Pre - One - sFE . Dec ( {SK}_{f} , Dec . {st}_{1} , 1 , {CT}_{1} ) = ( 1 , {ct}_{inp , 1} , {σ}_{inp , 1} , {ct}_{st , 1} , {σ}_{st , 1} , {itr}_{st , 0} ) = ( {y}_{1} , {ct}_{st , 2} , {σ}_{st , 2} , {itr}_{st , 1} ) = ( {y}_{1} , Dec . {st}_{2} ) for Dec . {st}_{2} = ( {ct}_{st , 2} , {σ}_{st , 2} , {itr}_{st , 1} )$$

where (y₁,st₂)=ƒ(x₁,st₁), ct_{st,2} is an SKE encryption of st₂ under key k_{E,2}, σ_{st,2} is a signature of ct_{st,2} signed using sgk_{A,2}, and itr_{st,1} is an iterator state associated with ppₛₜ.

For i>1, if Dec.stᵢ=(ct_{st,i},σ_{st,i},itr_{st,i-1}) where ct_{st,i} is an SKE encryption of stᵢ under key k_{E,i}, σ_{st,i} is a signature of ct_{st,i} signed using sgk_{A,i}, and itr_{st,i-1} is an iterator state associated with ppₛₜ, then

$$Pre - One - sFE . Dec ( {SK}_{f} , Dec . {st}_{i} , i , {CT}_{i} ) = ( i , {ct}_{inp , i} , {σ}_{inp , i} , {ct}_{st , i} , {σ}_{st , i} , {itr}_{st , i - 1} ) = ( {y}_{i} , {ct}_{st , i + 1} , {σ}_{st , i + 1} , {itr}_{st , i} ) = ( {y}_{i} , Dec . {st}_{i + 1} ) for Dec . {st}_{i + 1} = ( {ct}_{st , i + 1} , {σ}_{st , i + 1} , {itr}_{st , i} )$$

where (yᵢ,stᵢ₊₁)=ƒ(xᵢ,stᵢ), ct_{st,i+1} is an SKE encryption of stᵢ₊₁ under key k_{E,i}+1, σ_{st,i+1} is a signature of ct_{st,i+1} signed using sgk_{A,i+1}, and itr_{st,i-1} is an iterator state associated with ppₛₜ.

Thus, by induction on i and the decryption state, the decryption algorithm correctly outputs y=y₁ . . . yₙ where (yᵢ, stᵢ₊₁)=ƒ(xᵢ,stᵢ) for i∈[n].

### 4.4 Additional Algorithms

We define the following algorithm which will be used in our security proof. It is similar to KeyGen except that it hardwires in the output values at steps t-1 and t for some chosen t and some chosen output values. We have highlighted the differences between this function and Pre-One-sFE.KeyGen.

```
  • Pre-One-sFE.KeyGenHardwire(MSK, f, st₁, t, y*ₜ₋₁, y*ₜ, stₜ₊₁)
    1. Parse MSK = (Kᵢₙₚ, K_{A}, K_{E}).
    2. Compute ct_{st,1}:
      (a) (r_{E,1}, r_{Enc,1}) = PPRF.Eval(K_{E}, 1).
      (b) k_{E,1} = SKE.Setup(1^{λ}; r_{E,1}).
      (c) ct_{st,1} = SKE.Enc(k_{E,1}, st₁; r_{Enc,1}).
    3. Setup iterator: (ppₛₜ, itr_{st,0}) ← Itr.Setup(1^{λ}).
    4. Compute σ_{st,1}:
      (a) m₁ = (1, ct_{st,1}, itr_{st,0}).
      (b) (sgk_{A,1}, vk_{A,1}, vk_{A,1,rej}) = SSig.Setup(1^{λ}; PPRF.Eval(K_{A}, 1)).
      (c) σ_{st,1} ← SSig.Sign(sgk_{A,1}, m₁).
    5. Compute ct*_{st,t} and ct*_{st,t+1}:
      (a) For i ∈ {t, t + 1},
          i. (r_{E,i}, r_{Enc,i}) = PPRF.Eval(K_{E}, i).
          ii. k_{E,i} = SKE.Setup(1^{λ}; r_{E,i}).
      (b) ct*_{st,t} = SKE.Enc(k_{E,t}, ⊥; r_{Enc,t}).
      (c) ct*_{st,t+1} = SKE.Enc(k_{E,t+1}, stₜ₊₁; r_{Enc,t}).
    6. Compute program: [symbol]   ← i [symbol]   (ProgHardwire[f, Kᵢₙₚ, K_{A}, K_{E}, ppₛₜ, t, y*ₜ₋₁, ct*_{st,t}, y*ₜ, ct*_{st,t+1}]).
    7. Output SK_{f} = ( [symbol]   , ct_{st,1}, σ_{st,1}, itr_{st,0}).
        Program ProgHardwire[f,Kᵢₙₚ, K_{A}, K_{E}, ppₛₜ, t, y*ₜ₋₁, ct*_{st,t}, y*ₜ, ct*_{st,t+1}]
            (i, ct_{inp,i}, σ_{inp,i}, ct_{st,i}, σ_{st,i}, itr_{st,i-1})
  1. Verification Step:
    i. Verify i is positive: If i ≤ 0, output ⊥.
    ii. Verify input signature:
        i. (sgk_{inp,i}, vk_{inp,i}, vk_{inp,i,rej}) ← SSig.Setup(1^{λ}; PPRF.Eval(Kᵢₙₚ, i)).
        ii. If SSig.Verify(vk_{inp,i}, ct_{inp,i}, σ_{inp,i}) = 0, output ⊥.
    iii. mᵢ = (i, ct_{st,i}, itr_{st,i-1}).
    iv. Verify state signature:
        i. (sgk_{A,i}, vk_{A,i}, vk_{A,i,rej}) ← SSig.Setup(1^{λ}; PPRF.Eval(K_{A}, i)).
        ii. If SSig.Verify(vk_{A,i}, mᵢ, σ_{st,i}) = 0, output ⊥.
  2. Computation Step:
    i. If i = t − 1, (yᵢ, ct_{st,i+1}) = (y*ₜ₋₁, ct*_{st,t}).
    ii. If i = t, (yᵢ, ct_{st,i+1}) = (y*ₜ, ct*_{st,t+1}).
    iii. If i ∉ {t − 1, t},
        i. Decrypt input and state:
          i. (r_{E,i}, r_{Enc,i}) = PPRF.Eval(K_{E}, i).
          ii. k_{E,i} = SKE.Setup(1^{λ}; r_{E,i}).
          iii. xᵢ = SKE.Dec(k_{E,i}, ct_{inp,i}).
          iv. stᵢ = SKE.Dec(k_{E,i}, ct_{st,i}).
        ii. Compute output value and next state:
          A. (yᵢ, stᵢ₊₁) = f(xᵢ, stᵢ).
        iii. Encrypt the new state:
          i. (r_{E,i+1}, r_{Enc,i+1}) = PPRF.Eval(K_{E}, i + 1).
          ii. k_{E,i+1} = SKE.Setup(1^{λ}; r_{E,i+1}).
          iii. ct_{st,i+1} = SKE.Enc(k_{E,i+1}, stᵢ₊₁; r_{Enc,i+1}).
  3. Authentication Step:
    i. itr_{st,i} = Itr.Iterate(ppₛₜ, itr_{st,i-1}, (i, ct_{st,i})).
    ii. mᵢ₊₁ = (i + 1, ct_{st,i+1}, itr_{st,i}).
    iii. Sign the new state:
        i. (sgk_{A,i+1}, vk_{A,i+1}, vk_{A,i+1,rej}) ← SSig.Setup(1^{λ}; PPRF.Eval(K_{A}, i + 1)).
        ii. σ_{st,i+1} = SSig.Sign(sgk_{A,i+1}, mᵢ₊₁).
  4. Output (yᵢ, ct_{st,i+1}, σ_{st,i+1}, itr_{st,i}).
5 Post-One-sFE
Guan, Korb, and Sahai construct a single-key, single-ciphertext, function-selectively secure
sFE scheme which we call Post-One-sFE.
Theorem 5.1. Assuming a strongly-compact, selectively secure, secret-key FE scheme for
P/Poly, there exists a single-key, single-ciphertext, function-selectively secure, secret-key sFE
scheme for P/Poly.
```

In this section, we provide the construction of Post-One-sFE and prove additional properties for it that will be useful in the security proof of our adaptive scheme One-sFE. For convenience, in the construction, we have made some minor, mostly notational changes, including merging the two PRFs of prior work into one PRF. However, these changes do not affect any relevant properties of the construction.

Post-One-sFE is built from the following tools, which as we show below, can each be instantiated using a strongly-compact, selectively secure, secret-key FE scheme for P/Poly.

### Tools.

PRF=(PRF.Setup,PRF.Eval): A secure pseudorandom function family.
SKE=(SKE.Setup,SKE.Enc,SKE.Dec): A secure symmetric key encryption scheme.
SKE′=(SKE′.Setup,SKE′.Enc,SKE′.Dec): A secure symmetric key encryption scheme.
OneCompFE=(OneCompFE.Setup,OneCompFE.Enc,OneCompFE.KeyGen, OneCompFE.Dec): A strongly-compact, single-key, single-ciphertext, selectively secure, secret-key FE scheme for P/Poly.
OneFSFE=(OneFSFE.Setup,OneFSFE.Enc,OneFSFE.KeyGen,OneFSFE.Dec): A single-key, single-ciphertext, function-selectively secure, secret-key FE scheme for P/Poly.

Instantiation of the Tools. Let SKFE be a strongly-compact, selectively secure, secret-key FE scheme for P/Poly.
We can build PRF, SKE, SKE′ from any one-way-function using standard cryptographic techniques. As FE implies one-way-functions, then we can build these from SKFE.
SKFE already satisfies the compactness and security requirements needed for OneCompFE.
We can first build a function-private, selectively secure, secret-key FE scheme FPFE for P/Poly by using the function-privacy transformation of prior work on SKFE. As observed in prior work, a single-key, single-ciphertext, function-private, selectively secure, secret-key FE scheme for P/Poly is also a (non-compact) single-key, single-ciphertext, function-selectively secure, secret-key FE scheme for P/Poly as we can simply exchange the roles of the functions and messages using universal circuits. Thus, FPFE can be used to build OneFSFE.

### 5.1 Parameters

The parameters are identical to those in prior work except that rather than using two PRFs, we use one PRF which has input size λ and output size 6)+&s. Thus, we do not redefine the parameters here. Additionally, for notational convenience, we will often omit the security, input size, output size, message size, function size, and state size parameters from our algorithms.

### 5.1.1 Post-One-sFE Construction

We now construct Post-One-sFE. This is identical to the construction from prior work except for some minor, mostly notational changes.

For later use, we have applied a similar transformation as in Remark 1.36 to turn our decryption algorithm into a streaming function in the standard format (i.e. takes only two inputs: a decryption state and a ciphertext). In this case, KeyGen simply outputs the first decryption state Dec.st₁. As this transformation only requires renaming sk_{ƒ} to Dec.st₁ and adding the index i to each Dec.stᵢ, this change can be considered a notational variation, rather than a major change to the underlying algorithms.

We have also defined our KeyGen algorithm so that it additionally takes the starting state st₁ as input (rather than hardwiring st₁=⊥ as in prior work).

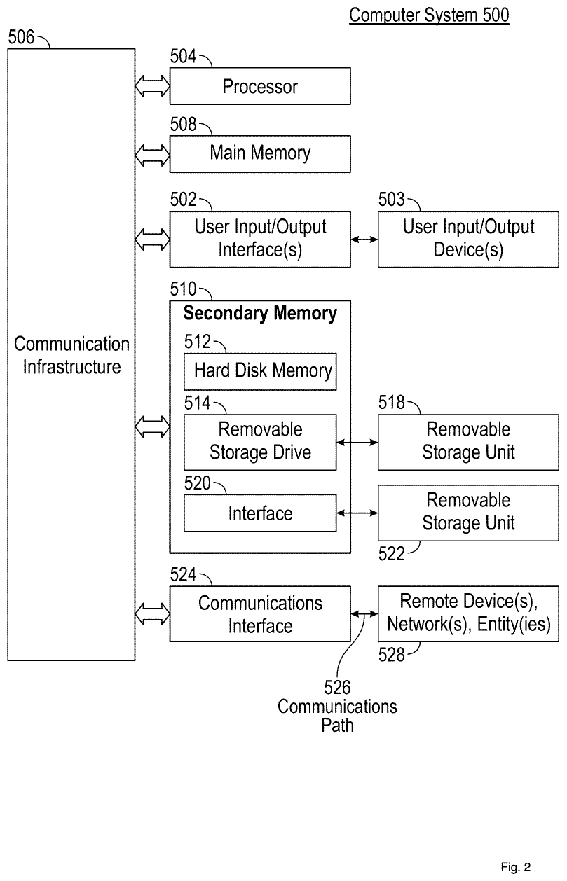

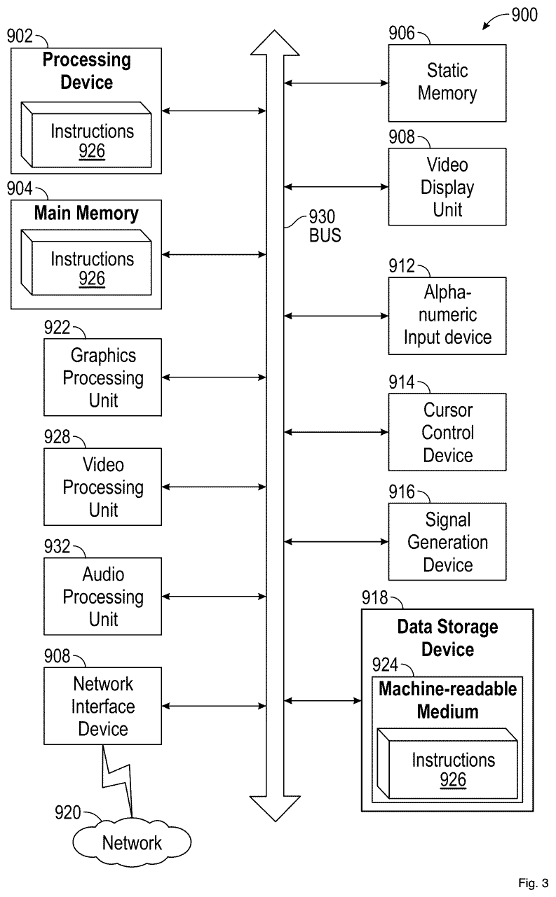

```
  • Post-One-sFE.Setup(1^{λ}, 1^{l}^{_{F}}, 1^{l}^{_{S}}, 1^{l}^{_{X}}, 1^{l}^{_{Y}}):
      1. K ← PRF.Setup(1^{λ}).
      * Throughout, for i ∈ [2^{λ}], we will define
            Kᵢ = (pᵢ, rₘₛₖ_{ᵢ}, r′ₘₛₖ_{ᵢ}, rₖ_{ᵢ}, r′ₖ_{ᵢ}, r_{KeyGen}_{ᵢ}, r′_{Enc}_{ᵢ}) = PRF.Eval(K, i)
          from which we can compute the following values defined below
              mskᵢ = OneFSFE.Setup(1^{λ}; rₘₛₖ_{ᵢ})
              msk′ᵢ = OneCompFE.Setup(1^{λ}; r′ₘₛₖ_{ᵢ})
                kᵢ = SKE.Setup(1^{λ}; rₖ_{ᵢ})
                k′ᵢ = SKE′.Setup(1^{λ}; r′ₖ_{ᵢ})
      2. Output MSK = K.
  • Post-One-sFE.EncSetup(MSK): Output Enc.st = ⊥.
  • Post-One-sFE.Enc(MSK, Enc.st, i, xᵢ):
      1. Parse MSK = K.
      2. Compute mskᵢ, pᵢ, pᵢ₊₁, r′ₘₛₖ_{ᵢ₊₁}, r′_{Enc}_{ᵢ₊₁}, rₘₛₖ_{ᵢ₊₁}, r_{KeyGen}_{ᵢ₊₁}, kᵢ, k′ᵢ, msk′ᵢ from K.
      3. ctᵢ ← OneFSFE.Enc(mskᵢ, (xᵢ, pᵢ, pᵢ₊₁, r′ₘₛₖ_{ᵢ₊₁}, r′_{Enc}_{ᵢ₊₁}, rₘₛₖ_{ᵢ₊₁}, r_{KeyGen}_{ᵢ₊₁}, 0, 0^{λ}, 0^{l}^{_{Y}})).
      4. If i = 1, output CT₁ = ct₁.
      5. If i > 1,
          (a) cᵢ ← SKE.Enc(kᵢ, ⊥).
          (b) c′ᵢ ← SKE′.Enc(k′ᵢ, ⊥).
          (c) Let hᵢ = h_{c}_{ᵢ}_{,c′}_{ᵢ}as defined in Figure 3.
          (d) sk′ₕ_{ᵢ} ← OneCompFE.KeyGen(msk′ᵢ_{, h}_{ᵢ}).
          (e) Output CTᵢ = (ctᵢ, sk′ₕ_{ᵢ}).
  • Post-One-sFE.KeyGen(MSK, f, st₁):
      1. Parse MSK = K.
      2. Compute msk₁, k₁, p₁, r_{KeyGen}_{₁}from K.
      3. c₁ ← SKE.Enc(k₁, ⊥).
      4. \tilde{s}\tilde{t}₁ = st₁ ⊕ p₁.
      5. Let g₁ = g_{f,\tilde{s}\tilde{t}}_{₁}_{,c}_{₁} as defined in Figure 2.
      6. sk_{g1} ← OneFSFE.KeyGen(msk₁, g₁; r_{KeyGen}_{₁}).
      7. Output Dec.st₁ = (1, sk_{g1}).
g_{f,\tilde{s}\tilde{t}}_{ᵢ}_{,c}_{ᵢ}(xᵢ, pᵢ, pᵢ₊₁, r′ₘₛₖ_{ᵢ₊₁}, r′_{Enc}_{ᵢ₊₁}, rₘₛₖ_{ᵢ₊₁}, r_{KeyGen}_{ᵢ₊₁}, αᵢ, rₖ_{ᵢ}, ψᵢ):
    • If αᵢ = 0,
        1. stᵢ = \tilde{s}\tilde{t}ᵢ ⊕ pᵢ.
        2. (yᵢ, stᵢ₊₁) = f(xᵢ, stᵢ).
        3. \tilde{s}\tilde{t}ᵢ₊₁ = stᵢ₊₁ ⊕ pᵢ₊₁.
        4. msk′ᵢ₊₁ = OneCompFE.Setup(1^{λ}; r′ₘₛₖ_{ᵢ₊₁}).
        5. ct′ᵢ₊₁ = OneCompFE.Enc(msk′ᵢ₊₁, (f, \tilde{s}\tilde{t}ᵢ₊₁, rₘₛₖ_{ᵢ₊₁}, r_{KeyGen}_{ᵢ₊₁}, 0, 0^{λ}); r′_{Enc}_{ᵢ₊₁}).
        6. Output (yᵢ, ct′ᵢ₊₁).
    • Else,
        1. kᵢ = SKE.Setup(1^{λ}; rₖ_{ᵢ}).
        2. (θᵢ, ct′ᵢ₊₁) = SKE.Dec(kᵢ, cᵢ).
        3. Output (θᵢ ⊕ ψᵢ, ct′ᵢ₊₁).
Figure 2: Definition of g_{f,\tilde{s}\tilde{t}}_{ᵢ}_{,c}_{ᵢ}.
h_{c}_{ᵢ}_{,c′}_{ᵢ}(f, \tilde{s}\tilde{t}ᵢ, rₘₛₖ_{ᵢ}, r_{KeyGen}_{ᵢ}, α′ᵢ, r′ₖ_{ᵢ}):
    • If α′ᵢ = 0,
        1. mskᵢ = OneFSFE.Setup(1^{λ}; rₘₛₖ_{ᵢ}).
        2. Let gᵢ = g_{f,\tilde{s}\tilde{t}}_{ᵢ}_{,c}_{ᵢ} as defined in Figure 2.
        3. sk_{g}_{ᵢ} = OneFSFE.KeyGen(mskᵢ_{, g}_{ᵢ}_{; r}_{_{KeyGen}}_{ᵢ}).
        4. Output sk_{g}_{ᵢ}.
    • Else,
        1. k′ᵢ = SKE′.Setup(1^{λ}; r′ₖ_{ᵢ}).
        2. Output sk_{g}_{ᵢ} = SKE′.Dec(k′ᵢ_{, c′}_{ᵢ}).
Figure 3: Definition of h_{c}_{ᵢ}_{,c′}_{ᵢ}.
```

One-sFE.Dec(Dec.stᵢ,CTᵢ):

$$1. Parse Dec . {st}_{i} into ( i , {val}_{i} ) . \\ 2. If i = 1 , parse {val}_{1} = {sk}_{{g}_{1}} and {CT}_{1} = {ct}_{1} . \\ 3. If i > 1 , \\ ( a ) Parse {val}_{i} = {ct}_{i}^{′} and {CT}_{i} = ( {ct}_{i} , {sk}_{{h}_{i}}^{′} ) . \\ ( b ) {sk}_{{g}_{i}} = OneCompFE . Dec ( {sk}_{{h}_{i}}^{′} , {ct}_{i}^{′} ) . \\ 4. ( {y}_{i} , {ct}_{i + 1}^{′} ) = OneFSFE . Dec ( {sk}_{{g}_{i}} , {ct}_{i} ) . \\ 5. Dec . {st}_{i + 1} = ( i + 1 , {ct}_{i + 1}^{′} ) . \\ 6. Output ( {y}_{i} , Dec . {st}_{i + 1} ) .$$

### 5.2 Correctness, Efficiency, and Security

Correctness, efficiency, and single-key, single-ciphertext, function-selective security follow from the corresponding theorems in prior work as our construction is identical to theirs except for some minor, mostly notational changes.

### 5.3 Additional Properties

Post-One-sFE has some useful properties that we will need for the security proof of our adaptive scheme One-sFE.
1. The MSK K can be split up into individual parts: K₁, K₂, K₃, . . . .
   We define individual parts Kᵢ=PRF.Eval(K,i) as shown in the construction.
2. Encryption at index i only requires Kᵢ and Kᵢ₊₁, rather than all of K.
   To show this we define the following local encryption function:
      Post-One-sFE.EncLocal((Kᵢ,Kᵢ₊₁),Enc.st,i,xᵢ).

```
(a) Compute mskᵢ, pᵢ, pᵢ₊₁, r′ₘₛₖ_{ᵢ₊₁}, r′_{Enc}_{ᵢ₊₁}, rₘₛₖ_{ᵢ₊₁}, r_{KeyGen}_{ᵢ₊₁}, kᵢ, k′ᵢ, msk′ᵢ from (Kᵢ, Kᵢ₊₁).
(b) ctᵢ ← OneFSFE.Enc(mskᵢ, (xᵢ, pᵢ, pᵢ₊₁, r′ₘₛₖ_{ᵢ₊₁}, r′_{Enc}_{ᵢ₊₁}, rₘₛₖ_{ᵢ₊₁}, r_{KeyGen}_{ᵢ₊₁}, 0, 0^{λ}, [symbol]  ))
(c) If i = 1, output Post.CT₁ = ct₁.
(d) If i > 1
    i. cᵢ ← SKE.Enc(kᵢ, ⊥)
    ii. c′ᵢ ← SKE′.Enc(k′ᵢ, ⊥)
  iii. Let hᵢ = h_{c}_{ᵢ}_{,c′}_{ᵢ} as defined in Figure 3.
iv. sk′ₕ_{ᵢ} ← OneCompFE.KeyGen(msk′ᵢ, hᵢ)
v. Output CTᵢ = (ctᵢ, sk′ₕ_{ᵢ})
```

iv. skₕ_{ᵢ}′←OneCompFE.KeyGen(mskᵢ′,hᵢ)
v. Output CTᵢ=(ctᵢ,skₕ_{ᵢ}′)
It is then easy to see that local encryption acts identically to regular encryption.
Lemma 5.2. For all K,Enc.st,i,xᵢ and randomness rand,
Post-One-sFE.Enc(K,Enc.st,i,xᵢ;rand)=Post-One-sFE.EncLocal((Kᵢ,Kᵢ₊₁),Enc.st,i,xᵢ;rand)
where Kᵢ=PRF.Eval(K,i) and Kᵢ₊₁=PRF.Eval(K,i+1).
Proof. The proof follows immediately from the definitions of Enc and EncLocal. □
3. Security holds even if we begin the two challenge streams at different (and potentially non-⊥) starting states, as long as their output y values are the same and the starting states are given to the challenger. (Syntatically, if we want to begin the challenge streams at different starting states, then in the security game, if the adversary receives an encryption of stream x^{(b)}, then the starting state for stream x^{(b)} is given as additional input to KeyGen (as in our construction) when generating the function key.)
   We will not prove this here, but it is implicitly shown in the proof of security for One-sFE (which uses Post-One-sFE as a building block).
4. We can generate intermediate decryption states Dec.stᵢ without running through the entire encryption and decryption process. In particular, we just need to know the intermediate state st; along with Kᵢ and ƒ.
   To generate Dec.st₁, we can define the following local key generation function:
      Post-One-sFE.KeyGenLocal(K₁,ƒ,st₁)

(a) Compute msk₁, k₁, p₁, r_{KeyGen}_{₁} from K₁.
(b) c₁ ← SKE.Enc(k₁, ⊥).
(c) [symbol] ₁ = p₁ ⊕ st₁.
(d) Let g₁ = [symbol] as defined in Figure 2.
(e) sk_{g}_{₁} ← OneFSFE.KeyGen(msk₁, g₁; r_{KeyGen}_{₁})
(f) Output Dec.st₁ = (1, sk_{g}_{₁}).

It is then easy to see that local keygen acts identically to regular keygen.
Lemma 5.3. For all K,ƒ,st₁ and randomness rand,
   Post-One-sFE.KeyGen(K,ƒ,st₁;rand)=Post-One-sFE.KeyGenLocal(K₁,ƒ,st₁;rand) where K₁=PRF.Eval(K,1).
Proof. The proof follows immediately from the definitions of KeyGen and KeyGenLocal.
For i>1, we can generate intermediate decryption states with the following function:
   Post-One-sFE.DecStGen(i,Kᵢ,ƒ,stᵢ).
      (a) Compute pᵢ,mskᵢ′,rₘₛₖ_{ᵢ}r_{KeyGen}_{ᵢ},r_{Enc}_{ᵢ}′ from Kᵢ.
      (b) stᵢ=stᵢ® pᵢ.
      (c) ctᵢ′=OneCompFE.Enc(mskᵢ′,(ƒ, [symbol] ,rₘₛₖ_{ᵢ},r_{KeyGen}_{ᵢ},0,0^{λ});r′_{Enc}_{ᵢ}).
      (d) Output Dec.stᵢ=(i,ctᵢ′).
Lemma 5.4. For any streaming function ƒ∈ [symbol] [ [symbol] , [symbol] , [symbol] , [symbol] ] with starting state (by definition, all functions ƒ∈ [symbol] [ [symbol] , [symbol] , [symbol] , [symbol] ] have starting state st₁=⊥. Here, we are using an expanded definition of [symbol] [ [symbol] , [symbol] , [symbol] , [symbol] ] which allows ƒ to have an arbitrary starting state st₁∈{0,1 [symbol] .) st₁ and any stream x=x₁x₂ . . . x_{t*} of length t*>0 where each xᵢ∈{0,1 [symbol] , then

Pr[D₀(MSK)≠D₁(MSK):MSK←Post-One-sFE.Setup(1^{λ}, [symbol] , [symbol] , [symbol] , [symbol] )]≤neg|(λ)
where we define
   D₀(MSK)
      (a) Enc.st←Post-One-sFE.EncSetup(MSK).
      (b) Dec.st₁←Post-One-sFE.KeyGen(MSK,ƒ,st₁).
      (c) For i∈[*],
      i. CTᵢ←Post-One-sFE.Enc(MSK,Enc.st,i,xᵢ).
      ii. (yᵢ,Dec.stᵢ₊₁)=Post-One-sFE.Dec(Dec.stᵢ,CTᵢ)
      (d) Output Dec.st_{t*+1}.
D₁(MSK)

$$Parse MSK = K . \qquad ( a )$$

$${K}_{{t}^{*} + 1} = PRF . Eval ( K , {t}^{*} + 1 ) . \qquad ( b )$$

$$For i ∈ [ {t}^{*} ] , \qquad ( c )$$

$$( {y}_{i} , {st}_{i + 1} ) = f ( {x}_{i} , {st}_{i} ) . \qquad i .$$

$$Output Dec . {st}_{{t}^{*} - 1} = Post - One - sFE . DecStGen ( {t}^{*} + 1 , {K}_{{t}^{*} + 1} , f , {st}_{{t}^{*} + 1} ) . \qquad ( d )$$

Proof. Let ƒ be any streaming function ƒ∈ [symbol] [ [symbol] , [symbol] , [symbol] , [symbol] ] with starting state st₁, and let x=x₁x₂ . . . x_{t*} be any stream of length t*>0 where each xᵢ∈{0,1 [symbol] .
Let us first analyze D₀. Consider
   (a) MSK←Post-One-sFE.Setup(1^{λ}).
   (b) Enc.st←-Post-One-sFE.EncSetup(MSK).
   (c) Dec.st₁←Post-One-sFE.KeyGen(MSK,ƒ,st₁).
   (d) For i∈[*],
      i. CTᵢ←Post-One-sFE.Enc(MSK,Enc.st,i,xᵢ).
For notational convenience, in the following calculations, we will allow Dec.stᵢ for i>1 to be ordered or reordered as either (i,ctᵢ′) or (ctᵢ′,i).
When i=1, by correctness of OneFSFE, except with negligible probability,

$$\begin{matrix}Post - One - sFE . Dec ( Dec . {st}_{1} , {CT}_{1} ) = Post - One - sFE . Dec ( ( 1 , {sk}_{{g}_{1}} ) , {ct}_{1} ) \\ = ( OneFSFE . Dec ( {sk}_{{g}_{1}} , {ct}_{1} ) , 2 ) \\ = ( {g}_{f , {st}_{1} ⊕ {p}_{1} , {c}_{1}} ( {x}_{1} , {p}_{1} , {p}_{2} , {r}_{{msk}_{2}}^{′} , {r}_{{Enc}_{2}}^{′} , {r}_{{msk}_{2}} , {r}_{{KeyGen}_{2}} , 0 , {0}^{λ} , {0}^{{ℓ}_{𝒴}} ) , 2 ) \\ = ( {y}_{1} , {ct}_{2}^{′} , 2 ) \\ = ( {y}_{1} , Dec . {st}_{2} ) for Dec . {st}_{2} = ( 2 , {ct}_{2}^{′} )\end{matrix}$$

where (y₁,st₂)=ƒ(x₁,st₁) and ct₂=OneCompFE.Enc(msk₂′,(ƒ,st₂⊕p₂,rₘₛₖ_{₂},r_{KeyGen}_{₂},0,0^{λ});r_{Enc}_{₂}′). When i=2, by correctness of OneCompFE and OneFSFE, except with negligible probability,

$$Post - One - sFE . Dec ( Dec . {st}_{2} , {CT}_{2} ) = Post - One - sFE . Dec ( ( 2 , {ct}_{2}^{′} ) , ( {ct}_{2} , {sk}_{{h}_{2}}^{′} ) ) = ( OneFSFE . Dec ( OneCompFE . Dec ( {sk}_{{h}_{2}}^{′} , {ct}_{2}^{′} ) , {ct}_{2} ) , 3 ) = ( OneFSFE . Dec ( {h}_{{c}_{2} , {c}_{2}^{′}} ( f , {st}_{2} ⊕ {p}_{2} , {r}_{{msk}_{2}} , {r}_{{KeyGen}_{2}} , 0 , {0}^{λ} ) , {ct}_{2} ) , 3 ) = ( OneFSFE . Dec ( OneFSFE . KeyGen ( {msk}_{2} , {g}_{f , {st}_{2} ⊕ {p}_{2} , {c}_{2}} ; {r}_{{KeyGen}_{2}} ) , {ct}_{2} ) , 3 ) = ( OneFSFE . Dec ( {sk}_{{g}_{2}} , {ct}_{2} ) , 3 ) = ( {g}_{f , {st}_{2} ⊕ {p}_{2} , {c}_{2}} ( {x}_{2} , {p}_{2} , {p}_{3} , {r}_{{msk}_{3}}^{′} , {r}_{{Enc}_{3}}^{′} , {r}_{{msk}_{3}} , {r}_{{KeyGen}_{3}} , 0 , {0}^{λ} , {0}^{{ℓ}_{𝒴}} ) , 3 ) = ( {y}_{2} , {ct}_{3}^{′} , 3 ) = ( {y}_{2} , Dec . {st}_{3} ) for Dec . {st}_{3} = ( 3 , {ct}_{3}^{′} )$$

where (y₂,st₃)=ƒ(x₂,st₂) and ct₃′=OneCompFE.Enc(msk₃′,(ƒ,st₃⊕p₃,rₘₛₖ_{₃},r_{KeyGen}_{₃},0,0^{λ});r_{Enc}_{₃}′). Similarly, by induction, for i>2, except with negligible probability,

$$Post - One - sFE . Dec ( Dec . {st}_{i} , {CT}_{i} ) = ( {y}_{i} , Dec . {st}_{i + 1} ) for Dec . {st}_{i + 1} = ( i + 1 , {ct}_{i + 1}^{′} )$$

where (yᵢ,stᵢ₊₁)=ƒ(xᵢ,stᵢ) and ctᵢ₊₁′=OneCompFE.Enc(mskᵢ₊₁′,(ƒ,stᵢ₊₁⊕pᵢ₊₁,rₘₛₖ_{ᵢ₊₁}′) r_{KeyGen}_{ᵢ₊₁},0,0^{λ});r_{Enc}_{ᵢ₊₁}′)
Thus, except with negligible probability, D₀(MSK) outputs (t*+1, ct_{t*+1}′) where ct_{t*+1}′=OneCompFE.Enc(msk_{t*+1}′,(ƒ,st_{t*++1}⊕p_{t*+1},rₘₛₖ_{_{t*+1)}},r_{KeyGen}_{_{t*+1}},0,0^{λ});r_{Enc}_{_{t*+1}}′). But this is exactly what D₁(MSK) outputs! Therefore the two distributions have identical output except with negligible probability. □

### 6 Combining Pre-One-sFE and Post-One-sFE to Build One-sFE

We now construct our main building block: a single-key, single-ciphertext, adaptively secure, secret-key sFE scheme which we call One-sFE. We prove the following:
Theorem 6.1. Assuming i [symbol] for P/Poly and injective PRGs, there exists a single-key, single-ciphertext, adaptively secure, secret-key sFE scheme for P/Poly.

We build our scheme by combining the following two schemes:
Pre-One-sFE: the single-key, single-ciphertext, selectively secure sFE scheme for [symbol] defined in Section 4.
Post-One-sFE: the single-key, single-ciphertext, function-selectively secure sFE scheme for P/Poly defined in Section 5.

This is not a general transformation as our security proof is very non-black-box and relies on properties of both schemes. The technical overview provided herein discloses a high level overview of our construction.

By Theorem 4.1, we can build Pre-One-sFE from i [symbol] and injective PRGs. By Theorem 5.1, we can build Post-One-sFE from a strongly-compact, selectively secure, secret-key FE scheme for P/Poly which in turn can be built from i [symbol] for P/Poly and OWFs. As OWFs are implied by PRGs, then our final scheme One-sFE can also be built from i [symbol] for P/Poly and injective PRGs.

### 6.1 Parameters

On security parameter λ, function size [symbol] , state size [symbol] , input size [symbol] , and output size [symbol] , we will instantiate our primitives with the following parameters:
Post-One-sFE: We instantiate Post-One-sFE with function size [symbol] , state size [symbol] , input size [symbol] , and output size [symbol] .
Pre-One-sFE: We instantiate Pre-One-sFE with function size [symbol] , state size [symbol] , input size Lₓ, and output size L_{y} where
   [symbol] is the size of Post-One-sFE's decryption function under the parameters listed above;
   [symbol] is the size of Post-One-sFE's decryption states under the parameters listed above;
   Lₓ is the size of Post-One-sFE's ciphertexts under the parameters listed above;
   L_{y}= [symbol] .

### 6.2 Construction

We now construct One-sFE from Pre-One-sFE and Post-One-sFE. Here, we omit the encryption state from the encryption algorithms of both Pre-One-sFE and Post-One-sFE as their encryption states are always L and are unused.

We also use the following notational variations when defining Pre-One-sFE and Post-One-sFE as was already made explicit in the constructions given in Section 4 and Section 5: We define the KeyGen algorithms of Pre-One-sFE and Post-One-sFE to additionally take the starting state as input. We also write Post-One-sFE so that its decryption algorithm is a streaming function in the standard format (i.e. takes only two inputs: a decryption state and a ciphertext). Note that in this case, Post-One-sFE.KeyGen simply outputs the first decryption state.

```
· One-sFE.Setup(1, [symbol]   , [symbol]   , [symbol]   , [symbol]   ):
  1. Pre.MSK ← Pre-One-sFE.Setup(1^{λ}, [symbol]   , [symbol]   , 1^{Lx}, 1^{Ly}).
  2. Post.MSK ← Post-One-sFE.Setup(1^{λ}, [symbol]   , [symbol]   , [symbol]   , [symbol]   ).
  3. Output MSK = (Pre.MSK, Post.MSK).
. One-sFE.EncSetup(MSK): Output Enc.st = ⊥.
· One-sFE.Enc(MSK, Enc.st, i, xᵢ):
  1. Parse MSK = (Pre.MSK, Post.MSK).
  2. Post.CTᵢ ← Post-One-sFE.Enc(Post.MSK, i, xᵢ).
  3. Pre.CTᵢ ← Pre-One-sFE.Enc(Pre.MSK, i, Post.CTᵢ).
  4. Output CTᵢ = Pre.CTᵢ.
· One-sFE.KeyGen(MSK, f):
  1. Parse MSK = (Pre.MSK, Post.MSK).
  2. Post. Dec.st₁ ← Post-One-sFE.KeyGen(Post.MSK, f, st₁) where st₁ = ⊥.
  3. Pre.SK_{f} ← Pre-One-sFE.KeyGen(Pre.MSK, Post-One-sFE.Dec, Post.Dec.st₁).
  4. Output SK_{f} = Pre.SK_{f}.
· One-sFE.Dec(SK_{f}, Dec.stᵢ, i, CTᵢ):
  1. Parse SK_{f} = Pre.SK, and CTᵢ = Pre.CTᵢ.
  2. If i > 0, parse Dec.stᵢ = Pre. Dec.stᵢ. If i = 1, Pre.Dec.st₁ = ⊥.
  3. (yᵢ, Pre.Dec.stᵢ₊₁) = Pre-One-sFE.Dec(Pre.SK_{f}, Pre.Dec.stᵢ, i, Pre.CTᵢ).
  4. Output (yᵢ, Dec.stᵢ₊₁ = Pre.Dec.stᵢ₊₁).
```

### 6.3 Correctness and Efficiency

Efficiency. Efficiency follows directly from the efficiency requirements of Pre-One-sFE and Post-One-sFE.

By the streaming efficiency of Post-One-sFE, the size and runtime of all algorithms of Post-One-sFE on security parameter λ, function size [symbol] , state size [symbol] , input size [symbol] , and output size [symbol] are poly(λ, [symbol] , [symbol] , [symbol] , [symbol] ).

By the streaming efficiency of Pre-One-sFE, the size and runtime of all algorithms of Pre-One-sFE on security parameter λ, function size [symbol] , state size [symbol] , input size Lₓ, and output size L_{y} are poly(λ, [symbol] , [symbol] ,Lₓ,L_{y}) which are poly(λ, [symbol] , [symbol] , [symbol] , [symbol] ) by the streaming efficiency of Post-One-sFE.

Thus, the size and runtime of all algorithms of One-sFE on security parameter λ, function size [symbol] , state size [symbol] , input size [symbol] , and output size [symbol] are poly(λ, [symbol] , [symbol] , [symbol] , [symbol] )

Correctness Intuition. One-sFE composes Post-One-sFE and Pre-One-sFE in the following manner:
Post-One-sFE encrypts the stream x₁, x₂, . . . , xₙ and creates a function key for ƒ.
Pre-One-sFE encrypts the stream Post.CT₁, Post.CT₂, . . . , Post.CTₙ of Post-One-sFE ciphertexts, and creates a function key for Post-One-sFE.Dec.

The decryption algorithm for One-sFE simply runs Pre-One-sFE's decryption algorithm. This means we will compute the output of running Post-One-sFE.Dec on the stream Post.CT₁, Post.CT₂, . . . , Post.CTₙ. But this means we will run Post-One-sFE's decryption algorithm and thus will compute the output of running ƒ on our original stream x₁, x₂, . . . , xₙ. Thus, we will get the correct output values we desire.

Correctness. More formally, let p be any polynomial and consider any λ and any [symbol] , [symbol] , [symbol] , [symbol] ≤p(λ). Let SK_{ƒ} be a function key for function ƒ∈ [symbol] [ [symbol] , [symbol] , [symbol] , [symbol] ], and let {CTᵢ}_{i∈[n]} be a ciphertext for x where x=x₁ . . . xₙ for some n∈[2^{λ}] and where each xᵢ∈{0,1 [symbol] . For all i∈[n], by correctness of Pre-One-sFE, except with negligible probability,

$$\begin{matrix}One - sFE . Dec ( {SK}_{f} , Dec . {st}_{i} , i , {CT}_{i} ) = Pre - One - sFE . Dec ( Pre . {SK}_{f} , Pre . Dec . {st}_{i} , i , Pre . {CT}_{i} ) \\ = ( {y}_{i} , Pre . Dec . {st}_{i + 1} ) \\ = ( {y}_{i} , Dec . {st}_{i + 1} )\end{matrix}$$

where yᵢ is the i^{th} output in the computation of the streaming function Post-One-sFE.Dec on the stream Post.CT₁, Post.CT₂, . . . , Post.CTₙ, that is, we compute each yᵢ by computing (yᵢ,Post.Dec.stᵢ₊₁)=Post-One-sFE.Dec(Post.Dec.stᵢ,Post.CTᵢ). For all i∈[n], by correctness of Post-One-sFE, except with negligible probability,

$$Post - One - sFE . Dec ( Post . Dec . {st}_{i} , Post . {CT}_{i} ) = ( {y}_{i} , Post . Dec . {st}_{i + 1} )$$

where (yᵢ,stᵢ₊₁)=ƒ(xᵢ,stᵢ). Thus, we correctly output y=y₁ . . . yₙ where (yᵢ,stᵢ₊₁)=ƒ(xᵢ,stᵢ).

### 7 Bootstrapping to an Adaptively Secure, Public-Key Streaming FE Scheme

To construct our adaptively secure, public-key sFE scheme, we use the following theorem which is implied by the prior work.
Theorem 7.1. Assuming
   1. a selectively secure, public-key FE scheme for P/Poly
   2. a single-key, single-ciphertext, adaptively secure, secret-key, sFE scheme for P/Poly there exists an adaptively secure, public-key sFE scheme for P/Poly.

Since the prior work only proves this theorem for function-selectively secure sFE schemes, for completeness, we provide a proof of Theorem 7.1 here. The prior work remarks, but does not formally prove, that their theorem should also hold for adaptively secure schemes. Apart from the fact that One-sFE now represents a (single-key, single-ciphertext) adaptively secure scheme, rather than a (single-key, single-ciphertext) function-selectively secure scheme, our construction is identical to the construction in prior work. Our proof of security is also essentially the same. We have merely reordered some of the steps in the hybrids so that they align with the adaptive security game. For a high level overview of the construction, we refer the reader to the Technical Overview of the prior work.

To prove Theorem 7.1, we build an sFE scheme from the following tools. As we show below, apart from One-sFE, all of the following tools can be instantiated using a selectively secure, public-key FE scheme for P/Poly.

### Tools.

One-sFE=(One-sFE.Setup,One-sFE.Enc,One-sFE.KeyGen,One-sFE.Dec): A single-key, single-ciphertext, adaptively secure, secret-key sFE scheme for P/Poly.
PRF=(PRF.Setup,PRF.Eval): A secure pseudorandom function family.
PRF2=(PRF2.Setup,PRF2.Eval): A secure pseudorandom function family.
SKE=(SKE.Setup,SKE.Enc,SKE.Dec): A secure symmetric key encryption scheme with pseudorandom ciphertexts.
FPFE=(FPFE.Setup,FPFE.Enc,FPFE.KeyGen,FPFE.Dec): A function-private-selective-secure, secret-key FE scheme for P/Poly
FE=(FE.Setup,FE.Enc,FE.KeyGen,FE.Dec): A selectively secure, public-key FE scheme for P/Poly.

Instantiation of the Tools. Let FE′ be a selectively secure, public-key FE scheme for P/Poly.
We can build PRF, PRF2, SKE from any one-way-function using standard cryptographic techniques. As FE′ implies one-way-functions, then we can build these from FE′.
FE′ already satisfies the security requirements needed for FE.
FE′ immediately implies a selectively secure, secret-key FE scheme SKFE′ for P/Poly. We can then build our function-private-selective-secure, secret-key FE scheme FPFE for P/Poly by using the function-privacy transformation of prior work on SKFE′.

### 7.1 Parameters

The parameters are identical to those in prior work since our construction is identical to the prior work except for the fact that One-sFE now represents a (single-key, single-ciphertext) adaptively secure scheme, rather than a (single-key, single-ciphertext) function-selectively secure scheme.

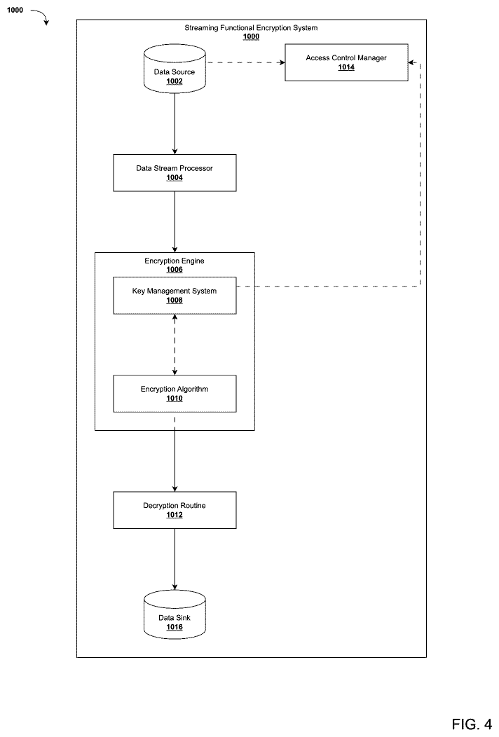

On security parameter λ, function size [symbol] , state size [symbol] , input size [symbol] , and output size [symbol] , we will instantiate our primitives with the following parameters:
One-sFE: We instantiate One-sFE with function size [symbol] , state size [symbol] , input size [symbol] , and output size [symbol] . This means that we will use the following setup algorithm: One-sFE.Setup(1^{λ}, [symbol] , [symbol] , [symbol] , [symbol] ).
PRF: We instantiate PRF with input size λ and output size 5. This means that we will use the following setup algorithm: PRF.Setup(1^{λ},1^{λ},1^{5λ}).
PRF2: We instantiate PRF2 with input size λ and output size λ. This means that we will use the following setup algorithm: PRF2.Setup(1^{λ},1^{λ},1^{λ}).
FPFE: We instantiate FPFE with
   Input Size: [symbol] _{FPFE.m}_{_{λ}}= [symbol] _{One-sFE.msk}_{_{λ}}+ [symbol] _{One-sFE.Enc.st}_{_{λ}}+ [symbol] _{PRF2.k}_{_{λ}}+2 where [symbol] _{One-sFE.msk}_{_{λ}} is the size of master secret keys of One-sFE, (One-sFE.Enc.st is the size of encryption states of One-sFE, and [symbol] _{PRF2.k}_{_{λ}} is the size of keys of PRF2.
   Function Size: CH where CH is the maximum of the size of H_{i,x}_{ᵢ}_{,t}_{ᵢ} defined in FIG. 4 and the size of H_{i,x}_{ᵢ}_{,x}_{ᵢ}_{′,t}_{ᵢ}_{,v}_{ᵢ}* defined in FIG. 6 for any
      i,tᵢ∈{0,1}^{λ}
      xᵢ,xᵢ′∈{0,1 [symbol]
      vᵢ of size [symbol] _{One-sFE.ct}_{_{λ}} where [symbol] _{One-sFE.ct}_{_{λ}} is the size of ciphertexts of One-sFE
   Observe that the function size depends only on λ, [symbol] , [symbol] , [symbol] , [symbol] and the sizes of PRF2, and One-sFE.
   Output Size: [symbol] _{One-sFE.ct}_{_{λ}} where [symbol] _{One-sFE.ct}_{_{λ}} is the size of ciphertexts of One-sFE
This means that we will use the following setup algorithm: FPFE.Setup(1^{λ}, [symbol] , [symbol] , [symbol] ).
SKE: We instantiate SKE with messages of length [symbol] _{SKE.m}_{_{λ}}= [symbol] _{One-sFE.sk}_{_{λ}}+ [symbol] _{FPFE.ct}_{_{λ}} where [symbol] _{One-sFE.sk}_{_{λ}} is the size of function keys of One-sFE and [symbol] _{FPFE.ct}_{_{λ}} is the size of ciphertexts of FPFE. This means that we will use the following setup algorithm: SKE.Setup(1^{λ}, [symbol] ).
FE: We instantiate FE with
   Input Size: [symbol] _{FE.m}_{_{λ}}= [symbol] _{FPFE.msk}_{_{λ}}+ [symbol] _{PRF.k}_{_{λ}}+1+ [symbol] _{SKE.k}_{_{λ}} where [symbol] _{FPFE.msk}_{_{λ}} is the size of master secret keys of FPFE, [symbol] _{PRF.k}_{_{λ}} is the size of keys of PRF, and [symbol] _{SKE.k}_{_{λ}} is the size of keys of SKE.
   Function Size: [symbol] _{G}_{_{λ}} where [symbol] _{G}_{_{λ}} is the maximum size of G_{ƒ,s,c} defined in FIG. 5 for any
      ƒ∈ [symbol] [ [symbol] , [symbol] , [symbol] , [symbol] ]
      [symbol] ∈{0,1}^{λ}
      c of size [symbol] _{SKE.ct}_{_{λ}} where [symbol] _{SKE.ct}_{_{λ}} is the size of ciphertexts of SKE
   Note that the function size depends only on λ, [symbol] , [symbol] , [symbol] , [symbol] and the sizes of PRF, PRF2, One-sFE, FPFE, and SKE.
   Output Size: [symbol] _{FE.out}_{_{λ}}= [symbol] _{OnesFE.sk}_{_{λ}}+ [symbol] _{FPFE.ct}_{_{λ}} where [symbol] _{One-sFE.sk}_{_{λ}} is the size of secret keys of One-sFE and [symbol] _{FPFE.ct}_{_{λ}} is the size of ciphertexts of FPFE
This means that we will use the following setup algorithm: FE.Setup(1^{λ}, [symbol] , [symbol] , [symbol] ).
FE.Enc(1^{λ}, [symbol] , [symbol] , [symbol] ,·,·),
FE.KeyGen (1^{λ}, [symbol] , [symbol] , [symbol] ,·,·), FE.Dec(1^{λ}, [symbol] , [symbol] , [symbol] ,·,·)

Notation. For notational convenience, when the parameters are understood, we will often omit the security, input size, output size, message size, function size, or state size parameters from each of the algorithms listed above.
Remark 7.2. We assume without loss of generality that for security parameter λ, all algorithms only require randomness of length λ. If the original algorithm required additional randomness, we can replace it with a new algorithm that first expands the λ bits of randomness using a PRG of appropriate stretch and then runs the original algorithm. Note that this replacement does not affect the security of the above schemes (as long as [symbol] , [symbol] , [symbol] , [symbol] are polynomial in λ).

### 7.2 Construction

We now construct our streaming FE scheme sFE. Our construction is identical to the prior work except for the fact that One-sFE now represents a (single-key, single-ciphertext) adaptively secure scheme, rather than a (single-key, single-ciphertext) function-selectively secure scheme. Recall that for notational convenience, we may omit the security, input size, output size, message size, function size, or state size parameters from our algorithms. For information on these parameters, please see the parameter section above.

```
  • sFE.Setup(1^{λ}, [symbol]   , [symbol]   , [symbol]   , [symbol]   ):
    1. (FE.mpk, FE.msk) ← FE.Setup(1^{λ})
    2. Output (MPK = FE.mpk, MSK = FE.msk).
  • sFE.EncSetup(MPK):
    1. Parse MPK = FE.mpk.
    2. PRF.K ← PRF.Setup(1^{λ}).
    3. FPFE.msk ← FPFE.Setup(1^{λ})
    4. FE.ct ← FE.Enc(FE.mpk, (FPFE.msk, PRF.K, 0, [symbol]   )).
    5. Output Enc.ST = (FPFE.msk, FE.ct).
  • sFE.Enc(MPK, Enc.ST, i, xᵢ):
    1. Parse Enc.ST = (FPFE.msk, FE.ct).
    2. tᵢ ← {0, 1}^{λ}.
    3. Let Hᵢ = H_{i,x}_{ᵢ}_{,t}_{ᵢ} as defined in Figure 4.
    4. FPFE.sk_{H}_{ᵢ} = FPFE.KeyGen(FPFE.msk, Hᵢ)
    5. If i = 1, output CT₁ = (FE.ct, FPFE.sk_{H}_{₁}).
    6. Else, output CTᵢ = FPFE.sk_{H}_{ᵢ}
H_{i,x}_{ᵢ}_{,t}_{ᵢ}(One-sFE.msk, One-sFE.Enc.st, PRF2.k, β):
  1. If β = 0
    (a) rᵢ ← PRF2.Eval(PRF2.k, tᵢ)
    (b) Output One-sFE.ctᵢ ← One-sFE.Enc(One-sFE.msk, One-sFE.Enc.st, i, xᵢ; rᵢ)
  2. Else, output ⊥
Figure 4: Definition of H_{i,x}_{ᵢ}_{,t}_{ᵢ}
  • sFE.KeyGen(MSK, f):
    1. Parse MSK = FE.msk.
    2. s ← {0, 1}^{λ}.
    3. c ← {0, 1 [symbol]   .
    4. Let G = G_{f,s,c} as defined in Figure 5.
    5. FE.sk_{G} ← FE.KeyGen(FE.msk, G).
    6. Output SK_{f} = FE.sk_{G}.
G_{f,s,c}(FPFE.msk, PRF.K, α, SKE.k):
  1. If α = 0
    (a) (r_{Setup}, r_{KeyGen}, r_{EncSetup}, r_{PRF2}, r_{Enc}) ← PRF.Eval(PRF.K, s)
    (b) One-sFE.msk ← One-sFE.Setup(1^{λ}; r_{Setup})
    (c) One-sFE.Enc.st ← One-sFE.EncSetup(One-sFE.msk; r_{EncSetup})
    (d) One-sFE.sk_{f} ← One-sFE.KeyGen(One-sFE.msk, f; r_{KeyGen})
    (e) PRF2.k ← PRF2.Setup(1^{λ}; r_{PRF2})
    (f) FPFE.ct ← FPFE.Enc(FPFE.msk, (One-sFE.msk, One-sFE.Enc.st, PRF2.k, 0); r_{Enc})
    (g) Output (One-sFE.sk_{f}, FPFE.ct)
  2. Else
    (a) Output (One-sFE.sk_{f}, FPFE.ct) ← SKE.Dec(SKE.k, c)
Figure 5: Definition of G_{f,s,c}
  • sFE.Dec(SK_{f}, Dec.STᵢ, i, CTᵢ):
    1. If i = 1
      (a) Parse CT₁ = (FE.ct, FPFE.sk_{H}_{ᵢ}) and SK_{f} = FE.sk_{G}.
      (b) (One-sFE.sk_{f}, FPFE.ct) = FE.Dec(FE.sk_{G}, FE.ct)
      (c) Set One-sFE.Dec.st₁ = ⊥.
    2. If i > 1
      (a) Parse CTᵢ = FPFE.sk_{H}_{ᵢ}
      (b) Parse Dec.STᵢ = (One-sFE.sk_{f}, FPFE.ct, One-sFE.Dec.stᵢ)
    3. One-sFE.ctᵢ = FPFE.Dec(FPFE.sk_{H}_{ᵢ}, FPFE.ct)
    4. (yᵢ, One-sFE.Dec.stᵢ₊₁) = One-sFE.Dec(One-sFE.sk_{f}, One-sFE. Dec.stᵢ, i,
      One-sFE.ctᵢ)
    5. Output (yᵢ, Dec.STᵢ₊₁ = (One-sFE.sk_{f}, FPFE.ct, One-sFE.Dec.stᵢ₊₁))
```

We also define the following function which will be used in our security proof.

Figure 6: Definition of H*_{i,x}_{ᵢ}_{,x′}_{ᵢ}_{,t}_{ᵢ}_{,v}_{ᵢ}

```
H*_{i,x}_{ᵢ}_{,x′}_{ᵢ}_{,t}_{ᵢ}_{,v}_{ᵢ}(One-sFE.msk, One-sFE.Enc.st, PRF2.k, β):
  • If β = 0
    1. rᵢ ← PRF2.Eval(PRF2.k, tᵢ)
    2. Output One-sFE.ctᵢ ← One-sFE.Enc(One-sFE.msk, One-sFE.Enc.st, i, xᵢ; rᵢ)
  • If β = 1
    1. rᵢ ← PRF2.Eval(PRF2.k, tᵢ)
    2. Output One-sFE.ctᵢ ← One-sFE.Enc(One-sFE.msk, One-sFE.Enc.st, i, x′ᵢ; rᵢ)
  • Else, output vᵢ
```

### 7.3 Correctness and Efficiency

Correctness and efficiency follow from the corresponding theorems in prior work since our construction is identical to prior work except for the fact that One-sFE now represents a (single-key, single-ciphertext) adaptively secure scheme, rather than a (single-key, single-ciphertext) function-selectively secure scheme. However, this difference only affects the security of One-sFE and thus only affects the proof of security.

### EXAMPLE EMBODIMENTS

Some embodiments may comprise a method for a streaming functional encryption scheme with adaptive security, the method comprising:
(a) building a single-key, single-ciphertext, adaptively secure adaptive streaming functional encryption scheme;
(b) executing a bootstrap of this scheme into a full multi-key, multi-ciphertext, public-key adaptive streaming functional encryption scheme;
   wherein building the single key scheme (i) further comprises:
(a) a setup routine configured for
   (i) taking as input a security parameter and parameters about the functions, including a function size, a state size, an input size, and an output size;
   (ii) running the setup algorithm of Post-One-sFE, wherein Post-One-sFE is a single-key, single-ciphertext, secret-key streaming functional encryption scheme where security only holds if the ciphertexts are given after the function keys;
   (iii) creating additional PRF keys for use in generating subsequent encryption and signature schemes;
   (iv) outputting the master secret key as the Post-One-sFE master secret key along with the additional PRF keys.
(b) an encryption routine configured for:
   (i) taking as input the master secret key, an index i, and a message xᵢ;
   (ii) encrypting xᵢ using the Post-One-sFE scheme;
   (iii) encrypting the Post-One-sFE ciphertext under an SKE scheme (to get a nested encryption) and signing it with a signature scheme;
   (iv) outputting the ciphertext as the nested encryption and its signature.
(c) a key generation routine configured for:
   (i) taking as input the master secret key and a function ƒ;
   (ii) creating a function key for ƒ under the Post-One-sFE scheme, which we treat as state st₁;
   (iii) encrypting the Post-One-sFE function key under an SKE scheme (to get a nested encryption) and signing it with a signature scheme;
   (iv) generating an iterator itr;
   (v) obfuscating a program Prog that takes in encryptions of xᵢ and stᵢ along with their signatures and an iterator state, decrypts and verifies these inputs, runs the decryption algorithm of Post-One-sFE to get (yᵢ,stᵢ₊₁) where ƒ(xᵢ,stᵢ)=(yᵢ,stᵢ₊₁), and outputs yᵢ, a new signed and encrypted state ciphertext for stᵢ₊₁, and an updated iterator;
   (vi) outputting the function key which consists of the obfuscated program, the nested encryption for state st₁ and its signature, and an iterator state itr.
(d) a decryption routine configured for:
   (i) running the obfuscated program on the encrypted and signed input and state ciphertexts and the current iterator to get an encrypted and signed state ciphertext for the next step, an output yᵢ, and an updated iterator.
      wherein the bootstrap step (ii) further comprises:
(a) a setup routine configured for
   (i) taking as input a security parameter and parameters about the functions, including a function size, a state size, an input size, and an output size;
   (ii) running the setup algorithm of a public key FE scheme and using these outputs as its master public key and master secret key;
(b) an encryption setup routine configured for:
   (i) taking as input the master secret key, an index i, and a message xᵢ;
   (ii) creating a new FPFE master secret key, where FPFE is a function-private, secret key FE scheme;
   (iii) encrypting the FPFE master secret key under the public key FE scheme;
   (iv) outputting an encryption state consisting of the FPFE master secret key and this ciphertext;
(c) an encryption routine configured for:
   (i) taking as input the master public key, the encryption state, an index i, and a value xᵢ;
   (ii) generating an FPFE function key for the function Hₓ_{ᵢ} which takes as input a One-sFE master secret key and encrypts the hardwired value xᵢ under this key, where One-sFE is our single-key, single-ciphertext, secret-key FE scheme;
   (iii) outputting the FPFE function key as the ciphertext for xᵢ.
(d) a key generation routine configured for:
   (i) taking as input the master secret key for the FE scheme and a function ƒ;
   (ii) generating an FE function key for the function Gf which takes as input the FPFE master secret key, generates a fresh One-sFE master secret key, encrypts the One-sFE master secret key under the FPFE scheme, generates a One-sFE function key for ƒ, and outputs this One-sFE function key along with the FPFE ciphertext;
   (iii) outputting a function key consisting of the FE function key for Gf.
(e) a decryption routine configured for:
   (i) taking as input a function key for ƒ, a decryption state, an index i, and a ciphertext of xᵢ;
   (ii) if this is the first iteration, running the FE decryption algorithm on the FE function key for G (contained in the function key) and the FE ciphertext (contained in the ciphertext for x₁) to get a FPFE ciphertext and a One-sFE function key;
   (iii) running the FPFE decryption algorithm on the FPFE function key (contained in the ciphertext for xᵢ) and the FPFE ciphertext (either contained in the decryption state or computed as above) to get a One-sFE ciphertext;
   (iv) running the One-sFE decryption algorithm on the the One-sFE function key (either contained in the decryption state or just computed as above), the One-sFE ciphertext just computed, and the One-sFE decryption state (contained in the decryption state) to get yᵢ and a new One-sFE decryption state;
   (v) outputting yᵢ along with a decryption state consisting of the One-sFE function key, the FPFE ciphertext, and the new One-sFE decryption state.

Further embodiments may comprise storing the result and outputting the result by transmitting it over a network in a streaming fashion.

In further embodiments, the key generation routine for the single key scheme further comprises:
(a) taking as input the master secret key and a function ƒ;
(b) first generating a function key Post.sk_{ƒ} for ƒ under the Post-One-sFE scheme;
(c) encrypting Post.sk_{ƒ} using the SKE scheme derived from K_{E} to get ct_{st,1};
(d) generating an iterator with public parameters pp and starting iterator state itr;
(e) signing message m₁=(1,ct_{st,1},itr) using the signature scheme derived from K_{A};
(f) producing an obfuscation of the following program Prog; and
(g) outputting the function key as the obfuscation of Prog, the state ciphertext ct_{st,i}, the signature on m₁, and the iterator state itr.

In some further embodiments, Prog has hardwired into it Kᵢₙₚ,K_{A},K_{E},pp and takes as input an index i, an input ciphertext ct_{inp,i}, a state ciphertext ct_{st,i}, signatures for both ciphertexts, and an iterator state; and further comprising:
(a) checking that i is positive and verify the signatures on the input and state ciphertexts using a verification key derived from K_{A};
(b) decrypting the input and state ciphertexts using a secret key derived from K_{E} and evaluating the Post-One-sFE decryption algorithm on these values, resulting in an updated Post-One-sFE decryption state and an output value yᵢ;
(c) encrypting the new state using randomness derived from K_{E};
(d) iterating into the iterator some of the new values computed;
(e) signing the new values using a signature scheme derived from K_{A}; and
(f) outputting yᵢ, the new encryption, the new signature, and the updated iterator.

In some further embodiments, the dataset is very large or continuously evolving.

In some further embodiments, the data set is stored or streamed.

Some further embodiments comprise training a machine learning algorithm on a dataset that is continually evolving.

Some further embodiments comprise issuing a new key in the middle of a stream.

Some embodiments comprise a system for a streaming functional encryption scheme with adaptive security, the system comprising a processor coupled to a storage device, the processor being configured for:
(a) building a single-key, single-ciphertext, adaptively secure adaptive streaming functional encryption scheme;
(b) executing a bootstrap of this scheme into a full multi-key, multi-ciphertext, public-key adaptive streaming functional encryption scheme;
   wherein building the single key scheme (i) further comprises:
(a) a setup routine configured for
   (i) taking as input a security parameter and parameters about the functions, including a function size, a state size, an input size, and an output size;
   (ii) running the setup algorithm of Post-One-sFE, wherein Post-One-sFE is a single-key, single-ciphertext, secret-key streaming functional encryption scheme where security only holds if the ciphertexts are given after the function keys;
   (iii) creating additional PRF keys for use in generating subsequent encryption and signature schemes;
   (iv) outputting the master secret key as the Post-One-sFE master secret key along with the additional PRF keys.
(b) an encryption routine configured for:
   (i) taking as input the master secret key, an index i, and a message xᵢ;
   (ii) encrypting xᵢ using the Post-One-sFE scheme;
   (iii) encrypting the Post-One-sFE ciphertext under an SKE scheme (to get a nested encryption) and signing it with a signature scheme;
   (iv) outputting the ciphertext as the nested encryption and its signature.
(c) a key generation routine configured for:
   (i) taking as input the master secret key and a function ƒ;
   (ii) creating a function key for ƒ under the Post-One-sFE scheme, which we treat as state st₁;
   (iii) encrypting the Post-One-sFE function key under an SKE scheme (to get a nested encryption) and signing it with a signature scheme;
   (iv) generating an iterator itr;
   (v) obfuscating a program Prog that takes in encryptions of xᵢ and stᵢ along with their signatures and an iterator state, decrypts and verifies these inputs, runs the decryption algorithm of Post-One-sFE to get (yᵢ,stᵢ₊₁) where ƒ(xᵢ,stᵢ)=(yᵢ,stᵢ₊₁), and outputs yᵢ, a new signed and encrypted state ciphertext for stᵢ₊₁, and an updated iterator;
   (vi) outputting the function key which consists of the obfuscated program, the nested encryption for state st₁ and its signature, and an iterator state itr.
(d) a decryption routine configured for:
   (i) running the obfuscated program on the encrypted and signed input and state ciphertexts and the current iterator to get an encrypted and signed state ciphertext for the next step, an output yᵢ, and an updated iterator.
      wherein the bootstrap step (ii) further comprises:
(a) a setup routine configured for
   (i) taking as input a security parameter and parameters about the functions, including a function size, a state size, an input size, and an output size;
   (ii) running the setup algorithm of a public key FE scheme and using these outputs as its master public key and master secret key;
(b) an encryption setup routine configured for:
   (i) taking as input the master secret key, an index i, and a message xᵢ;
   (ii) creating a new FPFE master secret key, where FPFE is a function-private, secret key FE scheme;
   (iii) encrypting the FPFE master secret key under the public key FE scheme;
   (iv) outputting an encryption state consisting of the FPFE master secret key and this ciphertext;
(c) an encryption routine configured for:
   (i) taking as input the master public key, the encryption state, an index i, and a value xᵢ;
   (ii) generating an FPFE function key for the function Hₓ_{ᵢ} which takes as input a One-sFE master secret key and encrypts the hardwired value xᵢ under this key, where One-sFE is our single-key, single-ciphertext, secret-key FE scheme;
   (iii) outputting the FPFE function key as the ciphertext for xᵢ.
(d) a key generation routine configured for:
   (i) taking as input the master secret key for the FE scheme and a function ƒ;
   (ii) generating an FE function key for the function Gf which takes as input the FPFE master secret key, generates a fresh One-sFE master secret key, encrypts the One-sFE master secret key under the FPFE scheme, generates a One-sFE function key for ƒ, and outputs this One-sFE function key along with the FPFE ciphertext;
   (iii) outputting a function key consisting of the FE function key for Gf.
(e) a decryption routine configured for:
   (i) taking as input a function key for ƒ, a decryption state, an index i, and a ciphertext of xᵢ;
   (ii) if this is the first iteration, running the FE decryption algorithm on the FE function key for G (contained in the function key) and the FE ciphertext (contained in the ciphertext for x₁) to get a FPFE ciphertext and a One-sFE function key;
   (iii) running the FPFE decryption algorithm on the FPFE function key (contained in the ciphertext for xᵢ) and the FPFE ciphertext (either contained in the decryption state or computed as above) to get a One-sFE ciphertext;
   (iv) running the One-sFE decryption algorithm on the the One-sFE function key (either contained in the decryption state or just computed as above), the One-sFE ciphertext just computed, and the One-sFE decryption state (contained in the decryption state) to get yᵢ and a new One-sFE decryption state;
   (v) outputting yᵢ along with a decryption state consisting of the One-sFE function key, the FPFE ciphertext, and the new One-sFE decryption state.

### System Implementations

### System Overview

Referring to FIG. 1, a schematic representation of a streaming functional encryption system is illustrated. The system may include a database containing multiple records, including a first database record 1, a second database record 2, and a third database record 3. These records may be accessed in a streaming fashion, as indicated by the streaming access arrow connecting the database to the streaming functional encryption component.

The streaming functional encryption component may comprise two main sections: an outer section labeled “streaming functional encryption” and an inner section labeled “bootstrap”. This structure reflects the process of building a single-key, single-ciphertext, adaptively secure streaming functional encryption scheme and executing a bootstrap of this scheme into a full multi-key, multi-ciphertext, public-key adaptive streaming functional encryption scheme.

In some cases, the bootstrap section may contain several functional routines:
1. A setup routine
2. An encryption setup routine
3. An encryption routine
4. A key generation routine
5. A decryption routine

Adjacent to these routines, the bootstrap section may include a component labeled “single-key, single-ciphertext, adaptively secure adaptive streaming functional encryption scheme” which may contain its own set of routines:
1. A setup routine
2. An encryption routine
3. A key generation routine
4. A decryption routine

The streaming access functionality may connect the database records to the streaming functional encryption component, allowing for secure data processing and access control between these system elements.

In some cases, the system may support dynamically generating an additional functional key corresponding to a new function during stream generation. This feature may enhance the flexibility of the system, allowing for the introduction of new functions even after the encryption process has begun.

The system may also be capable of applying the additional functional key iteratively to all ciphertext segments of the stream, including those generated prior to the generation of the additional functional key. This capability may allow for retroactive application of new functions to previously encrypted data, potentially increasing the utility and adaptability of the system.

The diagram shows the hierarchical relationship between the components, with the streaming functional encryption serving as the outer framework that encompasses the bootstrap functionality and associated encryption schemes. This structure may allow for the transformation of the single-key, single-ciphertext scheme into a more comprehensive multikey, multi-ciphertext, public-key adaptive streaming functional encryption scheme.

### Computer System Architecture

The streaming functional encryption scheme may be implemented using a computer system 500 as illustrated in FIG. 2. In some cases, the computer system 500 may comprise a processor 504 and a memory storing instructions, such as main memory 508 and secondary memory 510.

The computer system 500 may include an input output interface 502 connected to the communication infrastructure 506. The input output interface 502 may be coupled to one or more input output devices 503, allowing for user interaction with the system.

In some cases, the main memory 508 may be directly accessible to the processor 504 and may store instructions and data for immediate processing. The secondary memory 510 may provide additional storage capacity and may include a hard disk memory 512 for longer-term data retention.

The computer system 500 may also include a removable storage drive 514, which may read from and write to removable storage units 518 and 522. An interface 520 may be provided to facilitate communication between the removable storage drive 514 and the removable storage units 518 and 522.

A communications interface 524 may be included to enable connectivity with remote devices 528 via a communications path 526. The communications interface 524 may allow the computer system 500 to send and receive data related to the streaming functional encryption scheme.

In some cases, the processor 504 may generate a circuit for the secure transformation T. This circuit may be designed to process encrypted inputs and states, perform decryption and verification, execute decryption algorithms, and produce authenticated encrypted outputs.

The processor 504 may then use an indistinguishability obfuscation algorithm to produce an obfuscated version of the generated circuit. This obfuscated circuit may be used as the secure transformation T in the streaming functional encryption scheme.

All components of the computer system 500 may be interconnected via the communication infrastructure 506, which may include a bus 930. This architecture allows for efficient data transfer and processing, supporting the complex operations required for streaming functional encryption.

### Alternative Computer System Configuration

In some cases, a computer system 900 may provide an alternative configuration for implementing the streaming functional encryption process. The computer system 900 may include several components that differ from those described in the previous configuration, particularly in terms of specialized processing units and bus architecture.

A processing device 902 may serve as the central processing unit of the computer system 900. The processing device 902 may execute instructions 926 stored in a main memory 904. In some cases, the main memory 904 may be a volatile memory that provides fast access to data and instructions for the processing device 902.

The computer system 900 may also include a static memory 906, which may be a nonvolatile memory that retains data even when power is removed from the system. This static memory 906 may complement the main memory 904 by providing long-term storage for certain data or instructions.

A video display unit 908 may be included in the computer system 900 to provide visual output. This video display unit 908 may be used to display information related to the streaming functional encryption process or to provide a user interface for controlling the system.

User input may be facilitated through an alphanumeric input device 912 and a cursor control device 914. The alphanumeric input device 912 may allow users to input text or numeric data, while the cursor control device 914 may enable navigation and selection within a graphical user interface.

A signal generation device 916 may be incorporated into the computer system 900. This signal generation device 916 may generate control signals for various components of the system, potentially including signals related to the streaming functional encryption process.

The computer system 900 may include a data storage device 918 for storing larger amounts of data. This data storage device 918 may be used to store encrypted data streams, encryption keys, or other information related to the streaming functional encryption process.

A network 920 interface may allow the computer system 900 to communicate with other devices or systems. This network 920 connectivity may be crucial for receiving data streams to be encrypted or for transmitting encrypted data to other parts of a larger system.

The computer system 900 may incorporate specialized processing units to enhance its capabilities for streaming functional encryption. A graphics processing unit 922 may be included to handle complex mathematical operations often required in encryption algorithms. This graphics processing unit 922 may significantly accelerate certain aspects of the encryption process.

A machine readable medium 924 may store the instructions 926 that are executed by the processing device 902. These instructions 926 may include the algorithms and procedures necessary for implementing the streaming functional encryption scheme.

The computer system 900 may also include a video processing unit 928 and an audio processing unit 932. These specialized units may handle video and audio data streams respectively, potentially allowing for efficient encryption of multimedia content.

A bus 930 may serve as the central communication infrastructure of the computer system 900. This bus 930 may connect all the components of the system, allowing for data transfer between different units. The bus architecture may be designed to handle high-speed data streams efficiently, which may be crucial for real-time encryption and decryption operations.

In some cases, the computer system 900 may be used to create the secure transformation T using indistinguishability obfuscation. This process may involve generating a circuit for the secure transformation T using the processing device 902 and potentially the graphics processing unit 922 for complex calculations.

The generated circuit may then be processed using an indistinguishability obfuscation algorithm. This algorithm may be executed by the processing device 902, potentially utilizing the specialized capabilities of the graphics processing unit 922 for certain operations. The resulting obfuscated circuit may then be used as the secure transformation T in the streaming functional encryption process.

The use of specialized processing units and an efficient bus architecture in this alternative computer system configuration may provide enhanced performance for the streaming functional encryption process. The ability to distribute computational tasks across multiple processing units may allow for faster encryption and decryption operations, particularly when dealing with high-speed data streams.

### Streaming Functional Encryption System Components

Referring to FIG. 4, a block diagram illustrates an encryption system 1000 for implementing streaming functional encryption. The encryption system 1000 comprises several interconnected components that work together to process, encrypt, and decrypt data streams in real-time.

In some cases, a data source 1002 may provide the input data stream to be encrypted. The data source 1002 may be a file, database, network socket, or any other source capable of generating or storing data for encryption. The data from the data source 1002 flows into a data stream processor 1004, which prepares the incoming data for encryption.

The data stream processor 1004 may perform various operations on the data stream, such as filtering, sorting, or aggregating, to optimize the encryption process. In some cases, the data stream processor 1004 may implement a setup routine for the single-key single-ciphertext scheme. This setup routine may involve receiving input parameters such as a security parameter and function parameters, and generating a master secret key.

After processing, the data stream flows into an encryption engine 1006. The encryption engine 1006 is a central component of the encryption system 1000, responsible for transforming the processed data stream into an encrypted form. The encryption engine 1006 may contain several subcomponents, including a key management system 1008 and an encryption algorithm 1010.

The key management system 1008 may be responsible for generating, distributing, and managing encryption keys. In some cases, the key management system 1008 may implement an encryption setup routine for the bootstrap step. This routine may involve creating a new master secret key for a function-private, secret-key functional encryption scheme and encrypting this key under a public-key functional encryption scheme.

The encryption algorithm 1010 may use the keys provided by the key management system 1008 to encrypt the data stream. In some cases, the encryption algorithm 1010 may implement an encryption routine for the single-key single-ciphertext scheme. This routine may involve taking as input the master secret key, an index, and a message, and outputting a ciphertext as a nested encryption with its signature.

A decryption routine 1012 may be included in the encryption system 1000 to reverse the encryption process when authorized. The decryption routine 1012 may implement a decryption routine for the single-key single-ciphertext scheme. This may involve running an obfuscated program on encrypted and signed input and state ciphertexts and a current iterator to obtain an output and updated state information.

An access control manager 1014 may interact with various components of the encryption system 1000 to manage access rights and permissions. The access control manager 1014 may be responsible for implementing a key generation routine for the bootstrap step. This routine may involve generating a function key for a composite function that incorporates the desired function into an encryption process using multiple functional encryption schemes.

In some cases, the access control manager 1014 may also be responsible for generating an iterator with public parameters and a starting iterator state. This iterator may be used in the encryption and decryption processes to maintain state information across multiple operations.

The encrypted data stream ultimately flows to a data sink 1016, which may be a storage system, network connection, or any other destination for the encrypted data. In some cases, the data sink 1016 may receive and store encrypted training data as a stream of ciphertexts for machine learning applications.

The encryption system 1000 may support advanced functionalities such as training machine learning models on encrypted data. This may involve receiving encrypted training data as a stream of ciphertexts, generating function keys for a set of machine learning update functions, and iteratively applying the decryption routine to the stream of ciphertexts. The system may aggregate model updates to progressively refine machine learning model parameters, ultimately outputting final trained model parameters in encrypted form.

In some cases, the encryption system 1000 may allow for the generation of new function keys in the middle of a stream, providing flexibility for evolving computational needs. This may be achieved by dynamically generating an additional functional key corresponding to a new function, which can be applied iteratively to all ciphertext segments of the stream, including those generated prior to the new key's creation.

The components of the encryption system 1000 may be implemented using the computer system 500 or the computer system 900 described earlier. For example, the processor 504 or the processing device 902 may execute instructions stored in the main memory 508 or the main memory 904 to implement the various routines and algorithms of the encryption system 1000. The communication infrastructure 506 or the bus 930 may facilitate data transfer between the components, while the communications interface 524 or the network 920 may enable interaction with external systems or users.

A number of implementations have been described. Nevertheless, it will be understood that various modifications may be made without departing from the spirit and scope of the disclosure. Accordingly, other implementations are within the scope of the following claims.

1. A method for a streaming functional encryption scheme with adaptive security, the method comprising:
(a) using a computerized processor to build a single-key, single-ciphertext, adaptively secure streaming functional encryption scheme One-sFE;
(b) executing with the processor a bootstrap of this scheme into a full multi-key, multi-ciphertext, public-key adaptive streaming functional encryption scheme;
wherein building the single-key single-ciphertext scheme further comprises:
(a) configuring the processor to implement a setup routine for:
(i) receiving as input a security parameter and parameters about the functions, including a function size, a state size, an input size, and an output size;
(ii) running the setup algorithm of a base streaming functional encryption scheme Post-One-sFE;
(iii) generating cryptographic keys for additional encryption and authentication schemes;
(iv) outputting a master secret key MSK comprising the Post-One-sFE master secret key and the additional cryptographic keys;
(v) storing the master secret key MSK in a memory of the processor;
(b) configuring the processor to implement an encryption routine for:
(i) taking as input the master secret key MSK, an index i, and a message xᵢ;
(ii) encrypting xᵢ using the Post-One-sFE scheme;
(iii) performing a nested encryption of the Post-One-sFE ciphertext using a symmetric key encryption scheme SKE;
(iv) authenticating the nested encryption using a signature scheme Sig;
(v) outputting the ciphertext as the authenticated nested encryption;
(vi) storing the ciphertext in the memory of the processor;
(c) configuring the processor to implement a key generation routine for:
(i) taking as input the master secret key MSK and a function ƒ;
(ii) creating a function key for ƒ under the Post-One-sFE scheme, treated as state st₁;
(iii) encrypting the Post-One-sFE function key using the SKE scheme and authenticating it with the Sig scheme;
(iv) generating auxiliary cryptographic data, including an iterator itr;
(v) creating a secure transformation T that processes encrypted inputs and states, performs decryption and verification, executes the Post-One-sFE decryption algorithm, and produces authenticated encrypted outputs;
(vi) outputting the function key comprising the secure transformation T, the encrypted and authenticated initial state, and the auxiliary cryptographic data;
(vii) storing the function key in the memory of the processor;
(d) configuring the processor to implement a decryption routine for:
(i) applying the secure transformation T to the encrypted and authenticated input and state data to obtain an output yᵢ, an encrypted and authenticated state for the next step, and updated auxiliary data;
(ii) storing the output yᵢ, the encrypted and authenticated state, and the updated auxiliary data in the memory of the processor;
wherein the bootstrap step further comprises:
(a) configuring the processor to implement a setup routine for:
(i) taking as input a security parameter and function parameters;
(ii) running the setup algorithm of a public key functional encryption scheme FE;
(iii) outputting a master public key MPK and a master secret key MSK;
(iv) storing the master public key MPK and master secret key MSK in the memory of the processor;
(b) configuring the processor to implement an encryption setup routine for:
(i) taking as input the master secret key MSK;
(ii) generating a master secret key for a function-private functional encryption scheme FPFE;
(iii) encrypting the FPFE master secret key under the public key functional encryption scheme FE;
(iv) outputting an encryption state comprising the FPFE master secret key and its encryption;
(v) storing the encryption state in the memory of the processor;
(c) configuring the processor to implement an encryption routine for:
(i) taking as input the master public key MPK, the encryption state, an index i, and a value xᵢ;
(ii) generating an FPFE function key for a function that encrypts xᵢ under the One-sFE scheme;
(iii) outputting this FPFE function key as the ciphertext for xᵢ;
(iv) storing the ciphertext in the memory of the processor;
(d) configuring the processor to implement a key generation routine for:
(i) taking as input the master secret key MSK and a function ƒ;
(ii) generating an FE function key for a function that incorporates ƒ into a composite encryption process using the One-sFE and FPFE schemes;
(iii) outputting this FE function key;
(iv) storing the FE function key in the memory of the processor;
(e) configuring the processor to implement a decryption routine for:
(i) taking as input a function key for ƒ, a decryption state, an index i, and a ciphertext of xᵢ;
(ii) performing a series of nested decryptions and function evaluations using the FE, FPFE, and One-sFE scheme decryption algorithms;
(iii) outputting yᵢ and an updated decryption state comprising intermediate decryption results;
(iv) storing yᵢ and the updated decryption state in the memory of the processor.

2. The method of claim 1, wherein the secure transformation T is created using indistinguishability obfuscation, comprising:
(a) generating a circuit that processes encrypted inputs and states, performs decryption and verification, executes the Post-One-sFE decryption algorithm, and produces authenticated encrypted outputs;
(b) applying an indistinguishability obfuscation algorithm to the generated circuit to produce an obfuscated version of the circuit; and
(c) using the obfuscated circuit as the secure transformation T.

3. The method of claim 1, wherein the key generation routine for the single key scheme further comprises:
(a) taking as input the master secret key MSK and a function ƒ;
(b) generating a function key Post.sk_{ƒ} for the function ƒ under the Post-One-sFE scheme;
(c) encrypting Post.sk_{ƒ} using the symmetric key encryption scheme SKE derived from a key K_{E} to obtain a state ciphertext ct_{st,1}, where ct_{st,1}∈{0,1}ⁿ for some positive integer n;
(d) generating an iterator with public parameters pp and a starting iterator state itr, where itr∈{0,1}^{m} for some positive integer m;
(e) signing a message m₁=(1,ct_{st,1},itr) using a signature scheme Sig derived from a key K_{A} to obtain a signature σ₁;
(f) producing an obfuscation of a program Prog using an indistinguishability obfuscation algorithm; and
(g) outputting the composite function key comprising the obfuscation of Prog, the state ciphertext ct_{st,1}, the signature σ₁ on m₁, and the iterator state itr.

4. The method of claim 3, wherein the program Prog has hardwired into it keys Kᵢₙₚ, K_{A}, K_{E}, and the public parameters pp, and takes as input an index i∈ [symbol] , an input ciphertext ct_{inp,i}, a state ciphertext ct_{st,i}, signatures inp,i and σ_{st,i} for the input and state ciphertexts respectively, and an iterator state itrᵢ; and wherein the program Prog performs operations comprising:
(a) checking that the index i is positive and verifying the signatures σinp, and σ_{st,i} on the input ciphertext ct_{inp,i} and the state ciphertext ct_{st,i} respectively, using a verification key derived from K_{A};
(b) decrypting the input ciphertext ct_{inp,i} and the state ciphertext ct_{st,i} using a secret key derived from K_{E} to obtain xᵢ and stᵢ respectively, and evaluating the Post-One-sFE decryption algorithm on these decrypted values, resulting in an updated Post-One-sFE decryption state stᵢ₊₁ and an output value yᵢ;
(c) encrypting the updated Post-One-sFE decryption state stᵢ₊₁ using randomness derived from K_{E} to obtain a new state ciphertext ct_{st,i+1};
(d) updating the iterator state itrᵢ with some of the new values computed to obtain itrᵢ₊₁;
(e) signing the new values using the signature scheme Sig derived from K_{A} to obtain a new signature σ_{st,i+1}; and
(f) outputting the value yᵢ, the new state ciphertext ct_{st,i+1}, the new signature σ_{st,i+1}, and the updated iterator state itrᵢ₊₁.

5. The method of claim 1, further comprising:
(a) receiving encrypted training data as a stream of ciphertexts {ct₁, ct₂, . . . , ctₙ}, where each ctᵢ is an encryption of a training sample xᵢ;
(b) generating function keys {sk_{ƒ}_{₁}, sk_{ƒ}_{₂}, . . . , sk_{ƒ}_{ₘ}} for a set of machine learning update functions {ƒ₁, ƒ₂, . . . , ƒₘ}, where each ƒⱼ corresponds to the training of a specific machine learning model;
(c) iteratively applying the decryption routine to the stream of ciphertexts using the generated function keys to obtain model updates {yⱼ_{₁}, yⱼ_{₂}, . . . , yⱼₙ} along with encrypted intermediate model parameters {θⱼ_{₁}, θⱼ_{₂}, . . . , θⱼ_{ₙ}} where (y_{j,i},θ_{j,i})=(ƒⱼ(xᵢ,θⱼ_{_{i−1}}), and θⱼ_{₀} the initial model parameter for all j∈{1, . . . , m};
(d) aggregating the model updates to progressively refine the machine learning model parameters; and
(e) outputting the final trained model parameters {θ_{1,n+1}, . . . , θ_{m,n+1}} for all the m models in encrypted form.

6. The method of claim 1, further comprising dynamically generating, at any point during stream generation, an additional functional key corresponding to a new function, wherein the additional functional key is operable to be applied iteratively to all ciphertext segments of the stream, including those segments generated prior to the generation of the additional functional key.

7. A system for implementing a streaming functional encryption scheme with adaptive security, the system comprising:
a processor; and
a memory storing instructions that, when executed by the processor, cause the processor to:
(a) build a single-key, single-ciphertext, adaptively secure streaming functional encryption scheme One-sFE;
(b) execute a bootstrap of the One-sFE scheme into a full multi-key, multi-ciphertext, public-key adaptive streaming functional encryption scheme;
wherein building the single-key single-ciphertext scheme comprises:
(a) implementing a setup routine configured to:
(i) receive as input a security parameter and parameters about the functions, including a function size, a state size, an input size, and an output size;
(ii) run a setup algorithm of a base streaming functional encryption scheme Post-One-sFE;
(iii) generate cryptographic keys for additional encryption and authentication schemes;
(iv) output a master secret key MSK comprising the Post-One-sFE master secret key and the additional cryptographic keys;
(v) store the master secret key MSK in the memory;
(b) implementing an encryption routine configured to:
(i) take as input the master secret key MSK, an index i, and a message xᵢ;
(ii) encrypt xᵢ using the Post-One-sFE scheme;
(iii) perform a nested encryption of the Post-One-sFE ciphertext using a symmetric key encryption scheme SKE;
(iv) authenticate the nested encryption using a signature scheme Sig;
(v) output the ciphertext as the authenticated nested encryption;
(vi) store the ciphertext in the memory;
(c) implementing a key generation routine configured to:
(i) take as input the master secret key MSK and a function ƒ;
(ii) create a function key for ƒ under the Post-One-sFE scheme, treated as state st₁;
(iii) encrypt the Post-One-sFE function key using the SKE scheme and authenticate it with the Sig scheme;
(iv) generate auxiliary cryptographic data, including an iterator itr;
(v) create a secure transformation T that processes encrypted inputs and states, performs decryption and verification, executes the Post-One-sFE decryption algorithm, and produces authenticated encrypted outputs;
(vi) output the function key comprising the secure transformation T, the encrypted and authenticated initial state, and the auxiliary cryptographic data;
(vii) store the function key in the memory;
(d) implementing a decryption routine configured to:
(i) apply the secure transformation T to the encrypted and authenticated input and state data to obtain an output yᵢ, an encrypted and authenticated state for the next step, and updated auxiliary data;
(ii) store the output yᵢ, the encrypted and authenticated state, and the updated auxiliary data in the memory;
wherein the bootstrap step comprises:
(a) implementing a setup routine configured to:
(i) take as input a security parameter and function parameters;
(ii) run a setup algorithm of a public key functional encryption scheme FE;
(iii) output a master public key MPK and a master secret key MSK;
(iv) store the master public key MPK and master secret key MSK in the memory;
(b) implementing an encryption setup routine configured to:
(i) take as input the master secret key MSK;
(ii) generate a master secret key for a function-private functional encryption scheme FPFE;
(iii) encrypt the FPFE master secret key under the public key functional encryption scheme FE;
(iv) output an encryption state comprising the FPFE master secret key and its encryption;
(v) store the encryption state in the memory;
(c) implementing an encryption routine configured to:
(i) take as input the master public key MPK, the encryption state, an index i, and a value xᵢ;
(ii) generate an FPFE function key for a function that encrypts xᵢ under the One-sFE scheme;
(iii) output this FPFE function key as the ciphertext for xᵢ;
(iv) store the ciphertext in the memory;
(d) implementing a key generation routine configured to:
(i) take as input the master secret key MSK and a function ƒ;
(ii) generate an FE function key for a function that incorporates ƒ into a composite encryption process using the One-sFE and FPFE schemes;
(iii) output this FE function key;
(iv) store the FE function key in the memory;
(e) implementing a decryption routine configured to:
(i) take as input a function key for ƒ, a decryption state, an index i, and a ciphertext of xᵢ;
(ii) perform a series of nested decryptions and function evaluations using the FE, FPFE, and One-sFE scheme decryption algorithms;
(iii) output yᵢ and an updated decryption state comprising intermediate decryption results;
(iv) store yᵢ and the updated decryption state in the memory.

8. The system of claim 7, wherein the secure transformation T is created using indistinguishability obfuscation, and the processor is further configured to:
(a) generate a circuit that processes encrypted inputs and states, performs decryption and verification, executes the Post-One-sFE decryption algorithm, and produces authenticated encrypted outputs;
(b) apply an indistinguishability obfuscation algorithm to the generated circuit to produce an obfuscated version of the circuit; and
(c) use the obfuscated circuit as the secure transformation T.

9. The system of claim 7, wherein the key generation routine for the single key scheme is further configured to:
(a) take as input the master secret key MSK and a function ƒ;
(b) generate a function key Post.sk_{ƒ} for the function ƒ under the Post-One-sFE scheme;
(c) encrypt Post.sk_{ƒ} using the symmetric key encryption scheme SKE derived from a key K_{E} to obtain a state ciphertext ct_{st,1}, where ct_{st,1}∈{0,1}ⁿ for some positive integer n;
(d) generate an iterator with public parameters pp and a starting iterator state itr, where itr∈{0,1}^{m} for some positive integer m;
(e) sign a message m₁=(1,ct_{st,1},itr) using a signature scheme Sig derived from a key K_{A} to obtain a signature σ₁;
(f) produce an obfuscation of a program Prog using an indistinguishability obfuscation algorithm; and
(g) output the composite function key comprising the obfuscation of Prog, the state ciphertext ct_{st,1}, the signature σ₁ on m₁, and the iterator state itr.

10. The system of claim 9, wherein the program Prog has hardwired into it keys Kᵢₙₚ, K_{A}, K_{E}, and the public parameters pp, and takes as input an index i∈ [symbol] , an input ciphertext ct_{inp,i}, a state ciphertext ct_{st,i}, signatures σ_{inp,i} and σ_{st,i} for the input and state ciphertexts respectively, and an iterator state itrᵢ; and wherein the program Prog is configured to:
(a) check that the index i is positive and verify the signatures σ_{inp,i} and σ_{st,i} on the input ciphertext ct_{inp,i} and the state ciphertext ct_{st,i} respectively, using a verification key derived from K_{A};
(b) decrypt the input ciphertext ct_{inp,i} and the state ciphertext ct_{st,i} using a secret key derived from K_{E} to obtain xᵢ and stᵢ respectively, and evaluate the Post-One-sFE decryption algorithm on these decrypted values, resulting in an updated Post-One-sFE decryption state stᵢ₊₁ and an output value yᵢ;
(c) encrypt the updated Post-One-sFE decryption state stᵢ₊₁ using randomness derived from K_{E} to obtain a new state ciphertext ct_{st,i+1};
(d) update the iterator state itrᵢ with some of the new values computed to obtain itrᵢ₊₁;
(e) sign the new values using the signature scheme Sig derived from K_{A} to obtain a new signature σ_{st,i+1}; and
(f) output the value yᵢ, the new state ciphertext ct_{st,i+1}, the new signature σ_{st,i+1}, and the updated iterator state itrᵢ₊₁.

11. The system of claim 7, wherein the processor is further configured to:
(a) receive encrypted training data as a stream of ciphertexts {ct₁, ct₂, . . . , ctₙ}, where each ctᵢ is an encryption of a training sample xᵢ;
(b) generate function keys {sk_{ƒ}_{₁}, sk_{ƒ}_{₂}, . . . , sk_{ƒ}_{ₘ}} for a set of machine learning update functions {ƒ₁,ƒ₂, . . . , ƒₘ}, where each ƒⱼ corresponds to the training of a specific machine learning model;
(c) iteratively apply the decryption routine to the stream of ciphertexts using the generated function keys to obtain model updates {yⱼ_{₁}, yⱼ_{₂}, . . . , yⱼₙ} along with encrypted intermediate model parameters {θⱼ_{₁}, θⱼ_{₂}, . . . , θⱼ_{ₙ}} where (y_{j,i},θ_{j,i})=(ƒⱼ(xᵢ,θⱼ_{_{i−1}})), and θⱼ₀ the initial model parameter for all j∈{1, . . . , m};
(d) aggregate the model updates to progressively refine the machine learning model parameters; and
(e) output the final trained model parameters {θ_{1,n+1}, . . . , θ_{m,n+1}} for all the m models in encrypted form.

12. The system of claim 7, wherein the processor is further configured to dynamically generate, at any point during stream generation, an additional functional key corresponding to a new function, wherein the additional functional key is operable to be applied iteratively to all ciphertext segments of the stream, including those segments generated prior to the generation of the additional functional key.
Here is a set of computer-readable media claims based on the selected claims 1-6, starting with claim 13:

13. A non-transitory computer-readable storage medium storing instructions that, when executed by a processor, cause the processor to perform a method for a streaming functional encryption scheme with adaptive security, the method comprising:
(a) building a single-key, single-ciphertext, adaptively secure streaming functional encryption scheme One-sFE;
(b) executing a bootstrap of the One-sFE scheme into a full multi-key, multi-ciphertext, public-key adaptive streaming functional encryption scheme;
wherein building the single-key single-ciphertext scheme comprises:
(a) implementing a setup routine configured to:
(i) receive as input a security parameter and parameters about the functions, including a function size, a state size, an input size, and an output size;
(ii) run a setup algorithm of a base streaming functional encryption scheme Post-One-sFE;
(iii) generate cryptographic keys for additional encryption and authentication schemes;
(iv) output a master secret key MSK comprising the Post-One-sFE master secret key and the additional cryptographic keys;
(v) store the master secret key MSK in a memory;
(b) implementing an encryption routine configured to:
(i) take as input the master secret key MSK, an index i, and a message x_i;
(ii) encrypt x_i using the Post-One-sFE scheme;
(iii) perform a nested encryption of the Post-One-sFE ciphertext using a symmetric key encryption scheme SKE;
(iv) authenticate the nested encryption using a signature scheme Sig;
(v) output the ciphertext as the authenticated nested encryption;
(vi) store the ciphertext in the memory;
(c) implementing a key generation routine configured to:
(i) take as input the master secret key MSK and a function ƒ;
(ii) create a function key for ƒ under the Post-One-sFE scheme, treated as state st_1;
(iii) encrypt the Post-One-sFE function key using the SKE scheme and authenticate it with the Sig scheme;
(iv) generate auxiliary cryptographic data, including an iterator itr;
(v) create a secure transformation T that processes encrypted inputs and states, performs decryption and verification, executes the Post-One-sFE decryption algorithm, and produces authenticated encrypted outputs;
(vi) output the function key comprising the secure transformation T, the encrypted and authenticated initial state, and the auxiliary cryptographic data;
(vii) store the function key in the memory;
(d) implementing a decryption routine configured to:
(i) apply the secure transformation T to the encrypted and authenticated input and state data to obtain an output y_i, an encrypted and authenticated state for the next step, and updated auxiliary data;
(ii) store the output y_i, the encrypted and authenticated state, and the updated auxiliary data in the memory;
wherein the bootstrap step comprises:
(a) implementing a setup routine configured to:
(i) take as input a security parameter and function parameters;
(ii) run a setup algorithm of a public key functional encryption scheme FE;
(iii) output a master public key MPK and a master secret key MSK;
(iv) store the master public key MPK and master secret key MSK in the memory;
(b) implementing an encryption setup routine configured to:
(i) take as input the master secret key MSK;
(ii) generate a master secret key for a function-private functional encryption scheme FPFE;
(iii) encrypt the FPFE master secret key under the public key functional encryption scheme FE;
(iv) output an encryption state comprising the FPFE master secret key and its encryption;
(v) store the encryption state in the memory;
(c) implementing an encryption routine configured to:
(i) take as input the master public key MPK, the encryption state, an index i, and a value x_i;
(ii) generate an FPFE function key for a function that encrypts x_i under the One-sFE scheme;
(iii) output this FPFE function key as the ciphertext for x_i;
(iv) store the ciphertext in the memory;
(d) implementing a key generation routine configured to:
(i) take as input the master secret key MSK and a function ƒ;
(ii) generate an FE function key for a function that incorporates ƒ into a composite encryption process using the One-sFE and FPFE schemes;
(iii) output this FE function key;
(iv) store the FE function key in the memory;
(e) implementing a decryption routine configured to:
(i) take as input a function key for ƒ, a decryption state, an index i, and a ciphertext of x_i;
(ii) perform a series of nested decryptions and function evaluations using the FE, FPFE, and One-sFE scheme decryption algorithms;
(iii) output y_i and an updated decryption state comprising intermediate decryption results;
(iv) store y_i and the updated decryption state in the memory.

14. The non-transitory computer-readable storage medium of claim 13, wherein the secure transformation T is created using indistinguishability obfuscation, and the method further comprises:
(a) generating a circuit that processes encrypted inputs and states, performs decryption and verification, executes the Post-One-sFE decryption algorithm, and produces authenticated encrypted outputs;
(b) applying an indistinguishability obfuscation algorithm to the generated circuit to produce an obfuscated version of the circuit; and
(c) using the obfuscated circuit as the secure transformation T.

15. The non-transitory computer-readable storage medium of claim 13, wherein the key generation routine for the single key scheme further comprises:
(a) taking as input the master secret key MSK and a function ƒ;
(b) generating a function key Post.sk_ƒ for the function ƒ under the Post-One-sFE scheme;
(c) encrypting Post.sk_ƒ using the symmetric key encryption scheme SKE derived from a key K_E to obtain a state ciphertext ct_st,1, where ct_st, 1∈{0,1}ⁿ for some positive integer n;
(d) generating an iterator with public parameters pp and a starting iterator state itr, where itr∈{0,1}^{m} for some positive integer m;
(e) signing a message m_1=(1,ct_st,1,itr) using a signature scheme Sig derived from a key K_A to obtain a signature σ_1;
(f) producing an obfuscation of a program Prog using an indistinguishability obfuscation algorithm; and
(g) outputting the composite function key comprising the obfuscation of Prog, the state ciphertext ct_st,1, the signature σ_1 on m_1, and the iterator state itr.

16. The non-transitory computer-readable storage medium of claim 15, wherein the program Prog has hardwired into it keys K_inp, K_A, K_E, and the public parameters pp, and takes as input an index i∈ [symbol] , an input ciphertext ct_inp,i, a state ciphertext ct_st,i, signatures σ_inp,i and σ_st,i for the input and state ciphertexts respectively, and an iterator state itr_i; and wherein the program Prog performs operations comprising:
(a) checking that the index i is positive and verifying the signatures σ_inp,i and σ_st,i on the input ciphertext ct_inp,i and the state ciphertext ct_st,i respectively, using a verification key derived from K_A;
(b) decrypting the input ciphertext ct_inp,i and the state ciphertext ct_st,i using a secret key derived from K_E to obtain x_i and st_i respectively, and evaluating the Post-One-sFE decryption algorithm on these decrypted values, resulting in an updated Post-One-sFE decryption state st_i+1 and an output value y_i;
(c) encrypting the updated Post-One-sFE decryption state st_i+1 using randomness derived from K_E to obtain a new state ciphertext ct_st,i+1;
(d) updating the iterator state itr_i with some of the new values computed to obtain itr_i+1;
(e) signing the new values using the signature scheme Sig derived from K_A to obtain a new signature σ_st,i+1; and
(f) outputting the value y_i, the new state ciphertext ct_st,i+1, the new signature σ_st,i+1, and the updated iterator state itr_i+1.

17. The non-transitory computer-readable storage medium of claim 13, wherein the method further comprises:
(a) receiving encrypted training data as a stream of ciphertexts {ct_1, ct_2, . . . , ct_n}, where each ct_i is an encryption of a training sample x_i;
(b) generating function keys {sk_ƒ_1, sk_ƒ_2, . . . , sk_ƒ_m} for a set of machine learning update functions {ƒ_1, ƒ_2, . . . , ƒ_m}, where each ƒ_j corresponds to the training of a specific machine learning model;
(c) iteratively applying the decryption routine to the stream of ciphertexts using the generated function keys to obtain model updates {y_j_1, y_j_2, . . . , y_j_n} along with encrypted intermediate model parameters {θ_j_1, θ_j_2, . . . , θ_j_n} where (y_j,i,θ_j,i)=(ƒ_j(x_i,θ_j_i−1)), and θ_j_0 the initial model parameter for all j∈{1, . . . , m};
(d) aggregating the model updates to progressively refine the machine learning model parameters; and
(e) outputting the final trained model parameters {θ_1, n+1, . . . , θ_m, n+1} for all the m models in encrypted form.

18. The non-transitory computer-readable storage medium of claim 13, wherein the method further comprises dynamically generating, at any point during stream generation, an additional functional key corresponding to a new function, wherein the additional functional key is operable to be applied iteratively to all ciphertext segments of the stream, including those segments generated prior to the generation of the additional functional key.
